(19) United States
(12) Patent Application Publication
(10) Pub. No.: US 2025/0371128 A1
(43) Pub. Date: Dec. 4, 2025

(54) MANAGING CREDENTIALS

(71) Applicant: Apple Inc., Cupertino, CA (US)

(72) Inventors: Peter W. ROMAN, Los Altos, CA (US); Ryan D. SHELBY, Mountain View, CA (US); Russell E. SNEDIKER, Aptos, CA (US)

(21) Appl. No.: 19/096,175

(22) Filed: Mar. 31, 2025

Related U.S. Application Data
(60) Provisional application No. 63/655,937, filed on Jun. 4, 2024.

(51) Int. Cl. G06F 21/45

(52) U.S. Cl. CPC G06F 21/45

(57) ABSTRACT

The present disclosure generally relates to managing credentials. Some techniques are for displaying information related to credentials in accordance with some embodiments. Other techniques are for displaying notifications regarding the saving of credentials in accordance with some embodiments.

### CROSS-REFERENCE TO RELATED APPLICATIONS

This application claims priority to U.S. Provisional Patent Application Ser. No. 63/655,937, entitled “MANAGING CREDENTIALS” filed Jun. 4, 2024, which is hereby incorporated by reference in its entirety for all purposes.

### FIELD

The present disclosure relates generally to computer user interfaces, and more specifically to techniques for managing credentials.

### BACKGROUND

Electronic devices often use credentials to access restricted functionalities of various services. Such credentials can be managed via an application and/or system installed on an electronic device.

### SUMMARY

Some techniques for managing credentials using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient processes and interfaces for managing credentials. Such processes and interfaces optionally complement or replace other processes for managing credentials. Such processes and interfaces reduce the cognitive burden on a user and produce a more efficient human-machine interface. For battery-operated computing devices, such processes and interfaces conserve power and increase the time between battery charges.

In some embodiments, a method that is performed at a computer system that is in communication with one or more display generation components and one or more input devices is described. In some embodiments, the method comprises: while displaying, via the one or more display generation components, a credential manager user interface, detecting, via the one or more input devices, an input corresponding to a request to display a credential for a respective service; and in response to detecting the input corresponding to the request to display the credential for the respective service: in accordance with a determination that the respective service uses a service-specific credential, displaying, via the one or more display generation components, a first user interface that corresponds to the service-specific credential; and in accordance with a determination that the respective service uses a federated credential, displaying, via the one or more display generation components, a second user interface that corresponds to the federated credential, wherein the second user interface includes a link to a federated credential user interface that includes a set of one or more options for managing the federated credential.

In some embodiments, a non-transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a credential manager user interface, detecting, via the one or more input devices, an input corresponding to a request to display a credential for a respective service; and in response to detecting the input corresponding to the request to display the credential for the respective service: in accordance with a determination that the respective service uses a service-specific credential, displaying, via the one or more display generation components, a first user interface that corresponds to the service-specific credential; and in accordance with a determination that the respective service uses a federated credential, displaying, via the one or more display generation components, a second user interface that corresponds to the federated credential, wherein the second user interface includes a link to a federated credential user interface that includes a set of one or more options for managing the federated credential.

In some embodiments, a transitory computer-readable storage medium storing one or more programs configured to be executed by one or more processors of a computer system that is in communication with one or more display generation components and one or more input devices is described. In some embodiments, the one or more programs includes instructions for: while displaying, via the one or more display generation components, a credential manager user interface, detecting, via the one or more input devices, an input corresponding to a request to display a credential for a respective service; and in response to detecting the input corresponding to the request to display the credential for the respective service: in accordance with a determination that the respective service uses a service-specific credential, displaying, via the one or more display generation components, a first user interface that corresponds to the service-specific credential; and in accordance with a determination that the respective service uses a federated credential, displaying, via the one or more display generation components, a second user interface that corresponds to the federated credential, wherein the second user interface includes a link to a federated credential user interface that includes a set of one or more options for managing the federated credential.

In some embodiments, a computer system configured to communicate with one or more display generation components and one or more input devices is described. In some embodiments, the computer system comprises one or more processors and memory storing one or more programs configured to be executed by the one or more processors. In some embodiments, the one or more programs includes instructions for: while displaying, via the one or more display generation components, a credential manager user interface, detecting, via the one or more input devices, an input corresponding to a request to display a credential for a respective service; and in response to detecting the input corresponding to the request to display the credential for the respective service: in accordance with a determination that the respective service uses a service-specific credential, displaying, via the one or more display generation components, a first user interface that corresponds to the service-specific credential; and in accordance with a determination that the respective service uses a federated credential, displaying, via the one or more display generation components, a second user interface that corresponds to the federated credential, wherein the second user interface includes a link to a federated credential user interface that includes a set of one or more options for managing the federated credential.

In some embodiments, a computer system configured to communicate with one or more display generation components and one or more input devices is described. In some embodiments, the computer system comprises means for performing each of the following steps: while displaying, via the one or more display generation components, a credential manager user interface, detecting, via the one or more input devices, an input corresponding to a request to display a credential for a respective service; and in response to detecting the input corresponding to the request to display the credential for the respective service: in accordance with a determination that the respective service uses a service-specific credential, displaying, via the one or more display generation components, a first user interface that corresponds to the service-specific credential; and in accordance with a determination that the respective service uses a federated credential, displaying, via the one or more display generation components, a second user interface that corresponds to the federated credential, wherein the second user interface includes a link to a federated credential user interface that includes a set of one or more options for managing the federated credential.

In some embodiments, a computer program product is described. In some embodiments, the computer program product comprises one or more programs configured to be executed by one or more processors of a computer system that is in communication with one or more display generation components and one or more input devices. In some embodiments, the one or more programs include instructions for: while displaying, via the one or more display generation components, a credential manager user interface, detecting, via the one or more input devices, an input corresponding to a request to display a credential for a respective service; and in response to detecting the input corresponding to the request to display the credential for the respective service: in accordance with a determination that the respective service uses a service-specific credential, displaying, via the one or more display generation components, a first user interface that corresponds to the service-specific credential; and in accordance with a determination that the respective service uses a federated credential, displaying, via the one or more display generation components, a second user interface that corresponds to the federated credential, wherein the second user interface includes a link to a federated credential user interface that includes a set of one or more options for managing the federated credential.

In some embodiments, a method that is performed at a computer system that is in communication with one or more display generation components and one or more input devices is described. In some embodiments, the method comprises: while displaying a credential user interface for a service, detecting, via the one or more input devices, an input corresponding to a request to perform a respective operation associated with a credential for the service; and in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

In some embodiments, a non-transitory computer-readable storage medium storing one or more programs configured to be executed by one or more processors of a computer system that is in communication with one or more display generation components and one or more input devices is described. In some embodiments, the one or more programs includes instructions for: while displaying a credential user interface for a service, detecting, via the one or more input devices, an input corresponding to a request to perform a respective operation associated with a credential for the service; and in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

In some embodiments, a transitory computer-readable storage medium storing one or more programs configured to be executed by one or more processors of a computer system that is in communication with one or more display generation components and one or more input devices is described. In some embodiments, the one or more programs includes instructions for: while displaying a credential user interface for a service, detecting, via the one or more input devices, an input corresponding to a request to perform a respective operation associated with a credential for the service; and in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

In some embodiments, a computer system configured to communicate with one or more display generation components and one or more input devices is described. In some embodiments, the computer system comprises one or more processors and memory storing one or more programs configured to be executed by the one or more processors. In some embodiments, the one or more programs includes instructions for: while displaying a credential user interface for a service, detecting, via the one or more input devices, an input corresponding to a request to perform a respective operation associated with a credential for the service; and in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

In some embodiments, a computer system configured to communicate with one or more display generation components and one or more input devices is described. In some embodiments, the computer system comprises means for performing each of the following steps: while displaying a credential user interface for a service, detecting, via the one or more input devices, an input corresponding to a request to perform a respective operation associated with a credential for the service; and in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

In some embodiments, a computer program product is described. In some embodiments, the computer program product comprises one or more programs configured to be executed by one or more processors of a computer system that is in communication with one or more display generation components and one or more input devices. In some embodiments, the one or more programs include instructions for: while displaying a credential user interface for a service, detecting, via the one or more input devices, an input corresponding to a request to perform a respective operation associated with a credential for the service; and in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient processes and interfaces for managing credentials, thereby increasing the effectiveness, efficiency, and user satisfaction with such devices. Such processes and interfaces may complement or replace other processes for managing credentials.

### DESCRIPTION OF THE FIGURES

For a better understanding of the various described embodiments, reference should be made to the Detailed Description below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations. is a flow diagram for obtaining and providing information in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIGS. 5C-5D illustrate exemplary components of a personal electronic device having a touch-sensitive display and intensity sensors in accordance with some embodiments.

FIGS. 5E-5H illustrate exemplary components and user interfaces of a personal electronic device in accordance with some embodiments.

FIGS. 6A-6U illustrate exemplary user interfaces for displaying information related to credentials in accordance with some embodiments.

FIG. 7 is a flow diagram illustrating a method for displaying information related to credentials in accordance with some embodiments.

FIGS. 8A-8Z illustrate exemplary user interfaces for displaying notifications regarding the saving of credentials in accordance with some embodiments.

FIG. 9 is a flow diagram illustrating a method for displaying notifications regarding the saving of credentials in accordance with some embodiments.

### DETAILED DESCRIPTION

The following description sets forth exemplary processes, parameters, and the like. It should be recognized, however, that such description is not intended as a limitation on the scope of the present disclosure but is instead provided as a description of exemplary embodiments.

There is a need for electronic devices that provide efficient processes and interfaces for managing credentials. For example, different information and/or user interfaces can be displayed by an electronic device based on a type of a selected credential and notifications can be displayed that indicate that an operation has been performed with respect to a selected credential. Such techniques can reduce the cognitive burden on a user who manages credentials, thereby enhancing productivity. Further, such techniques can reduce processor and battery power otherwise wasted on redundant user inputs.

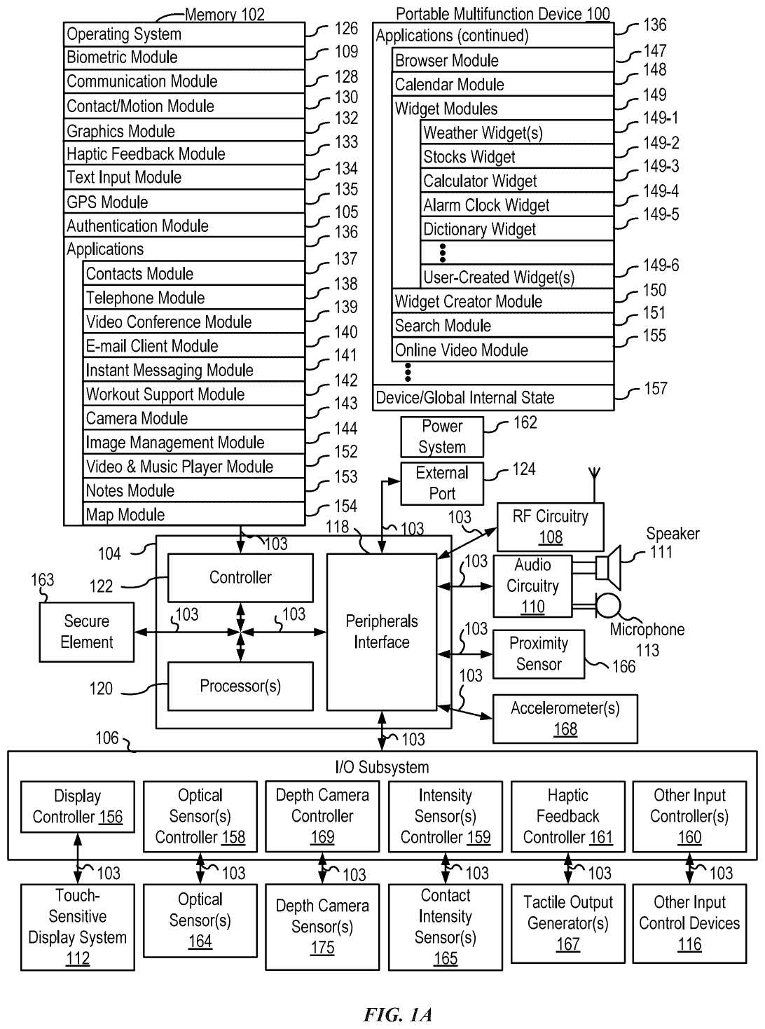

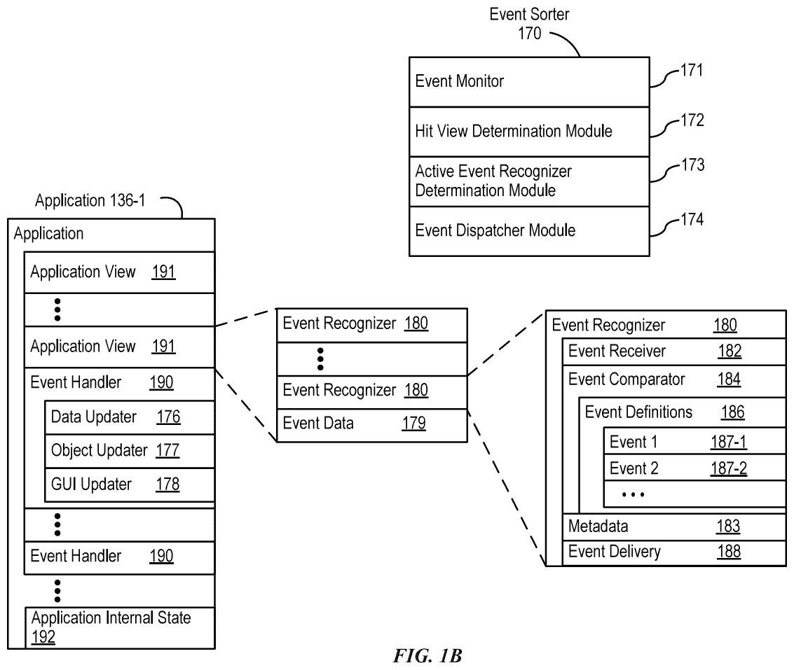

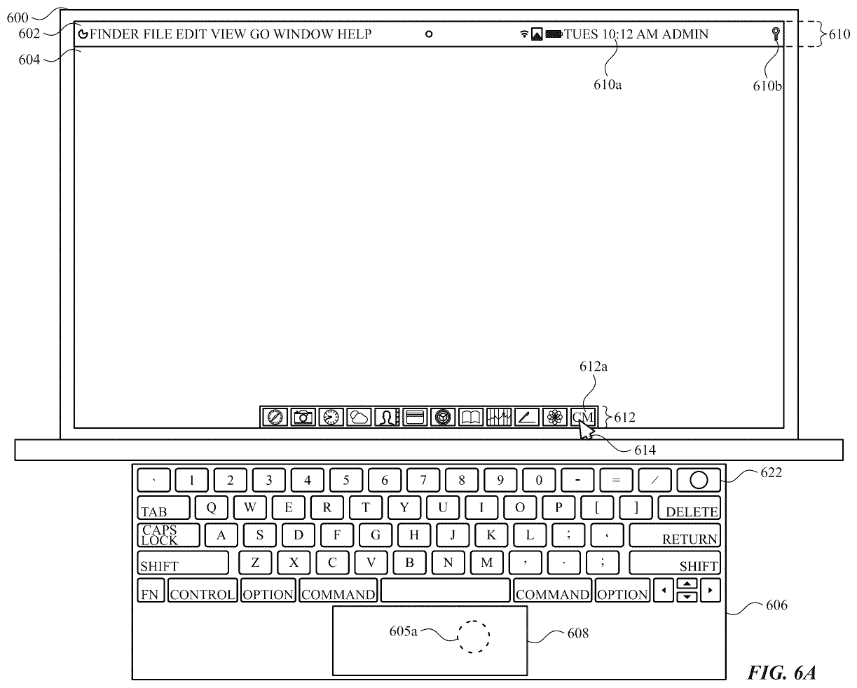

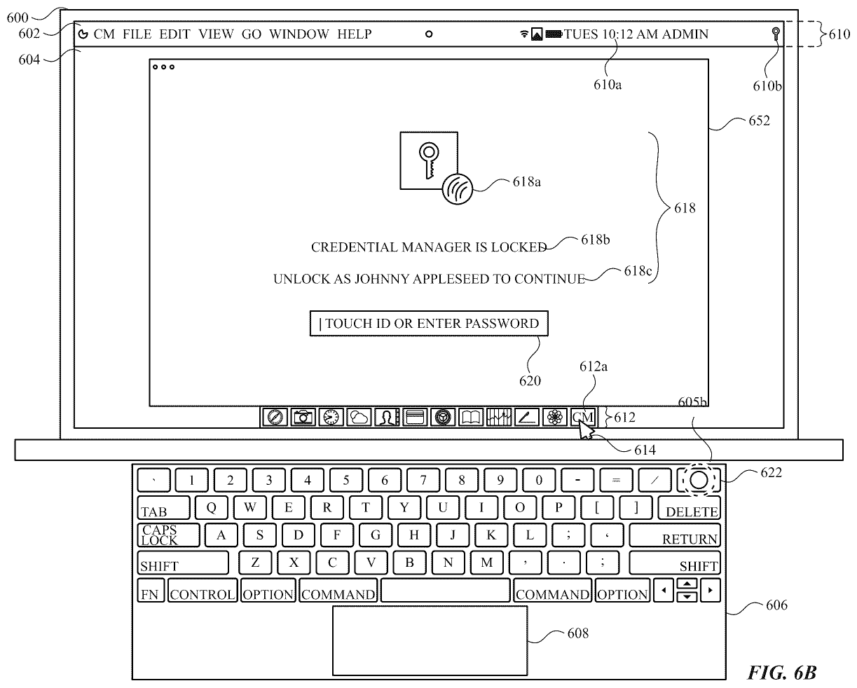

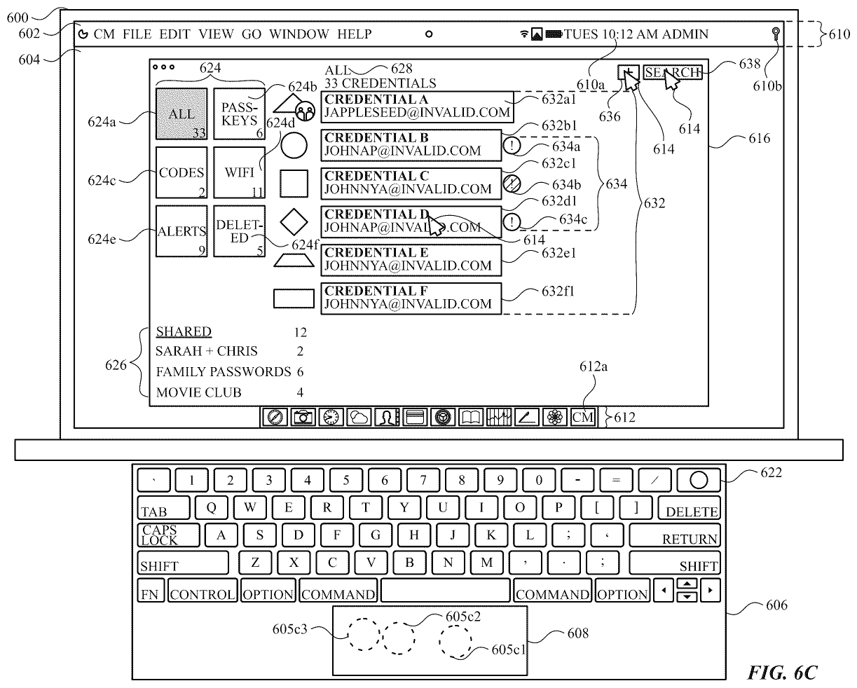

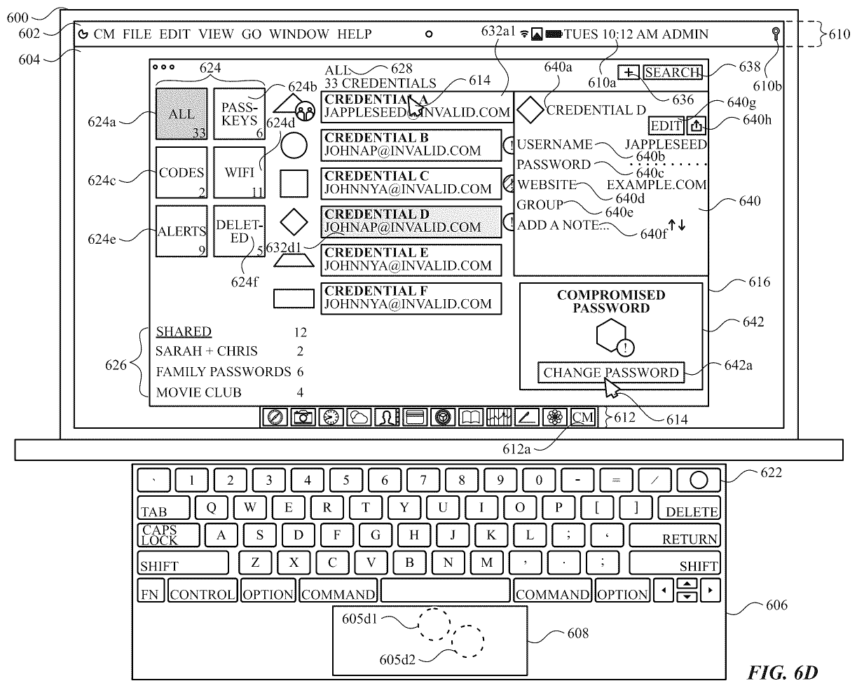

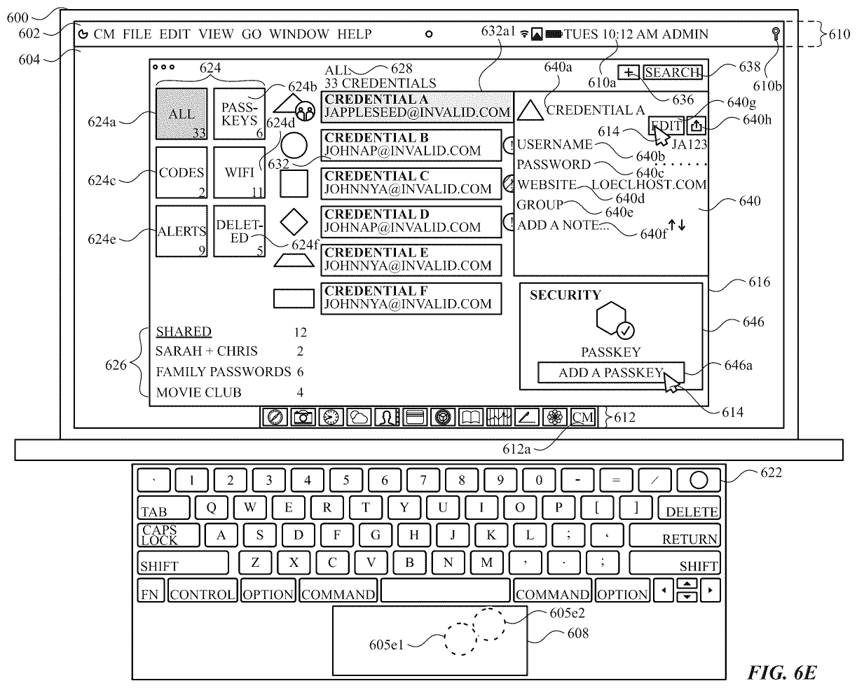

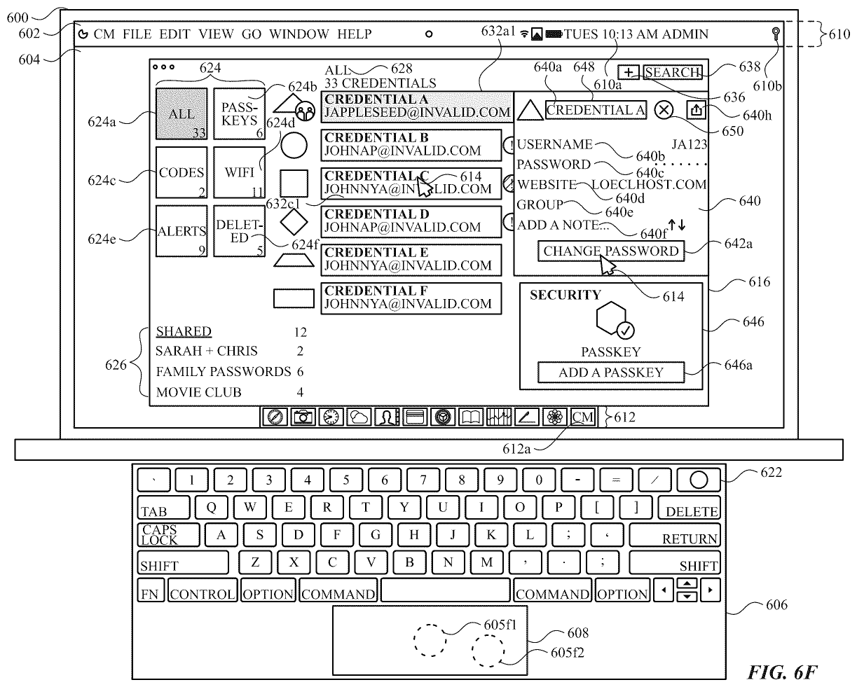

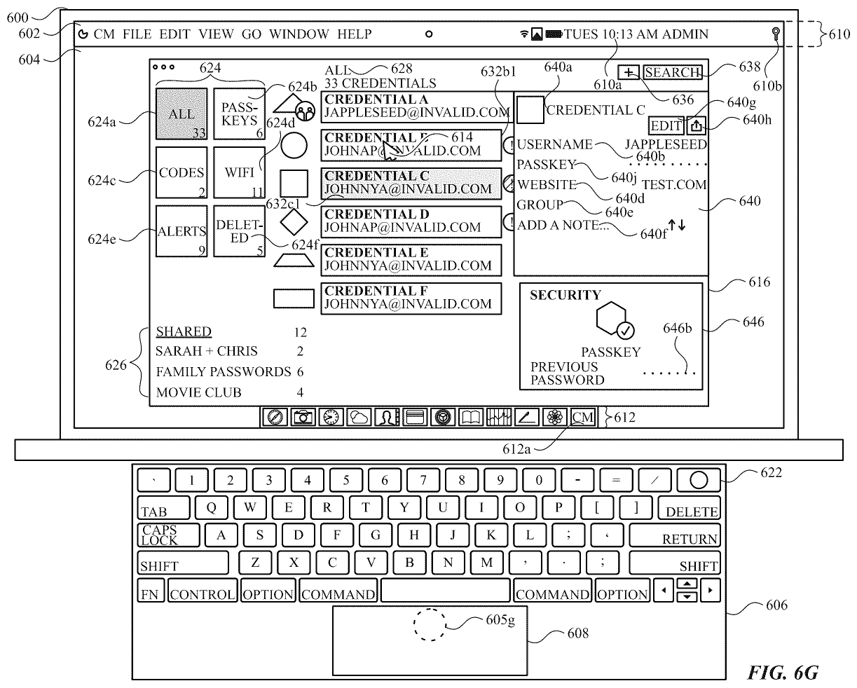

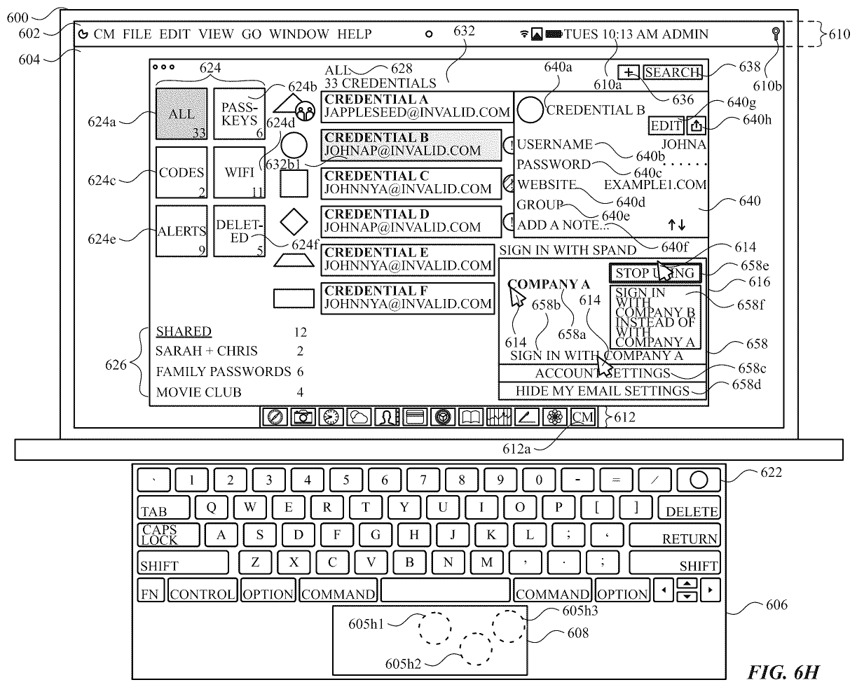

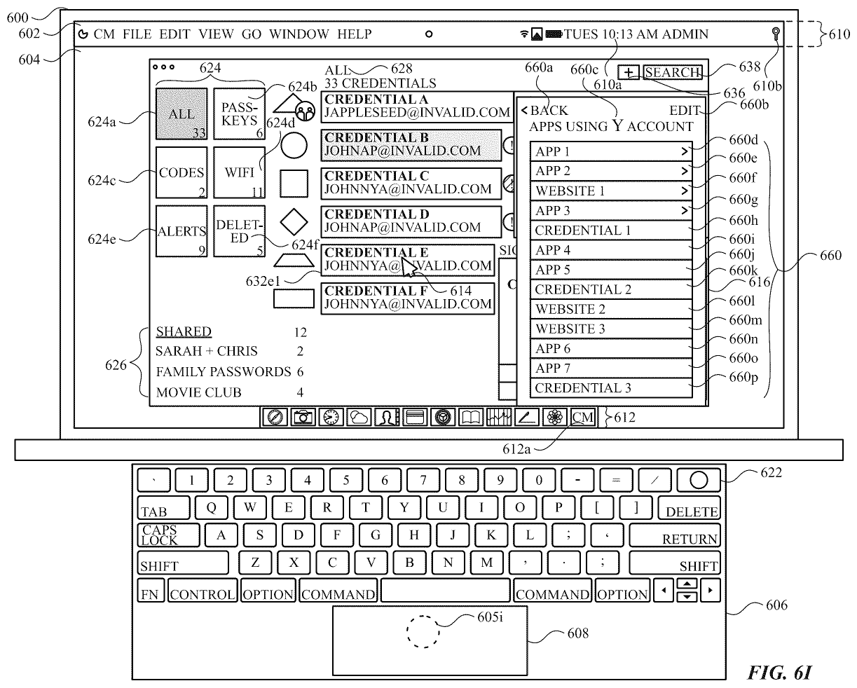

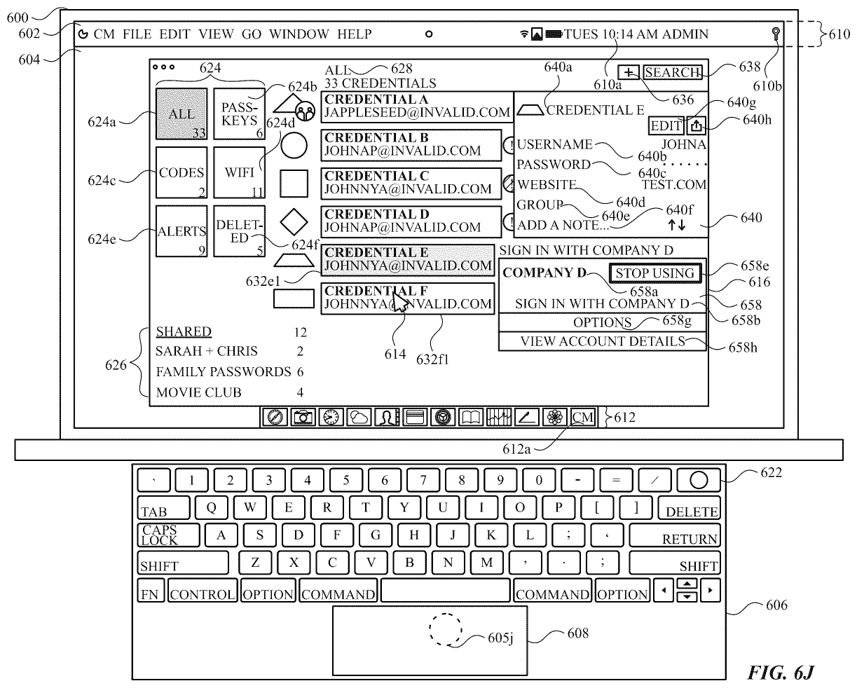

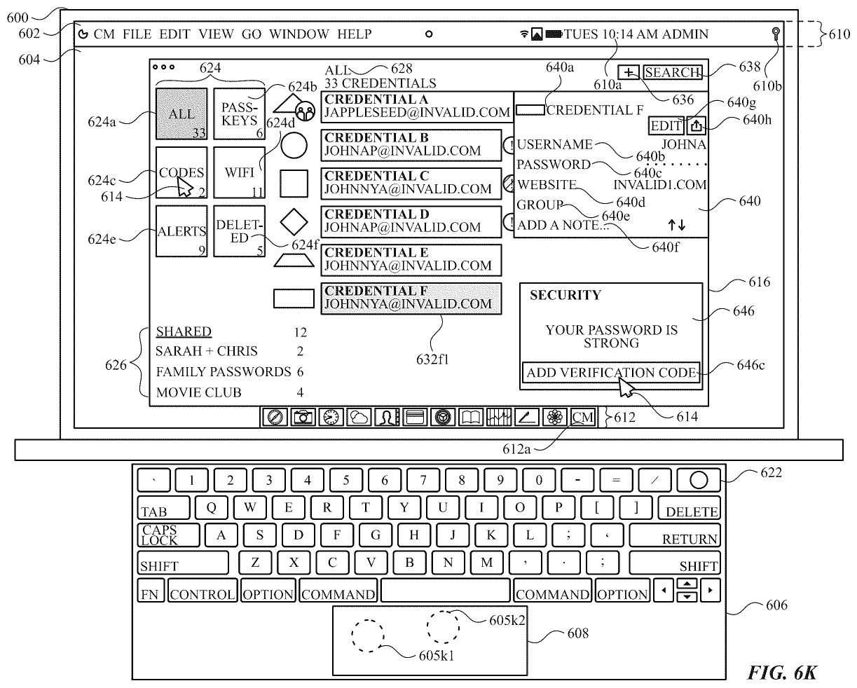

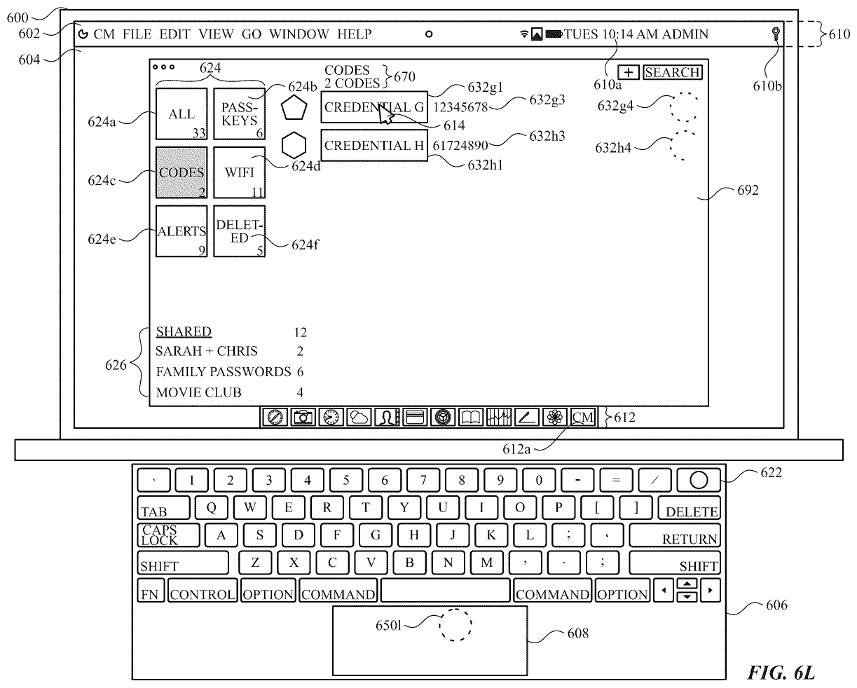

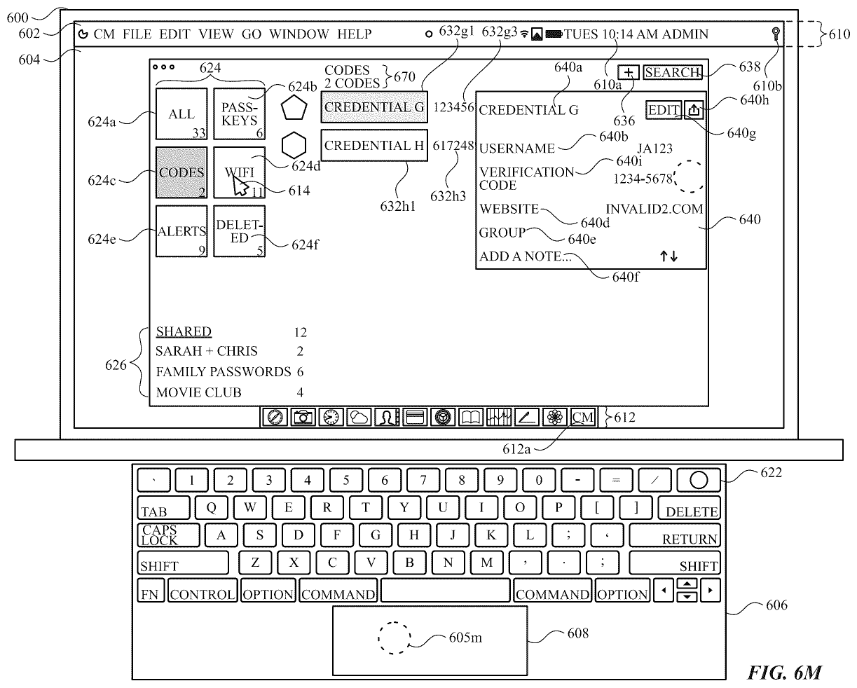

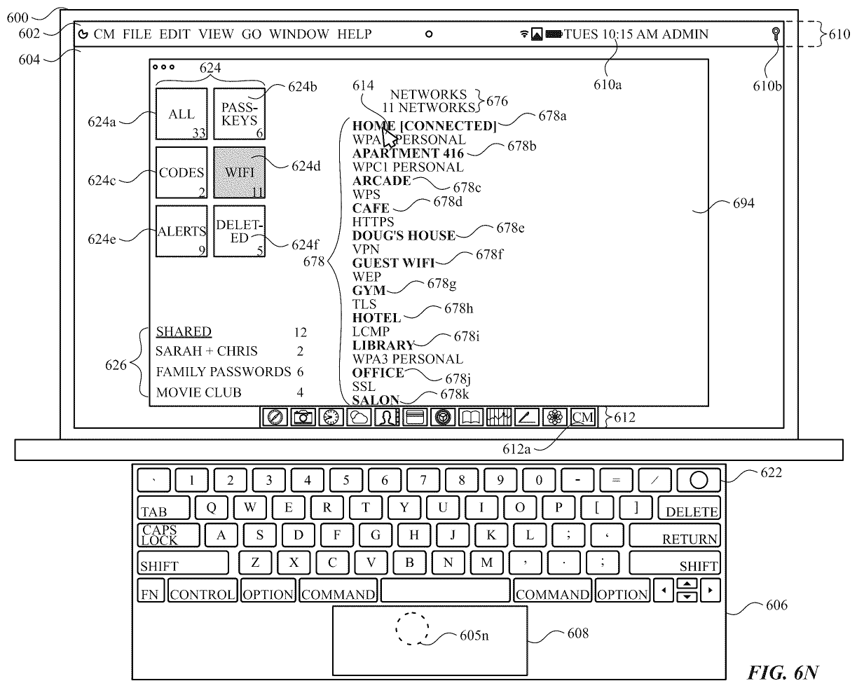

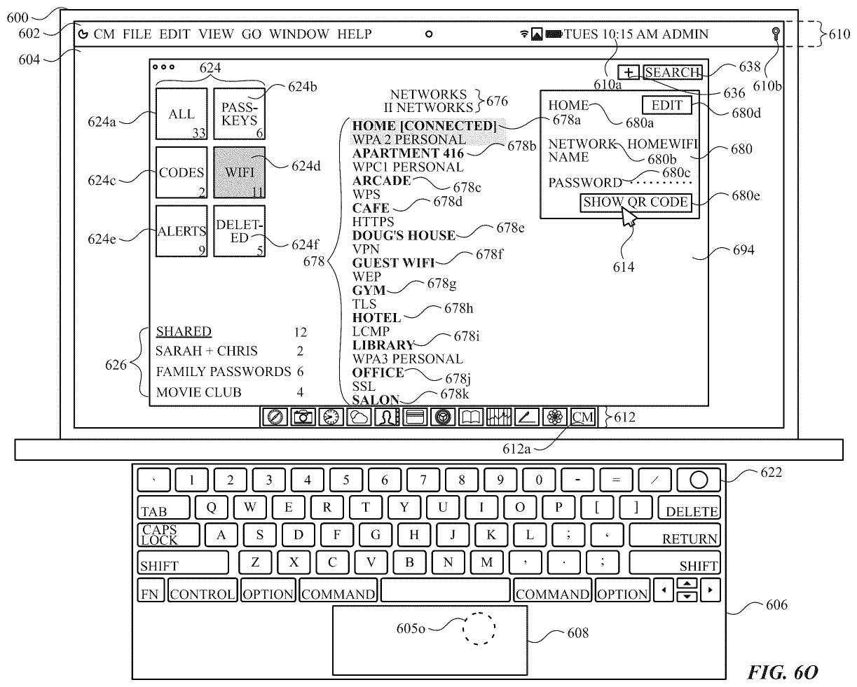

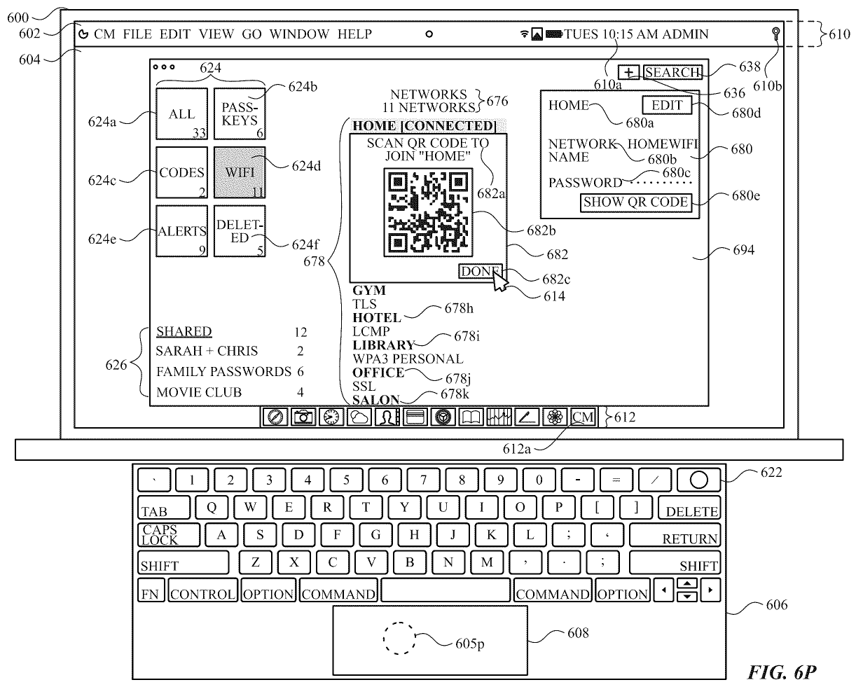

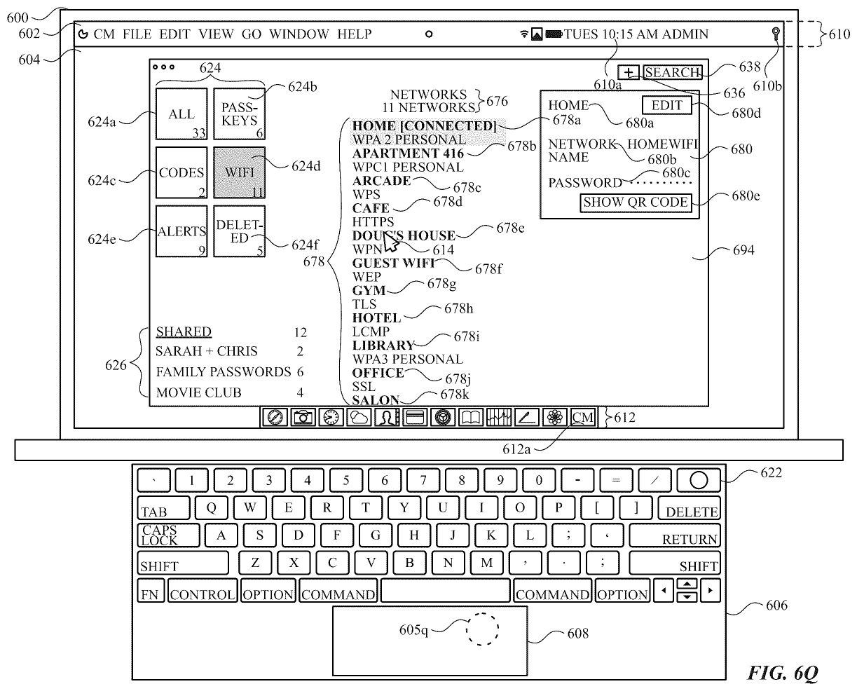

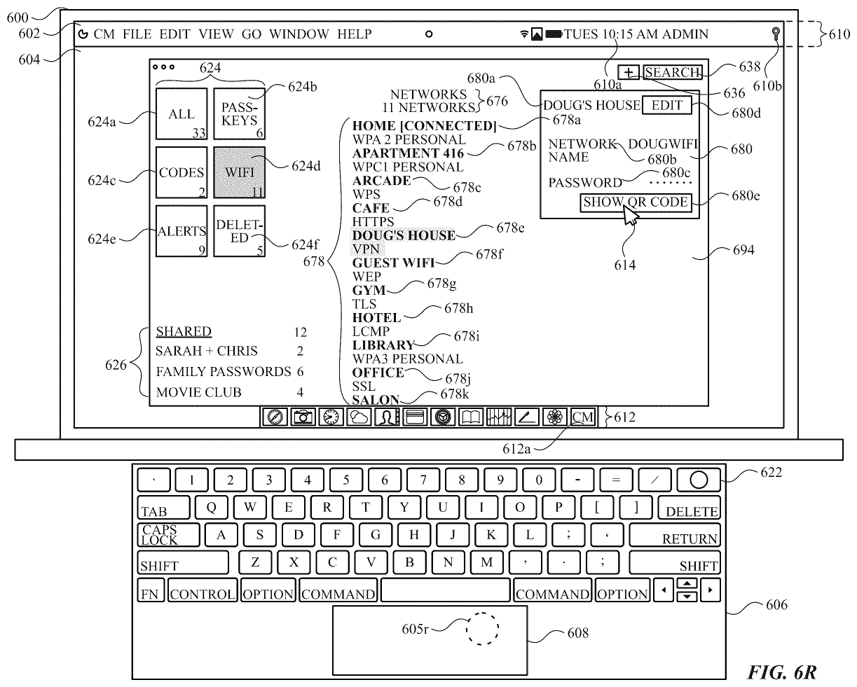

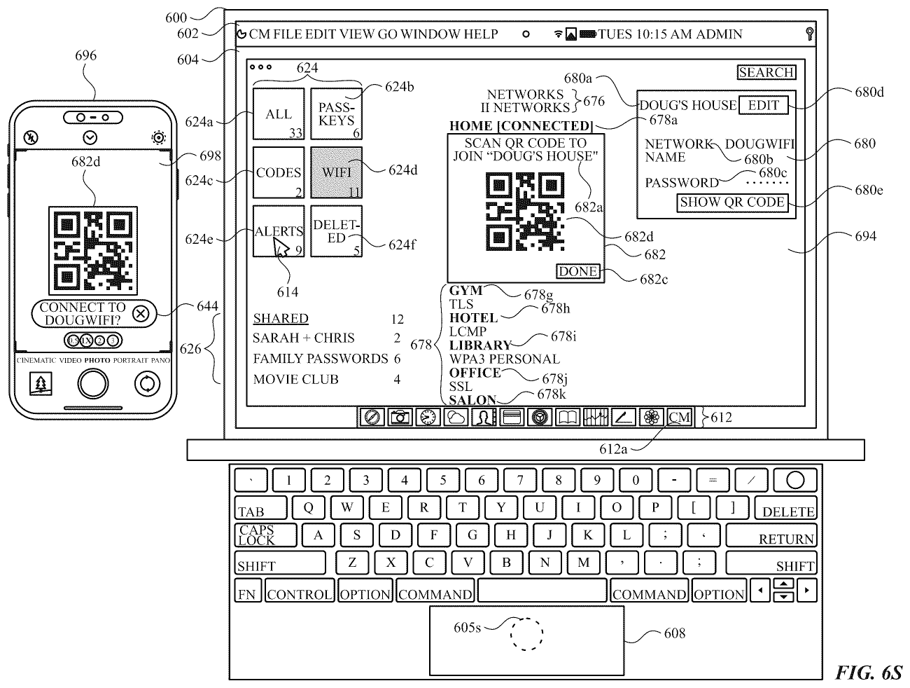

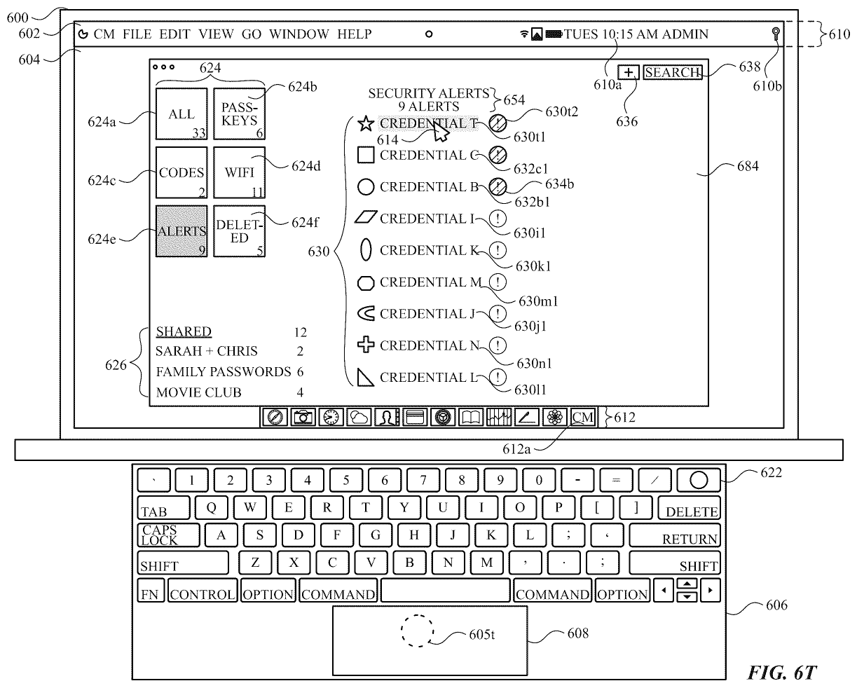

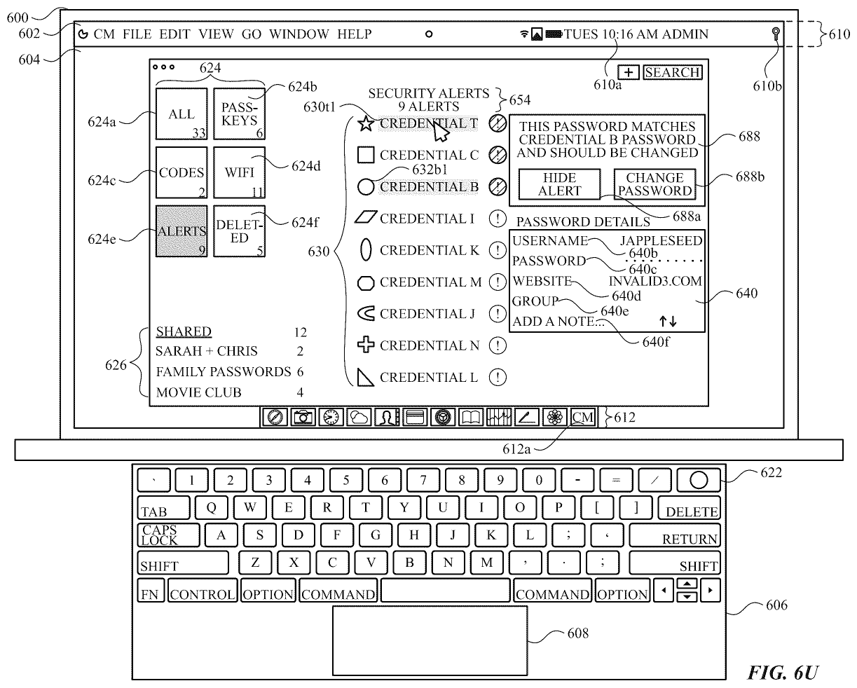

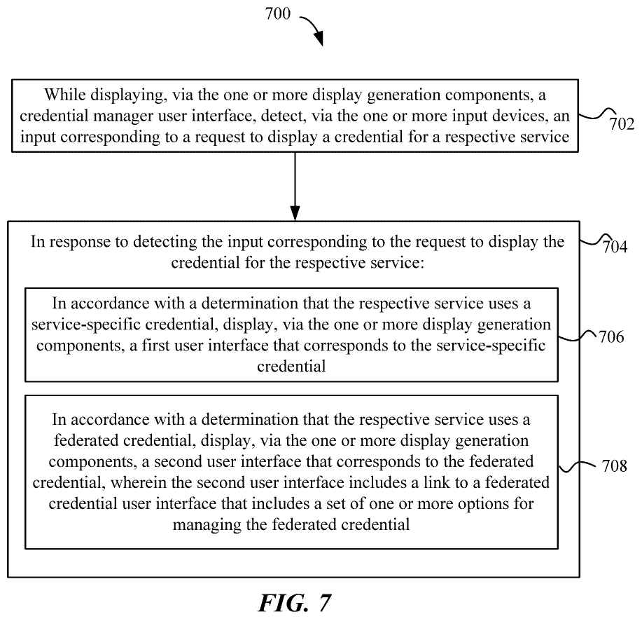

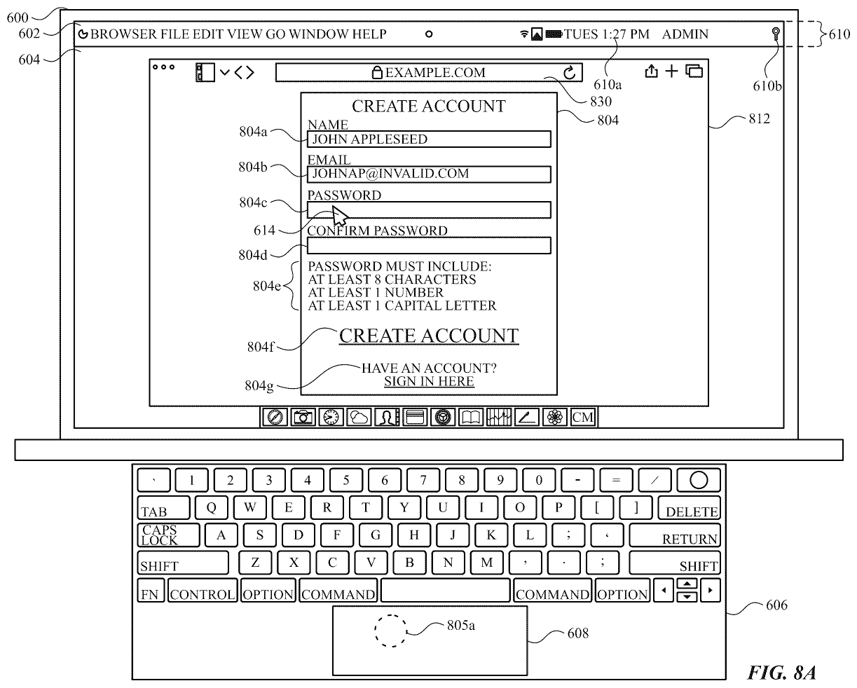

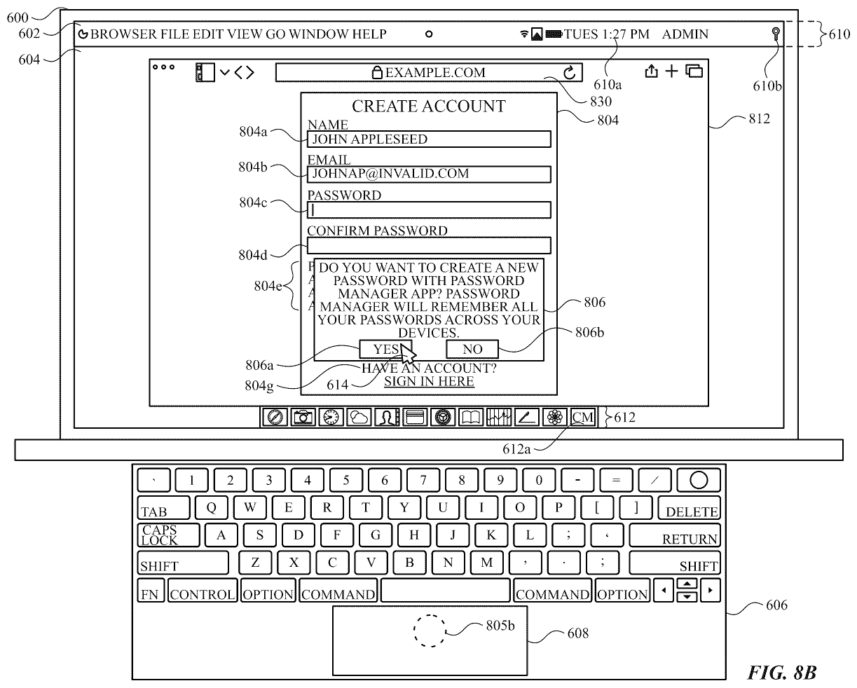

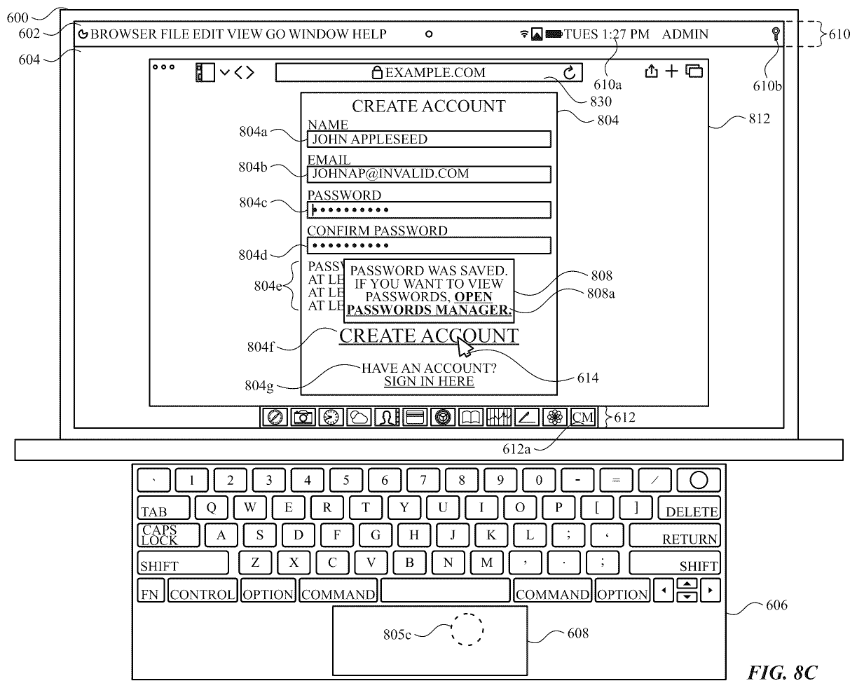

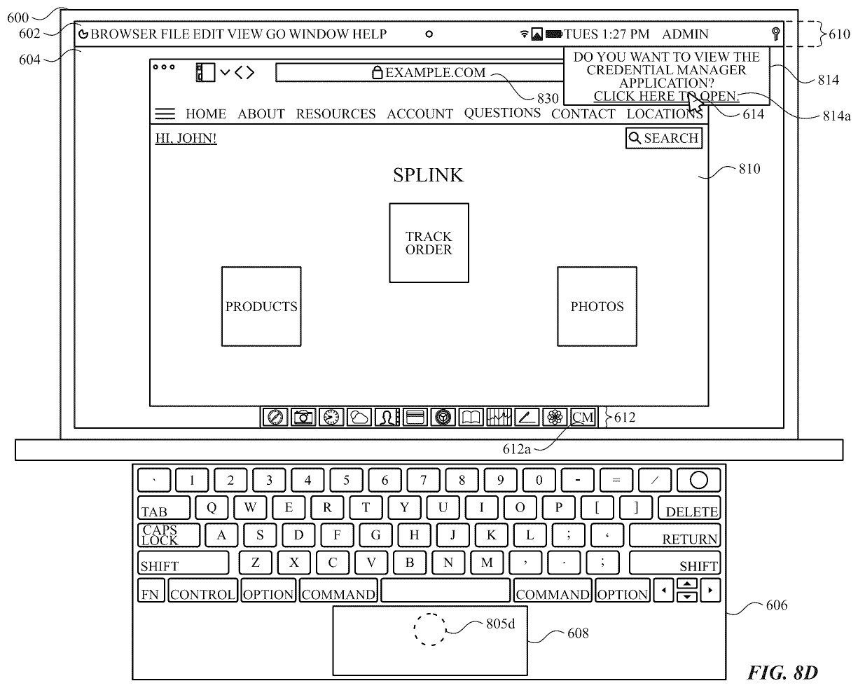

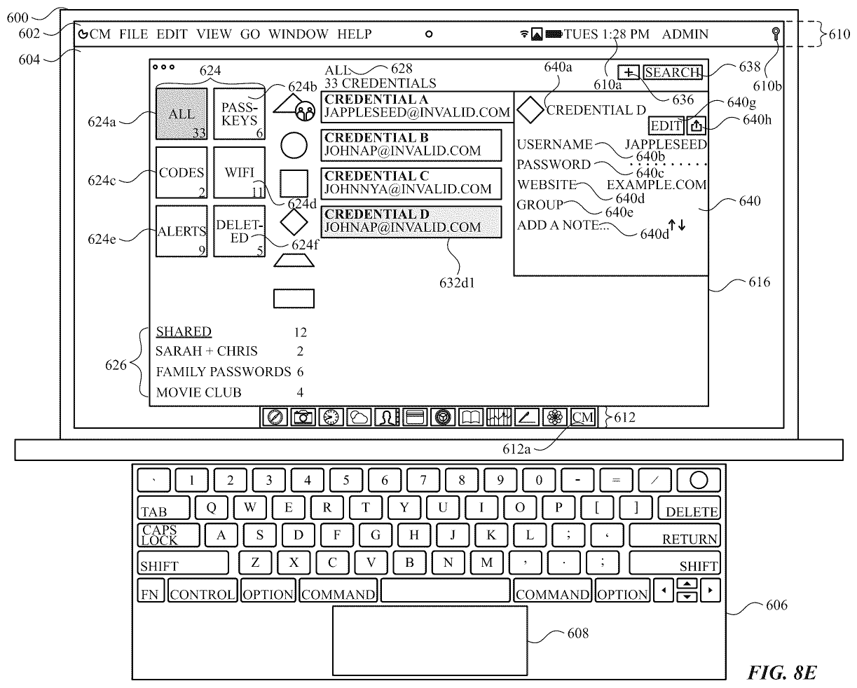

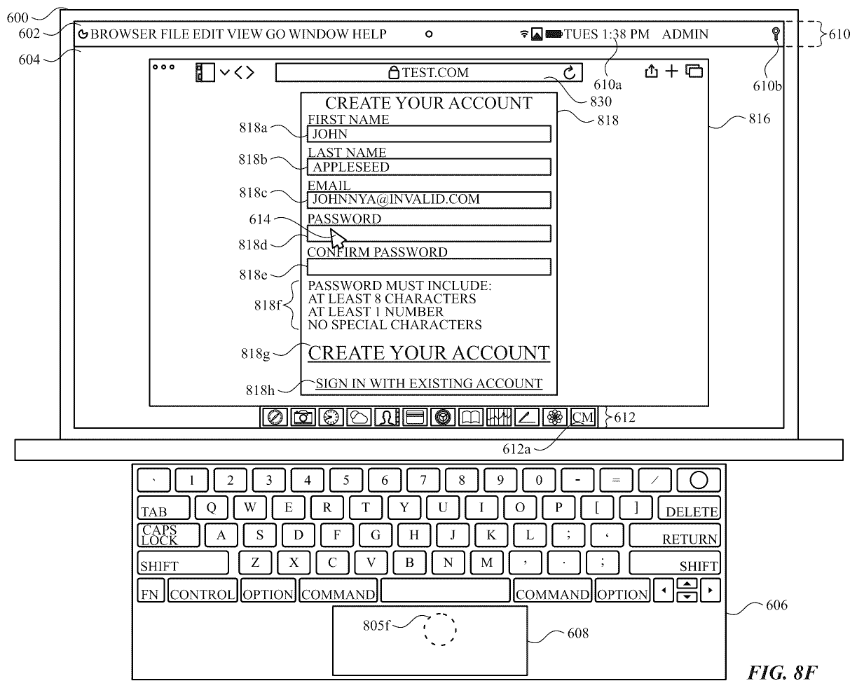

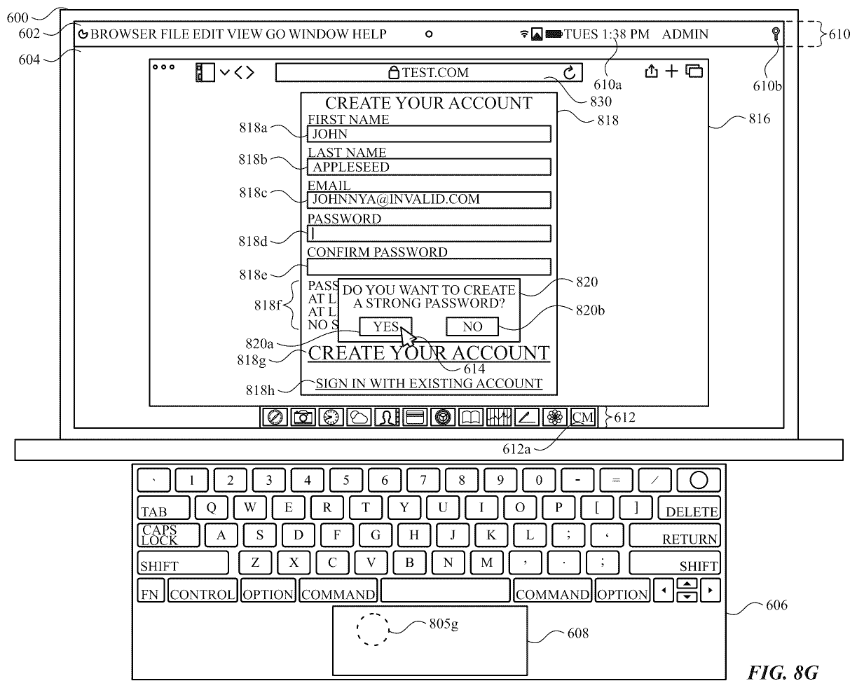

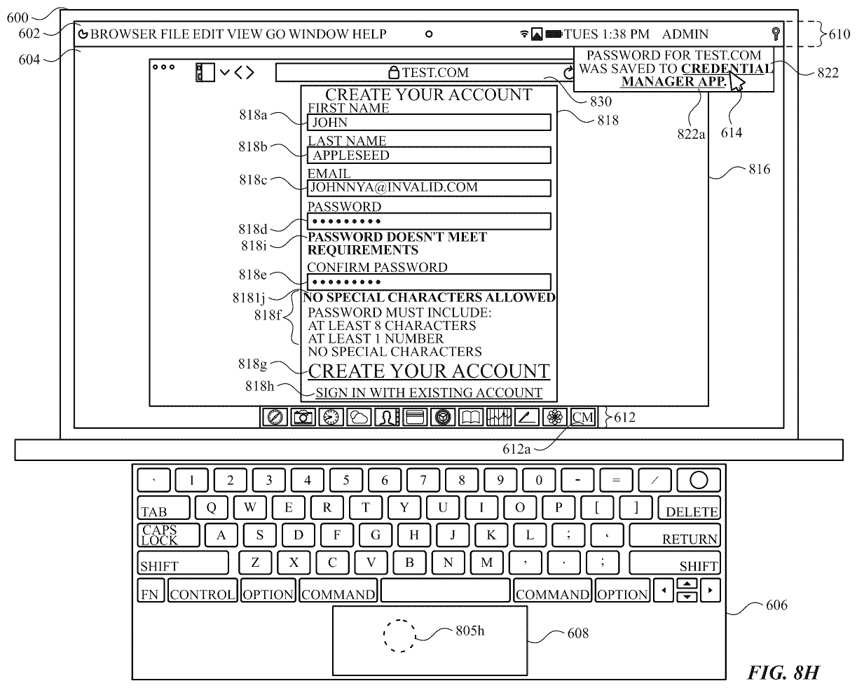

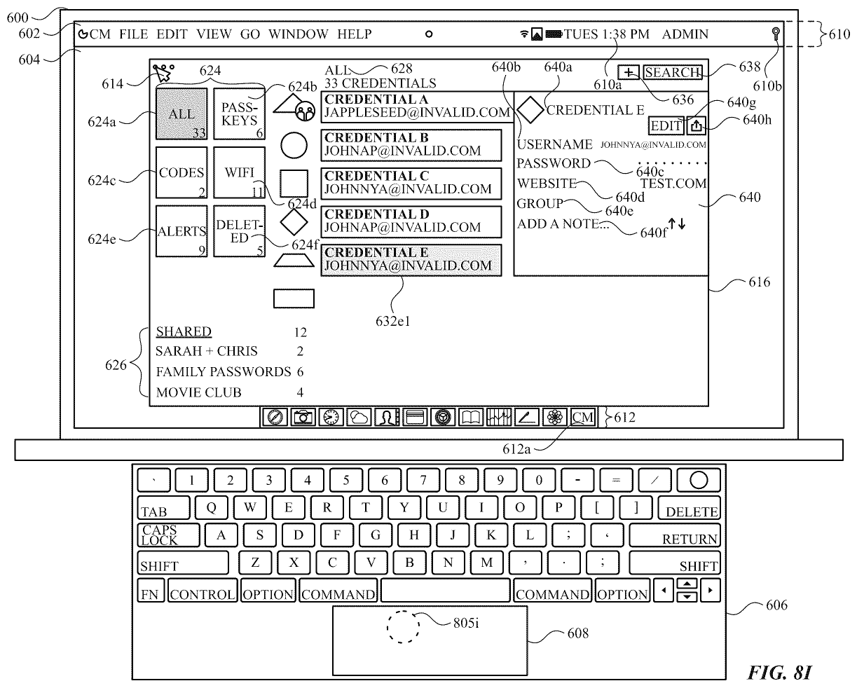

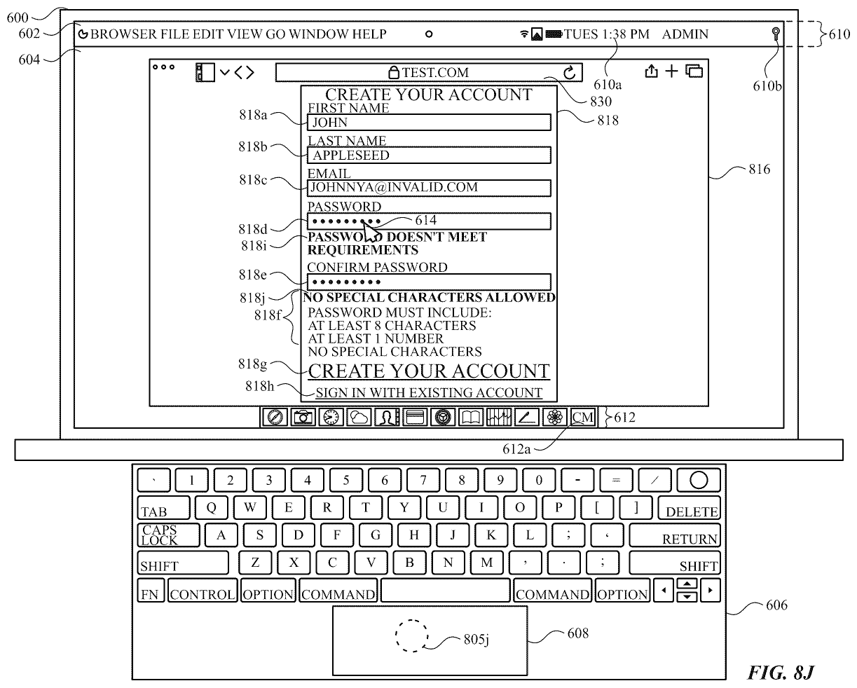

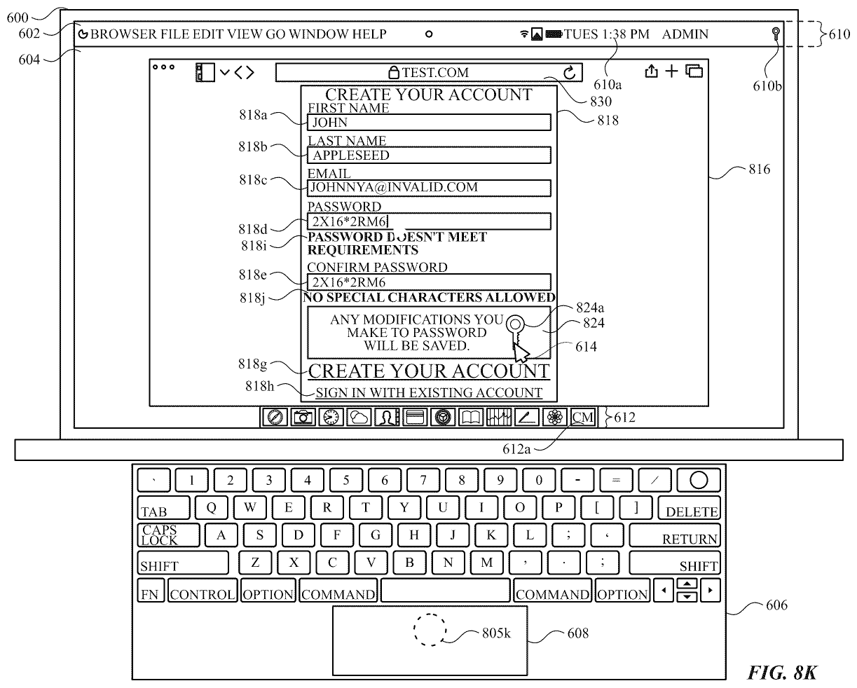

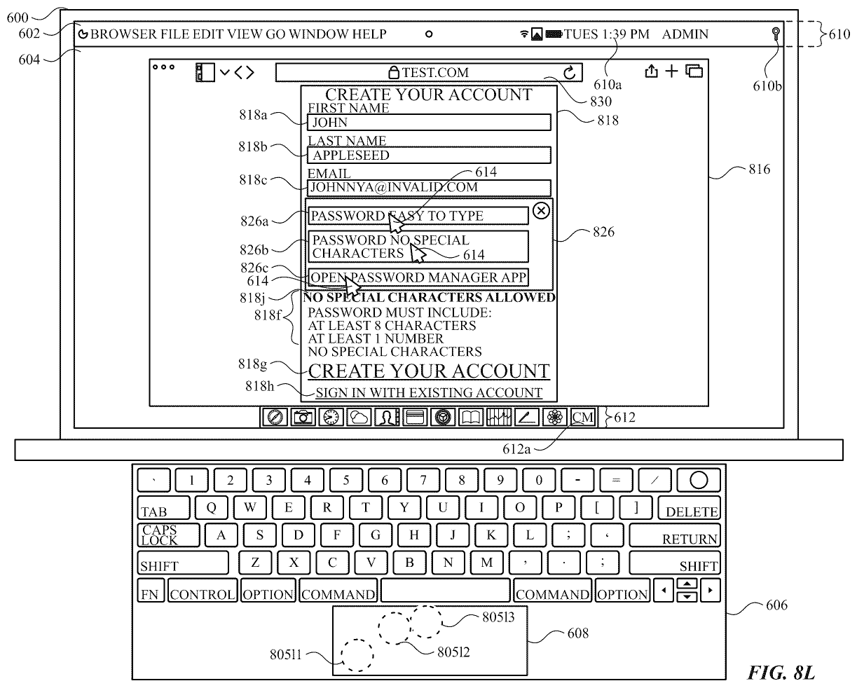

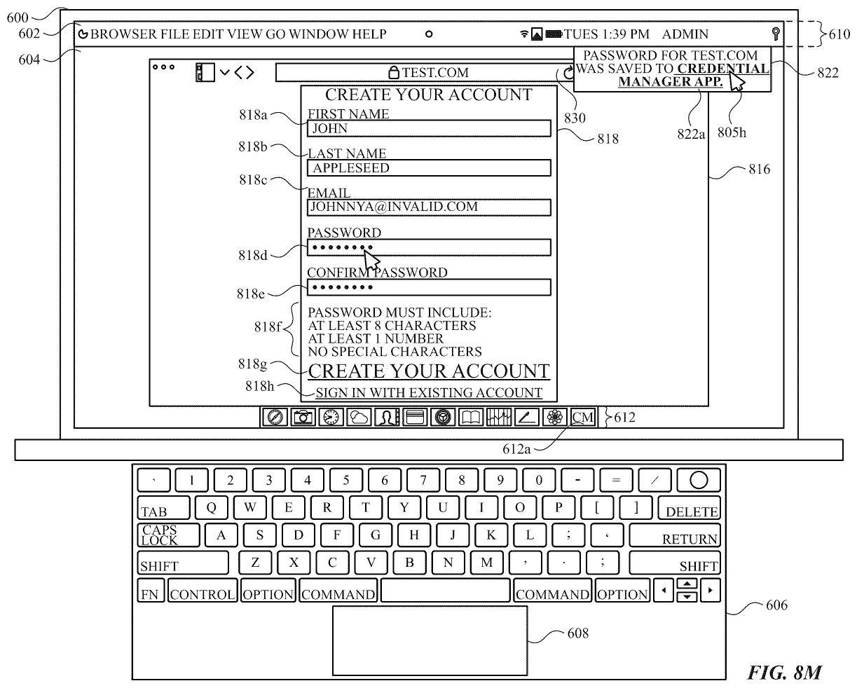

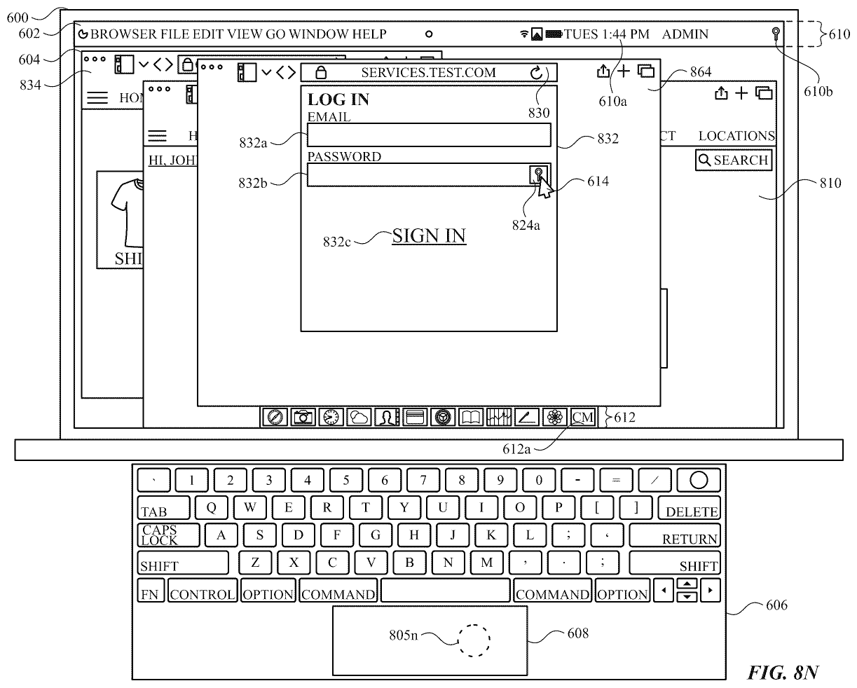

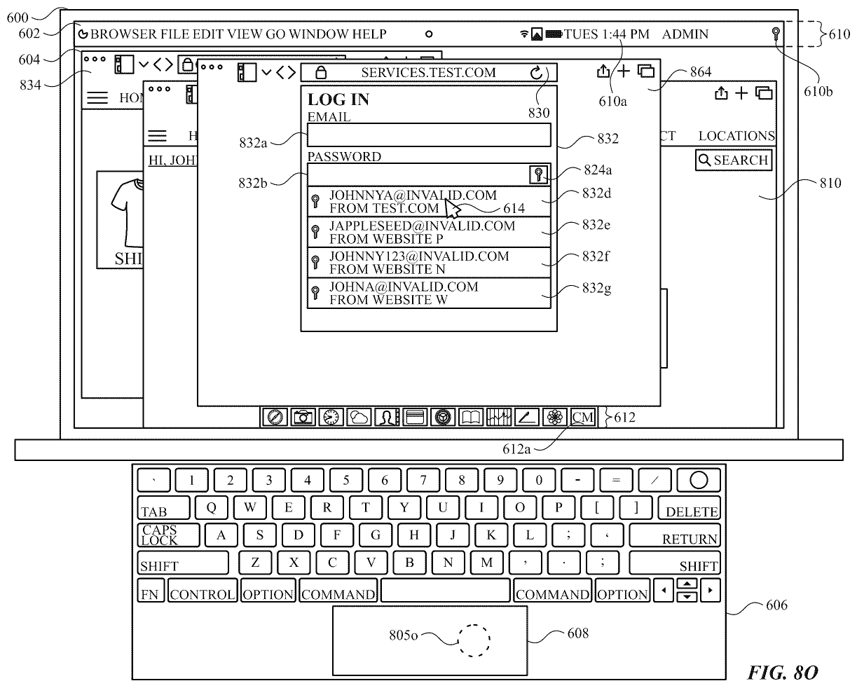

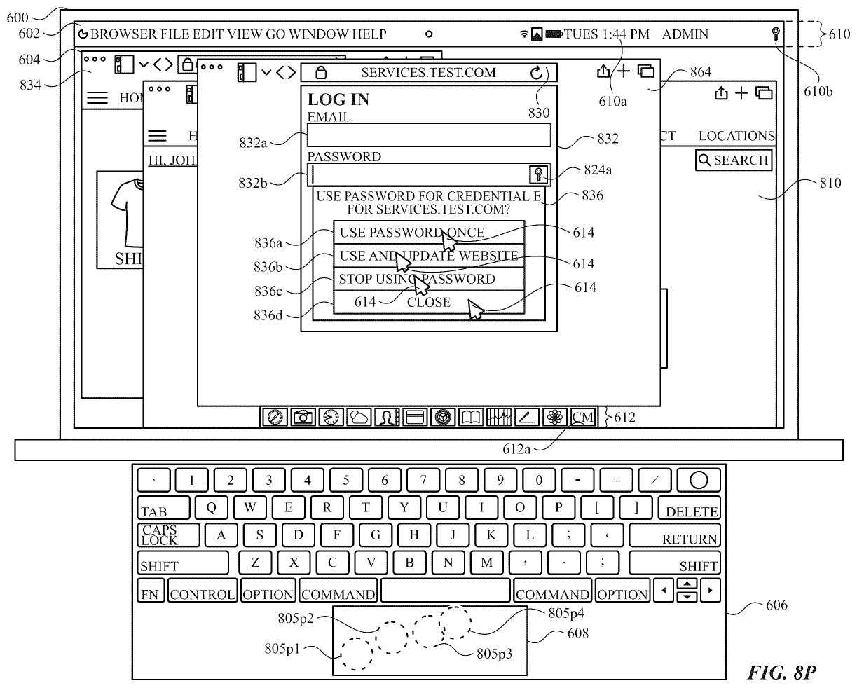

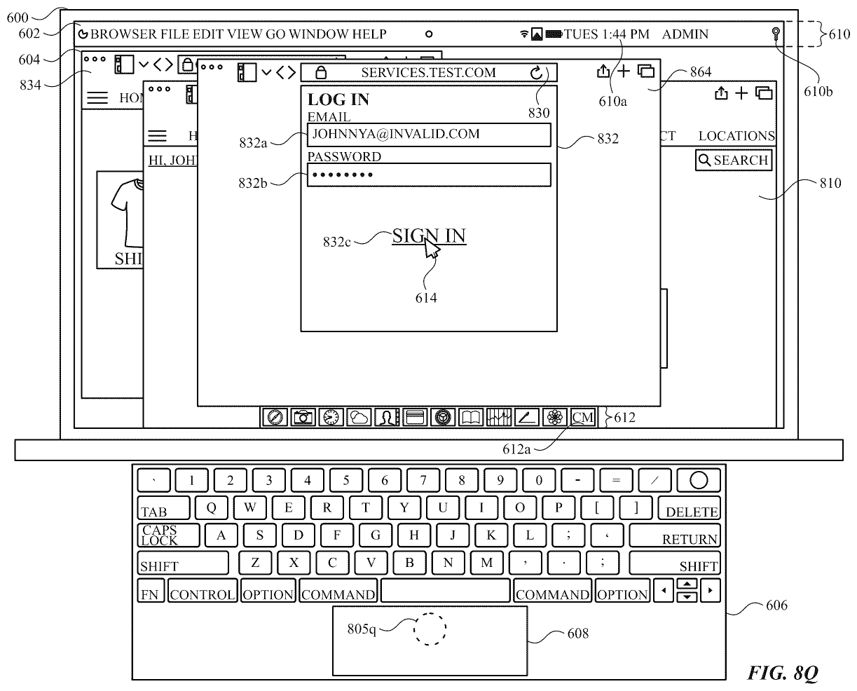

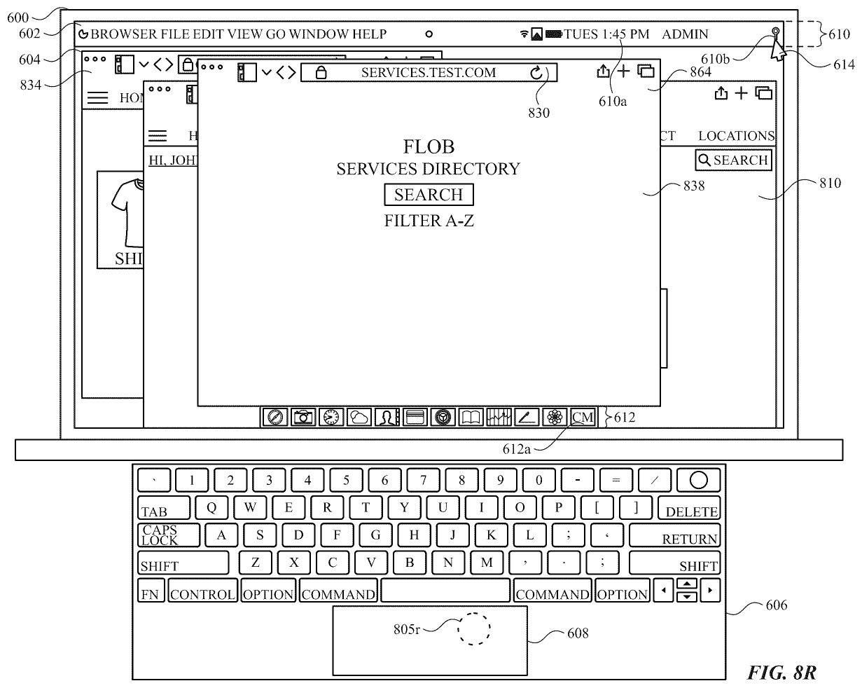

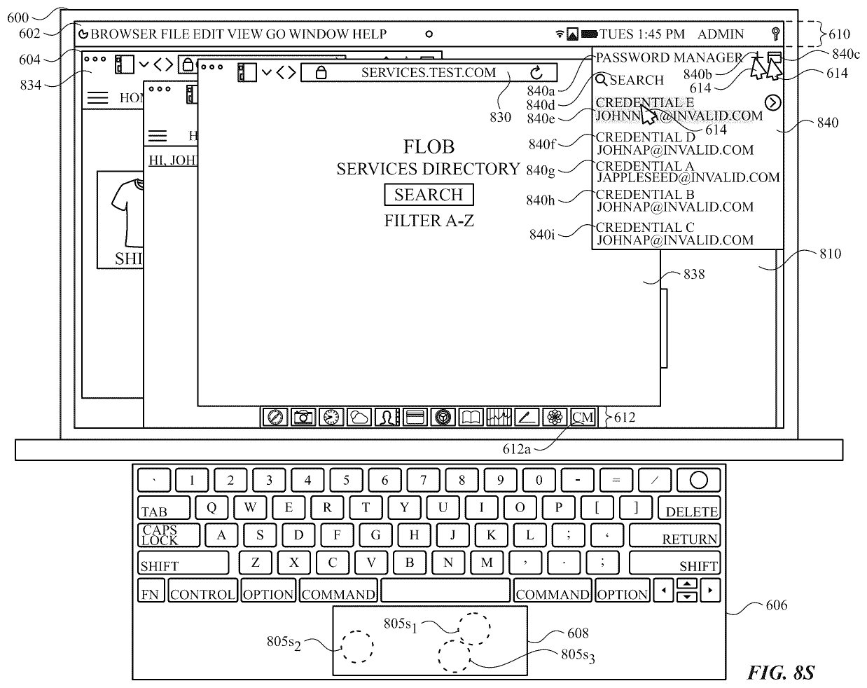

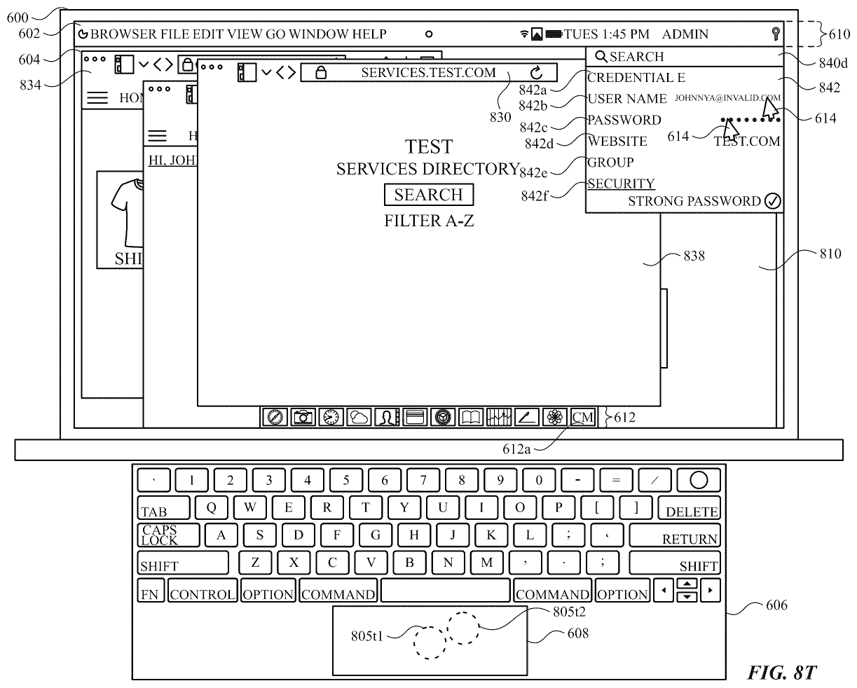

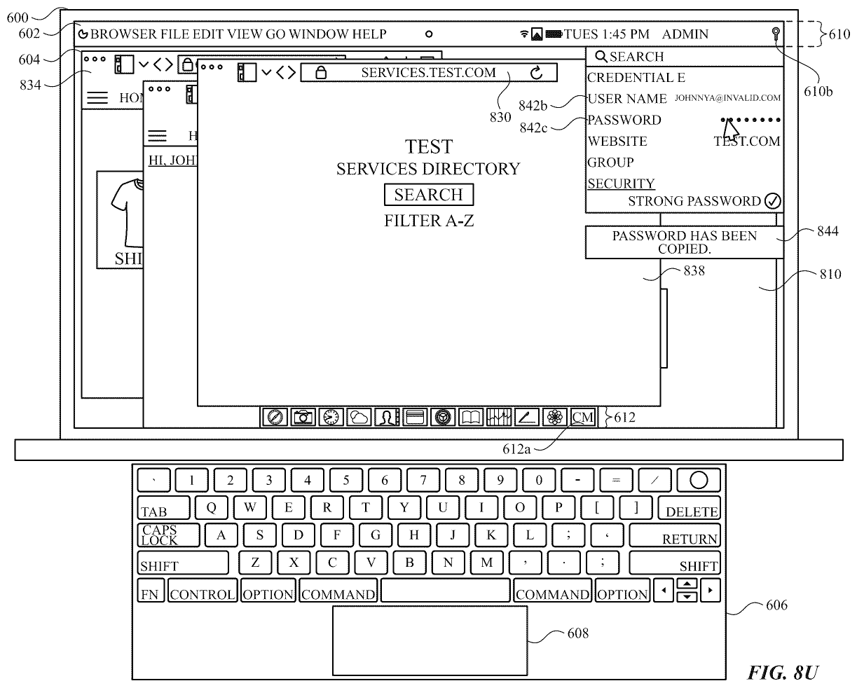

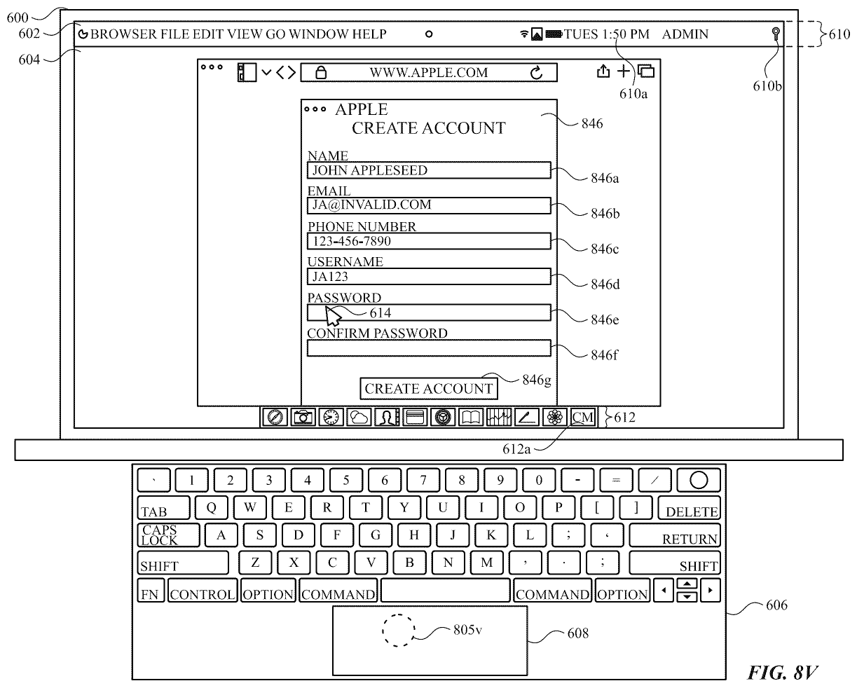

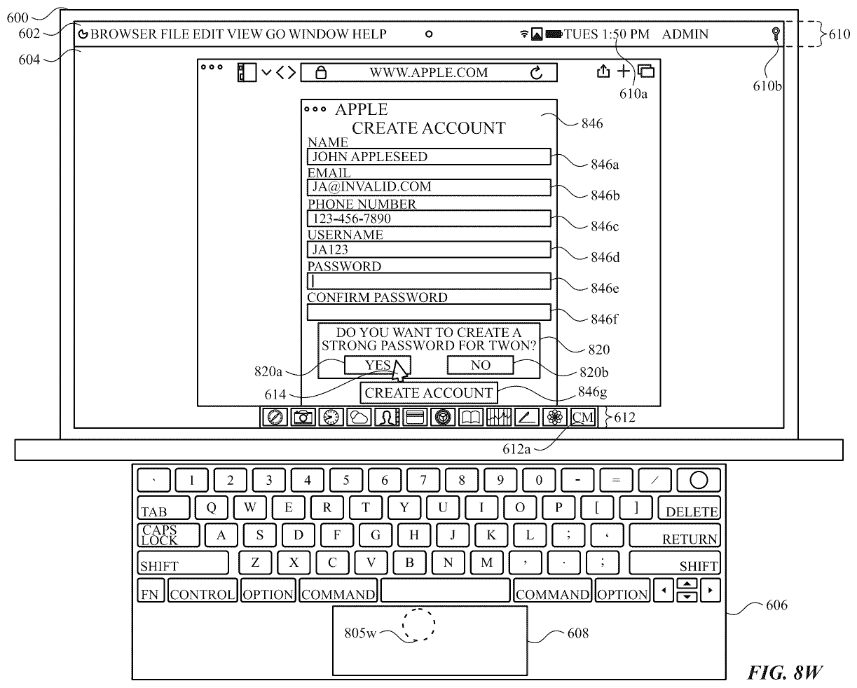

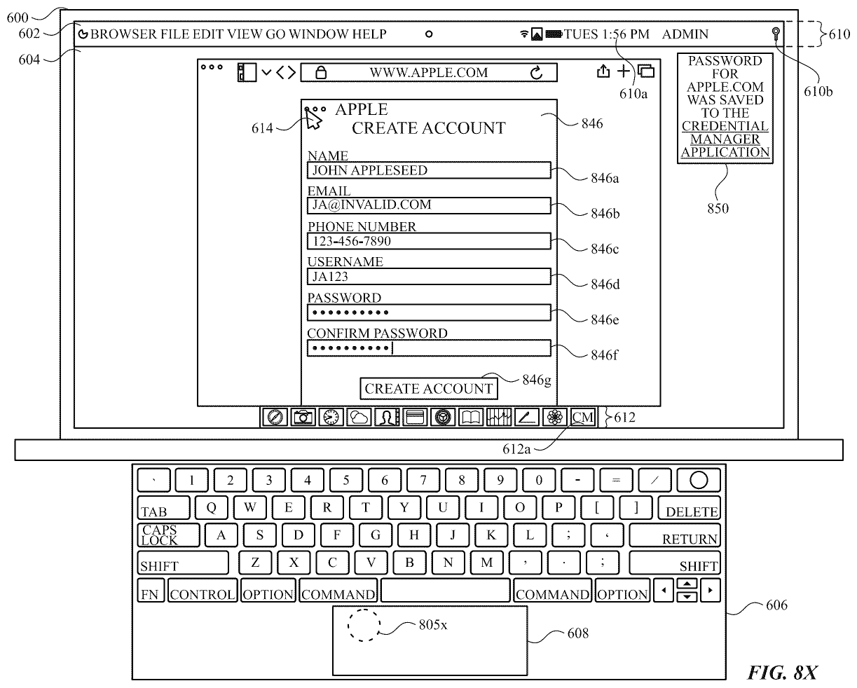

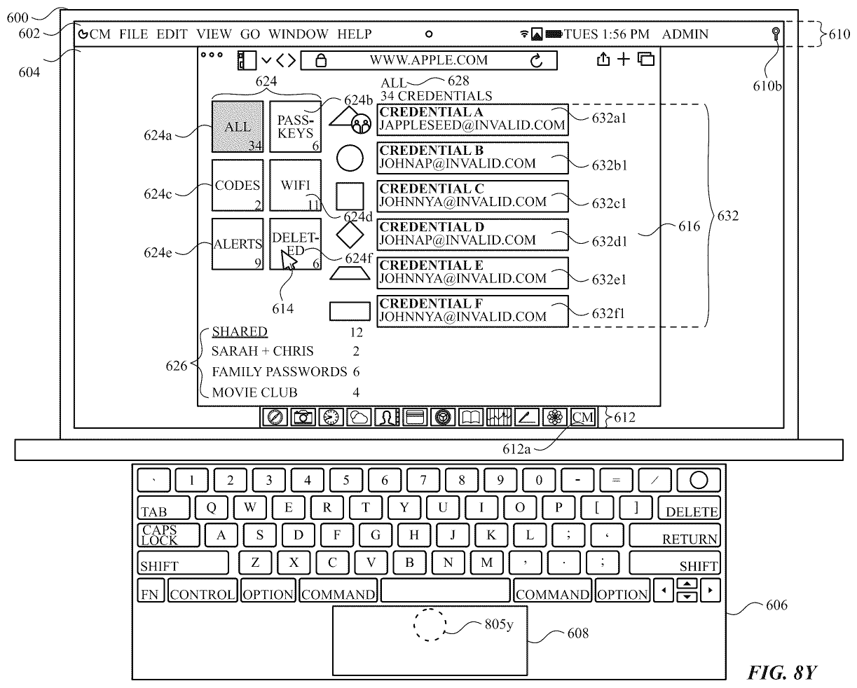

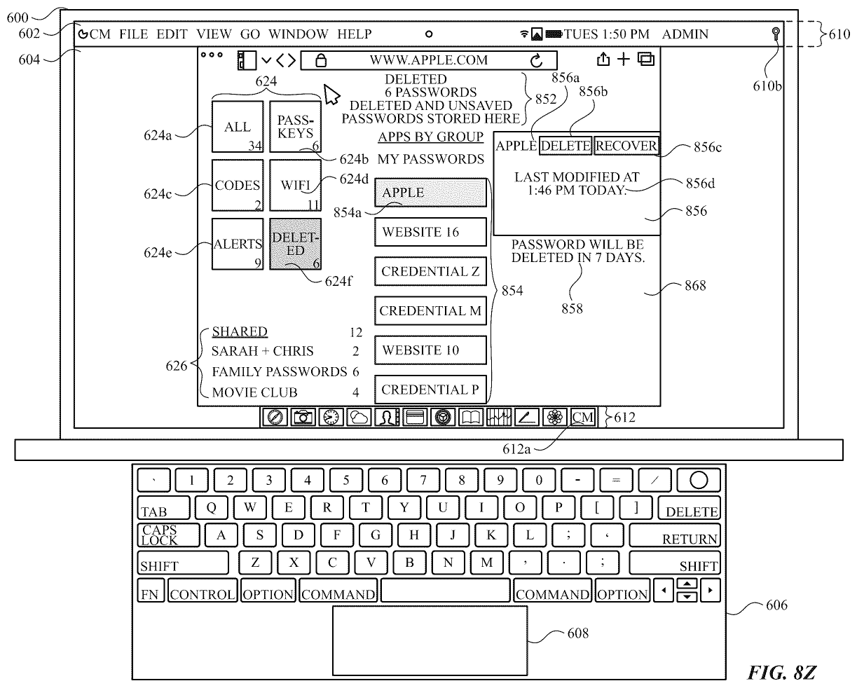

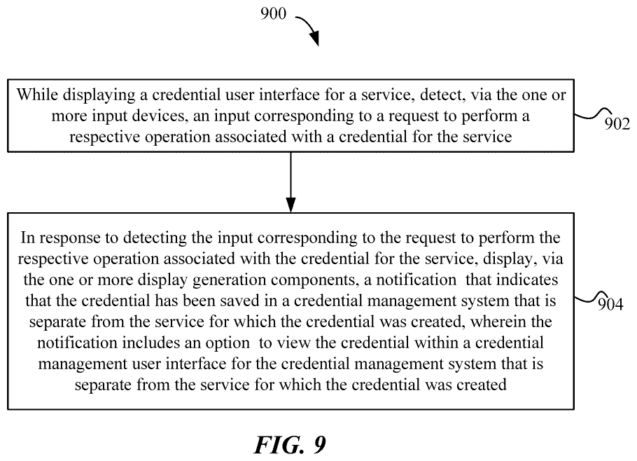

Below, FIGS. 1A-1B, 2, 3, 4A-4B, and 5A-5H provide a description of exemplary devices for performing the techniques for managing credentials. FIGS. 6A-6U illustrate exemplary user interfaces for displaying information related to credentials in accordance with some embodiments. FIG. 7 is a flow diagram illustrating a process for displaying information related to credentials in accordance with some embodiments. The user interfaces in FIGS. 6A-6U are used to illustrate the processes described below, including the processes in FIG. 7. FIGS. 8A-8Z illustrate exemplary user interfaces for displaying notifications regarding the saving of credentials in accordance with some embodiments. FIG. 9 is a flow diagram illustrating a process for displaying notifications regarding the saving of credentials in accordance with some embodiments. The user interfaces in FIGS. 8A-8Z are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in processes described herein where one or more steps are contingent upon one or more conditions having been met, it should be understood that the described processes can be repeated in multiple repetitions so that over the course of the repetitions all of the conditions upon which steps in the process are contingent have been met in different repetitions of the process. For example, if a process requires performing a first step if a condition is satisfied, and a second step if the condition is not satisfied, then a person of ordinary skill would appreciate that the claimed steps are repeated until the condition has been both satisfied and not satisfied, in no particular order. Thus, a process described with one or more steps that are contingent upon one or more conditions having been met could be rewritten as a process that is repeated until each of the conditions described in the process has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a process until all of the conditions upon which steps in the process are contingent have been met. A person having ordinary skill in the art would also understand that, similar to a process with contingent steps, a system or computer readable storage medium can repeat the steps of a process as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component (e.g., a display device such as a head-mounted display (HMD), a display, a projector, a touch-sensitive display, or other device component that presents visual content to a user, for example on or in the display generation component itself or produced from the display generation component and visible elsewhere). The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

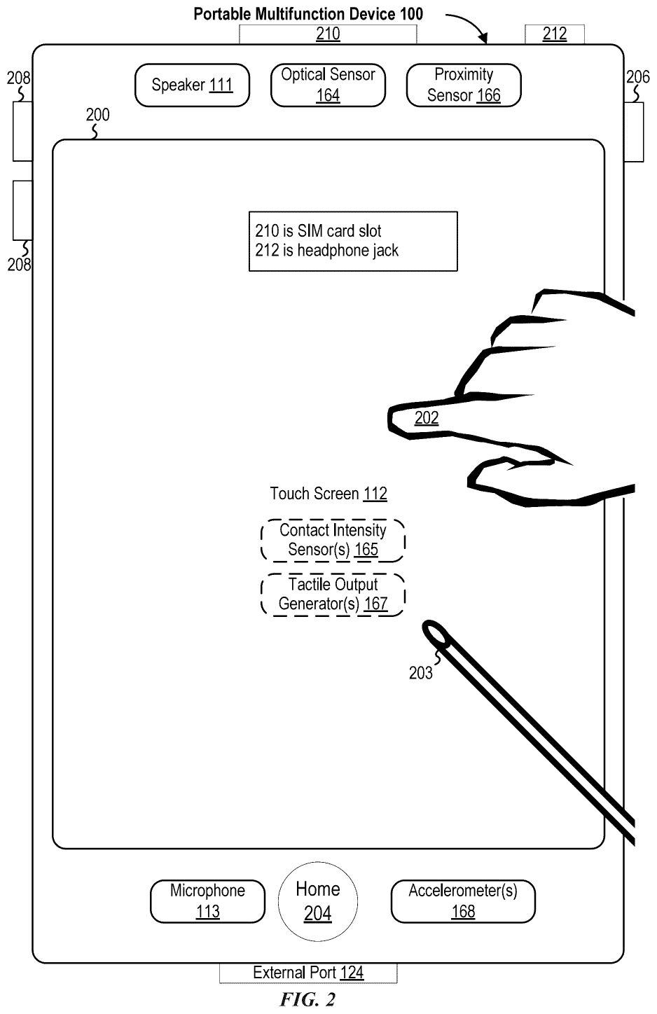

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

In some embodiments, a depth map (e.g., depth map image) contains information (e.g., values) that relates to the distance of objects in a scene from a viewpoint (e.g., a camera, an optical sensor, a depth camera sensor). In one embodiment of a depth map, each depth pixel defines the position in the viewpoint's Z-axis where its corresponding two-dimensional pixel is located. In some embodiments, a depth map is composed of pixels wherein each pixel is defined by a value (e.g., 0-255). For example, the “0” value represents pixels that are located at the most distant place in a “three dimensional” scene and the “255” value represents pixels that are located closest to a viewpoint (e.g., a camera, an optical sensor, a depth camera sensor) in the “three dimensional” scene. In other embodiments, a depth map represents the distance between an object in a scene and the plane of the viewpoint. In some embodiments, the depth map includes information about the relative depth of various features of an object of interest in view of the depth camera (e.g., the relative depth of eyes, nose, mouth, ears of a user's face). In some embodiments, the depth map includes information that enables the device to determine contours of the object of interest in a z direction.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

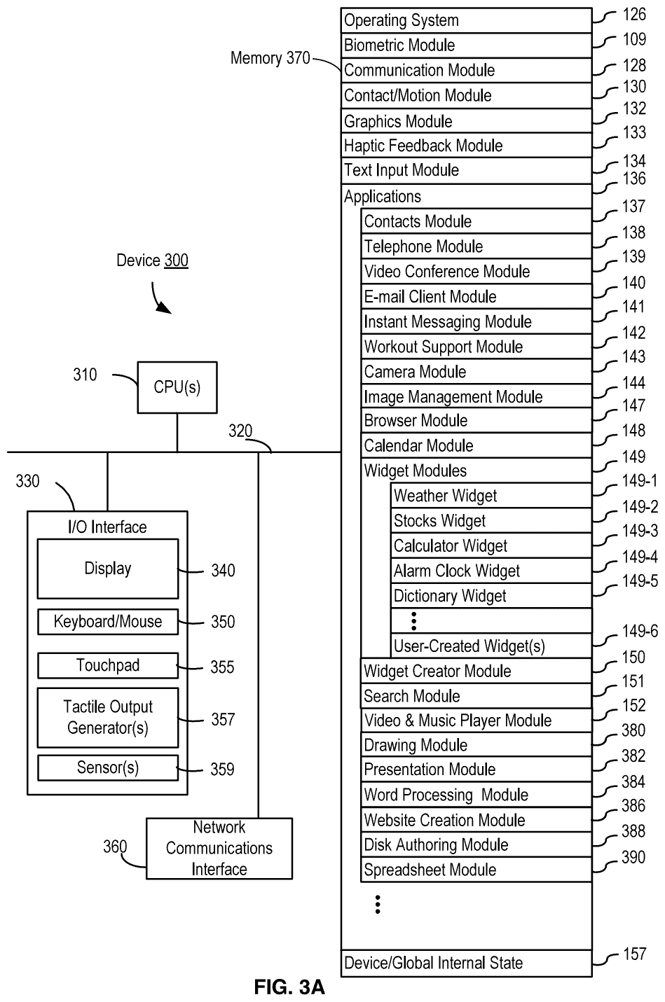

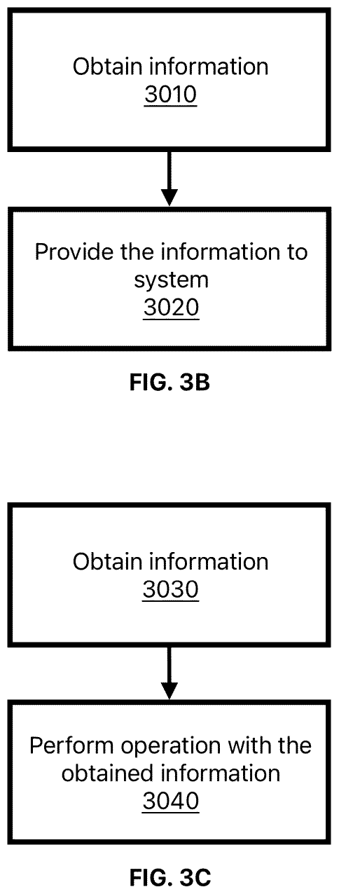

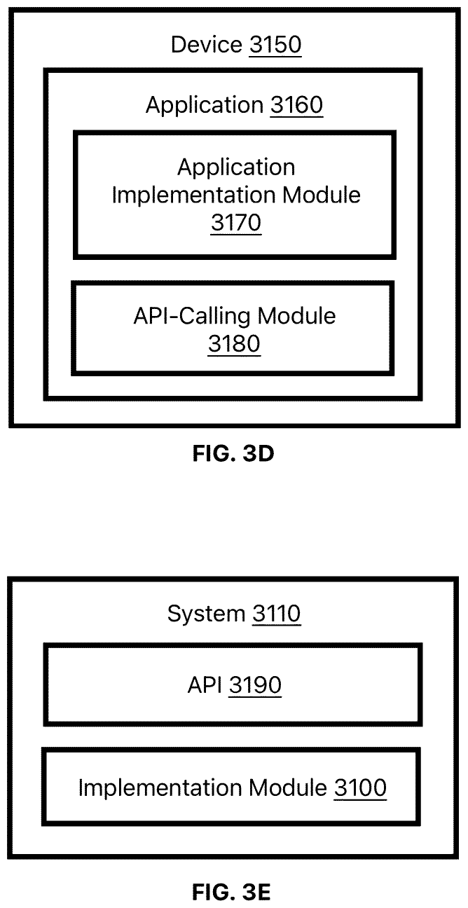

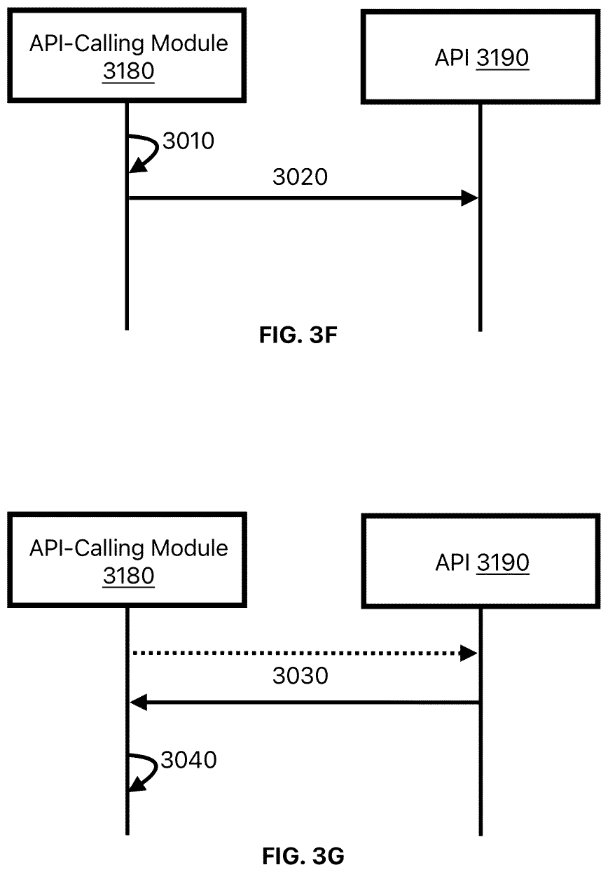

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3A) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the processes described in this application (e.g., the computer-implemented processes and other information processing processes described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits processes and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first party application). In some embodiments, application 3160 is an application that is provided to device 3150 via an operating system update file (e.g., a first party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server, etc.). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device.) that includes an operating system.

Referring to FIG. 3C and FIG. 3G, application 3160 obtains information (e.g., 3030). In some embodiments, the information obtained at 3030 includes positional information, time information, notification information, user information, environment information, electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low-level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing a secure connection (e.g., with an accessory), a device detection API (e.g., for locating nearby devices (e.g., media devices and/or smartphone)), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation module 3100 is a system (e.g., operating system, and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example when an input is detected, the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by AP I-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

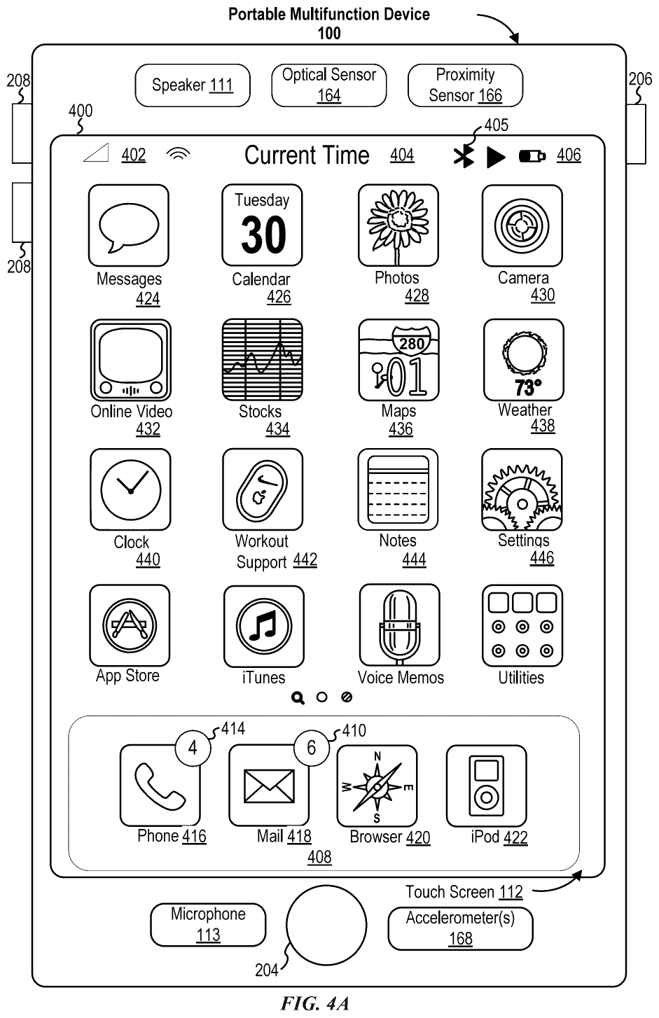

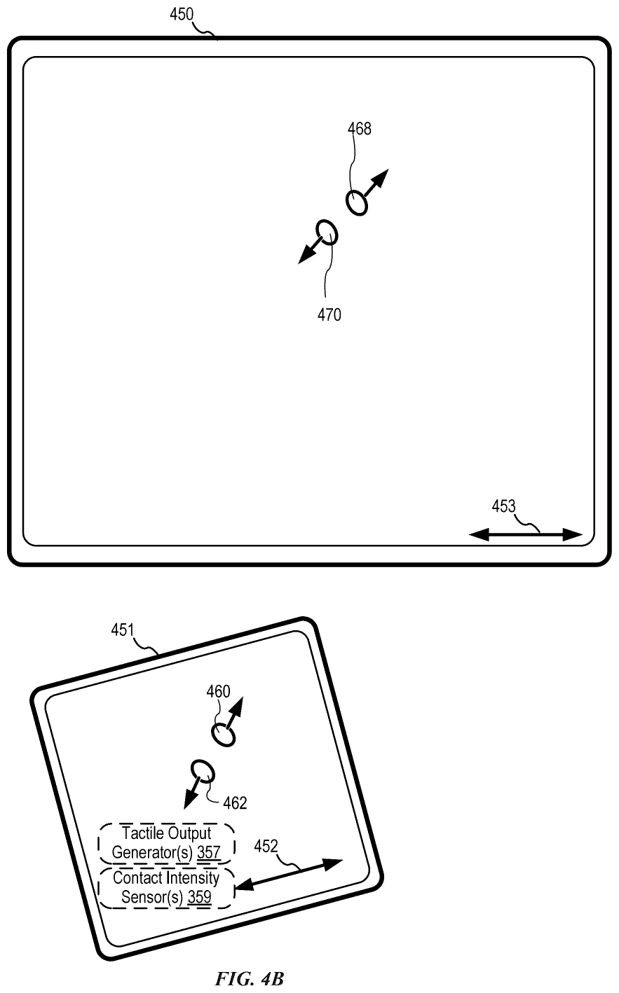

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar processes are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

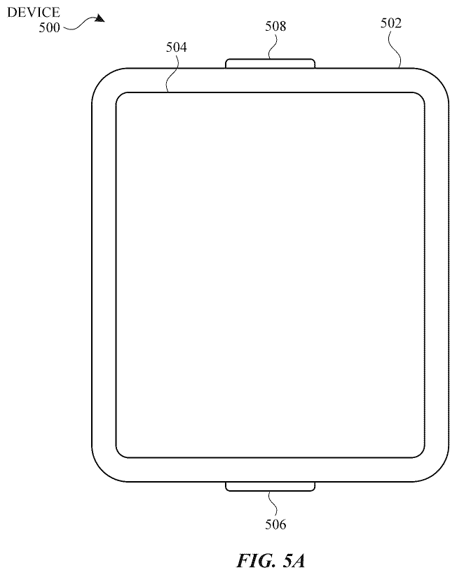

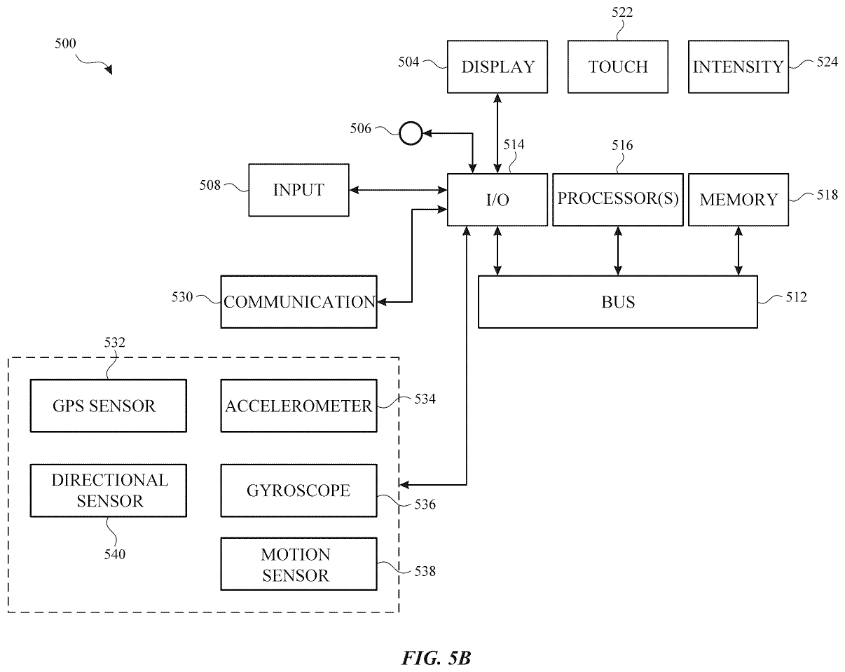

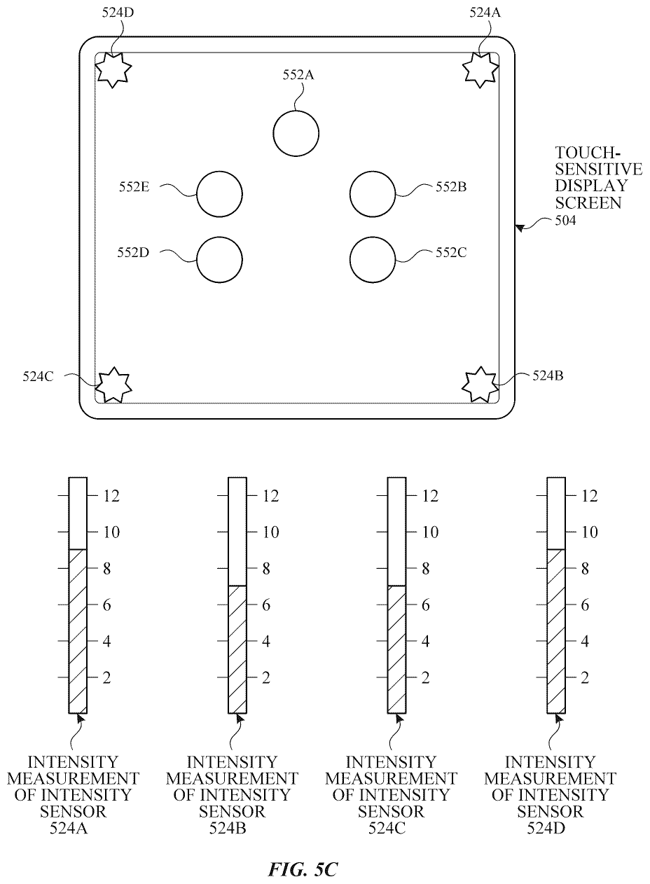

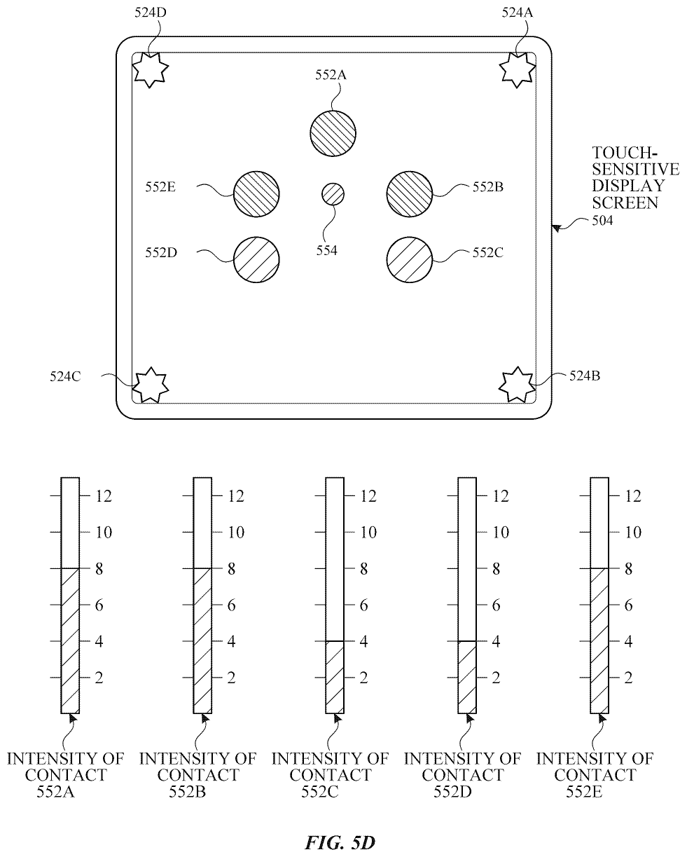

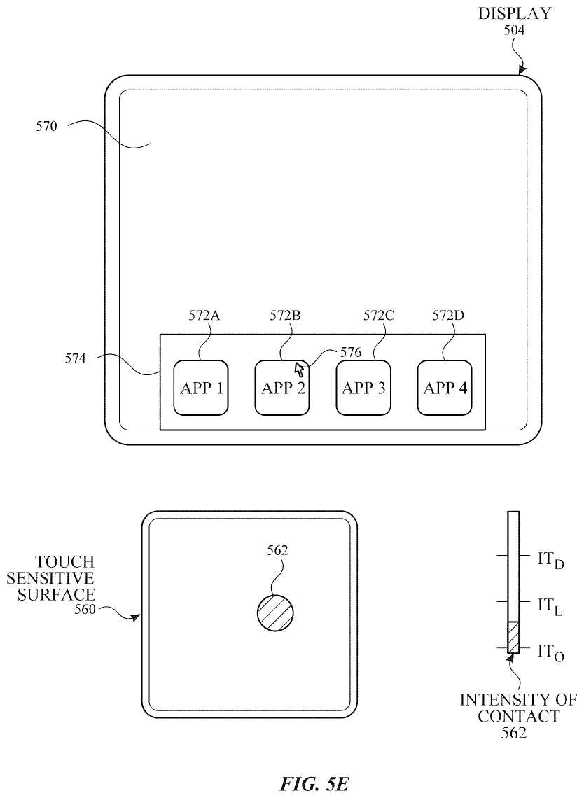

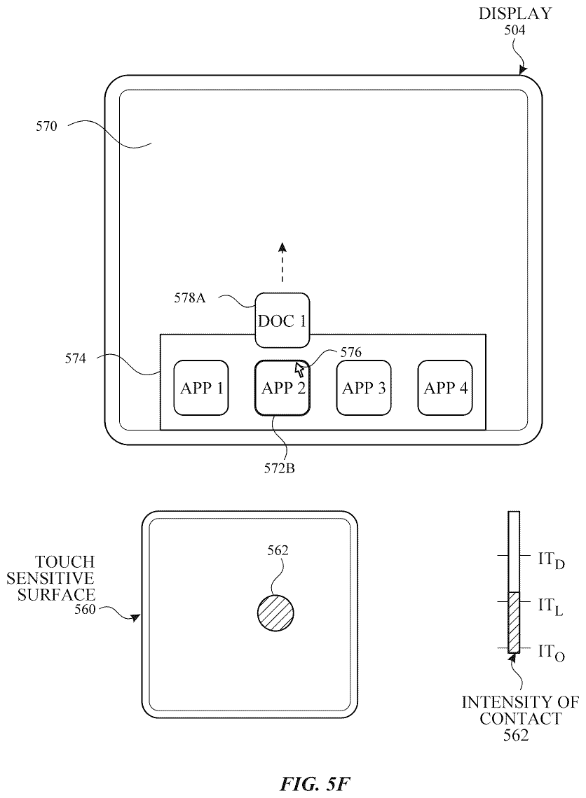

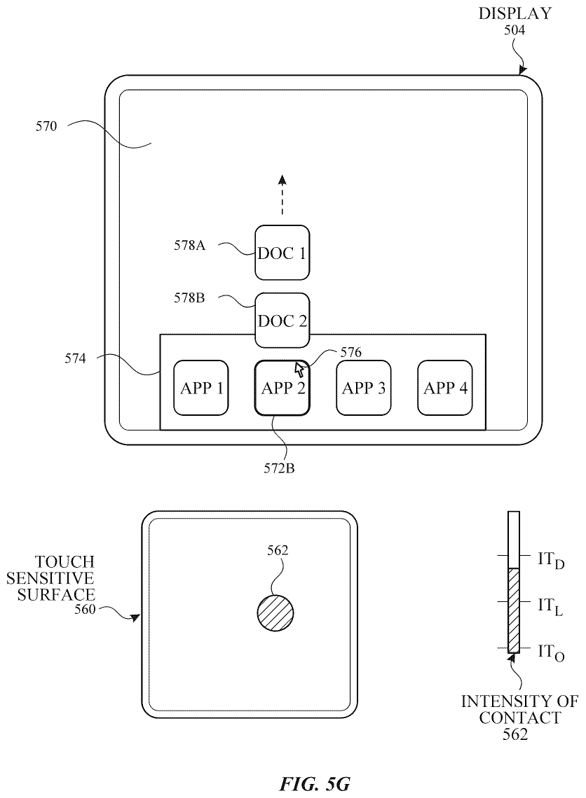

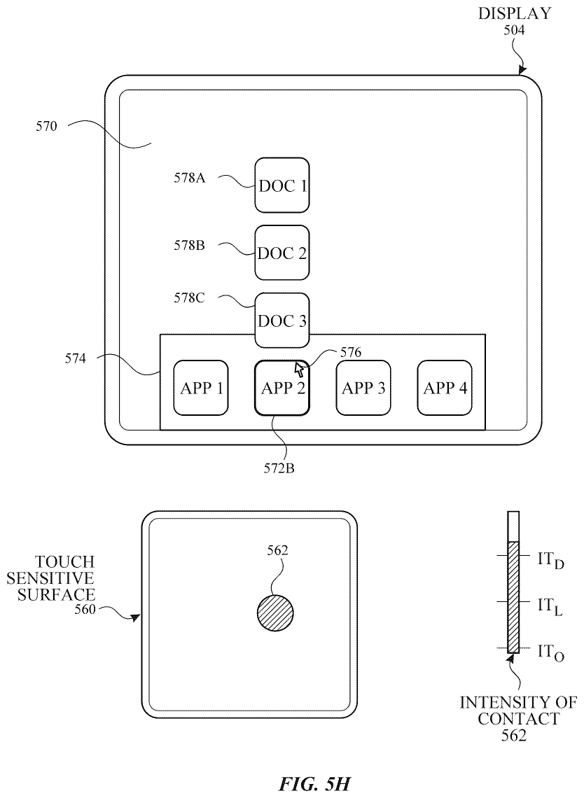

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including methods 700 and 900 (FIGS. 7 and 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

FIG. 5C illustrates detecting a plurality of contacts 552A-552E on touch-sensitive display screen 504 with a plurality of intensity sensors 524A-524D. FIG. 5C additionally includes intensity diagrams that show the current intensity measurements of the intensity sensors 524A-524D relative to units of intensity. In this example, the intensity measurements of intensity sensors 524A and 524D are each 9 units of intensity, and the intensity measurements of intensity sensors 524B and 524C are each 7 units of intensity. In some implementations, an aggregate intensity is the sum of the intensity measurements of the plurality of intensity sensors 524A-524D, which in this example is 32 intensity units. In some embodiments, each contact is assigned a respective intensity that is a portion of the aggregate intensity. FIG. 5D illustrates assigning the aggregate intensity to contacts 552A-552E based on their distance from the center of force 554. In this example, each of contacts 552A, 552B, and 552E are assigned an intensity of contact of 8 intensity units of the aggregate intensity, and each of contacts 552C and 552D are assigned an intensity of contact of 4 intensity units of the aggregate intensity. More generally, in some implementations, each contact j is assigned a respective intensity Ij that is a portion of the aggregate intensity, A, in accordance with a predefined mathematical function, Ij=A·(Dj/ΣDi), where Dj is the distance of the respective contact j to the center of force, and ΣDi is the sum of the distances of all the respective contacts (e.g., i=1 to last) to the center of force. The operations described with reference to FIGS. 5C-5D can be performed using an electronic device similar or identical to device 100, 300, or 500. In some embodiments, a characteristic intensity of a contact is based on one or more intensities of the contact. In some embodiments, the intensity sensors are used to determine a single characteristic intensity (e.g., a single characteristic intensity of a single contact). It should be noted that the intensity diagrams are not part of a displayed user interface, but are included in FIGS. 5C-5D to aid the reader.

In some embodiments, a portion of a gesture is identified for purposes of determining a characteristic intensity. For example, a touch-sensitive surface optionally receives a continuous swipe contact transitioning from a start location and reaching an end location, at which point the intensity of the contact increases. In this example, the characteristic intensity of the contact at the end location is, optionally, based on only a portion of the continuous swipe contact, and not the entire swipe contact (e.g., only the portion of the swipe contact at the end location). In some embodiments, a smoothing algorithm is, optionally, applied to the intensities of the swipe contact prior to determining the characteristic intensity of the contact. For example, the smoothing algorithm optionally includes one or more of: an unweighted sliding-average smoothing algorithm, a triangular smoothing algorithm, a median filter smoothing algorithm, and/or an exponential smoothing algorithm. In some circumstances, these smoothing algorithms eliminate narrow spikes or dips in the intensities of the swipe contact for purposes of determining a characteristic intensity.

The intensity of a contact on the touch-sensitive surface is, optionally, characterized relative to one or more intensity thresholds, such as a contact-detection intensity threshold, a light press intensity threshold, a deep press intensity threshold, and/or one or more other intensity thresholds. In some embodiments, the light press intensity threshold corresponds to an intensity at which the device will perform operations typically associated with clicking a button of a physical mouse or a trackpad. In some embodiments, the deep press intensity threshold corresponds to an intensity at which the device will perform operations that are different from operations typically associated with clicking a button of a physical mouse or a trackpad. In some embodiments, when a contact is detected with a characteristic intensity below the light press intensity threshold (e.g., and above a nominal contact-detection intensity threshold below which the contact is no longer detected), the device will move a focus selector in accordance with movement of the contact on the touch-sensitive surface without performing an operation associated with the light press intensity threshold or the deep press intensity threshold. Generally, unless otherwise stated, these intensity thresholds are consistent between different sets of user interface figures.

An increase of characteristic intensity of the contact from an intensity below the light press intensity threshold to an intensity between the light press intensity threshold and the deep press intensity threshold is sometimes referred to as a “light press” input. An increase of characteristic intensity of the contact from an intensity below the deep press intensity threshold to an intensity above the deep press intensity threshold is sometimes referred to as a “deep press” input. An increase of characteristic intensity of the contact from an intensity below the contact-detection intensity threshold to an intensity between the contact-detection intensity threshold and the light press intensity threshold is sometimes referred to as detecting the contact on the touch-surface. A decrease of characteristic intensity of the contact from an intensity above the contact-detection intensity threshold to an intensity below the contact-detection intensity threshold is sometimes referred to as detecting liftoff of the contact from the touch-surface. In some embodiments, the contact-detection intensity threshold is zero. In some embodiments, the contact-detection intensity threshold is greater than zero.

In some embodiments described herein, one or more operations are performed in response to detecting a gesture that includes a respective press input or in response to detecting the respective press input performed with a respective contact (or a plurality of contacts), where the respective press input is detected based at least in part on detecting an increase in intensity of the contact (or plurality of contacts) above a press-input intensity threshold. In some embodiments, the respective operation is performed in response to detecting the increase in intensity of the respective contact above the press-input intensity threshold (e.g., a “down stroke” of the respective press input). In some embodiments, the press input includes an increase in intensity of the respective contact above the press-input intensity threshold and a subsequent decrease in intensity of the contact below the press-input intensity threshold, and the respective operation is performed in response to detecting the subsequent decrease in intensity of the respective contact below the press-input threshold (e.g., an “up stroke” of the respective press input).

FIGS. 5E-5H illustrate detection of a gesture that includes a press input that corresponds to an increase in intensity of a contact 562 from an intensity below a light press intensity threshold (e.g., “ITL”) in FIG. 5E, to an intensity above a deep press intensity threshold (e.g., “ITD”) in FIG. 5H. The gesture performed with contact 562 is detected on touch-sensitive surface 560 while cursor 576 is displayed over application icon 572B corresponding to App 2, on a displayed user interface 570 that includes application icons 572A-572D displayed in predefined region 574. In some embodiments, the gesture is detected on touch-sensitive display 504. The intensity sensors detect the intensity of contacts on touch-sensitive surface 560. The device determines that the intensity of contact 562 peaked above the deep press intensity threshold (e.g., “ITD”). Contact 562 is maintained on touch-sensitive surface 560. In response to the detection of the gesture, and in accordance with contact 562 having an intensity that goes above the deep press intensity threshold (e.g., “ITD”) during the gesture, reduced-scale representations 578A-578C (e.g., thumbnails) of recently opened documents for App 2 are displayed, as shown in FIGS. 5F-5H. In some embodiments, the intensity, which is compared to the one or more intensity thresholds, is the characteristic intensity of a contact. It should be noted that the intensity diagram for contact 562 is not part of a displayed user interface, but is included in FIGS. 5E-5H to aid the reader.

In some embodiments, the display of representations 578A-578C includes an animation. For example, representation 578A is initially displayed in proximity of application icon 572B, as shown in FIG. 5F. As the animation proceeds, representation 578A moves upward and representation 578B is displayed in proximity of application icon 572B, as shown in FIG. 5G. Then, representations 578A moves upward, 578B moves upward toward representation 578A, and representation 578C is displayed in proximity of application icon 572B, as shown in FIG. 5H. Representations 578A-578C form an array above icon 572B. In some embodiments, the animation progresses in accordance with an intensity of contact 562, as shown in FIGS. 5F-5G, where the representations 578A-578C appear and move upwards as the intensity of contact 562 increases toward the deep press intensity threshold (e.g., “ITD”). In some embodiments, the intensity, on which the progress of the animation is based, is the characteristic intensity of the contact. The operations described with reference to FIGS. 5E-5H can be performed using an electronic device similar or identical to device 100, 300, or 500.

In some embodiments, the device employs intensity hysteresis to avoid accidental inputs sometimes termed “jitter,” where the device defines or selects a hysteresis intensity threshold with a predefined relationship to the press-input intensity threshold (e.g., the hysteresis intensity threshold is X intensity units lower than the press-input intensity threshold or the hysteresis intensity threshold is 75%, 90%, or some reasonable proportion of the press-input intensity threshold). Thus, in some embodiments, the press input includes an increase in intensity of the respective contact above the press-input intensity threshold and a subsequent decrease in intensity of the contact below the hysteresis intensity threshold that corresponds to the press-input intensity threshold, and the respective operation is performed in response to detecting the subsequent decrease in intensity of the respective contact below the hysteresis intensity threshold (e.g., an “up stroke” of the respective press input). Similarly, in some embodiments, the press input is detected only when the device detects an increase in intensity of the contact from an intensity at or below the hysteresis intensity threshold to an intensity at or above the press-input intensity threshold and, optionally, a subsequent decrease in intensity of the contact to an intensity at or below the hysteresis intensity, and the respective operation is performed in response to detecting the press input (e.g., the increase in intensity of the contact or the decrease in intensity of the contact, depending on the circumstances).

For ease of explanation, the descriptions of operations performed in response to a press input associated with a press-input intensity threshold or in response to a gesture including the press input are, optionally, triggered in response to detecting either: an increase in intensity of a contact above the press-input intensity threshold, an increase in intensity of a contact from an intensity below the hysteresis intensity threshold to an intensity above the press-input intensity threshold, a decrease in intensity of the contact below the press-input intensity threshold, and/or a decrease in intensity of the contact below the hysteresis intensity threshold corresponding to the press-input intensity threshold. Additionally, in examples where an operation is described as being performed in response to detecting a decrease in intensity of a contact below the press-input intensity threshold, the operation is, optionally, performed in response to detecting a decrease in intensity of the contact below a hysteresis intensity threshold corresponding to, and lower than, the press-input intensity threshold.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

As used herein, the terms “open application” or “executing application” refer to a software application with retained state information (e.g., as part of device/global internal state 157 and/or application internal state 192). An open or executing application is, optionally, any one of the following types of applications:
an active application, which is currently displayed on a display screen of the device that the application is being used on;
a background application (or background processes), which is not currently displayed, but one or more processes for the application are being processed by one or more processors; and
a suspended or hibernated application, which is not running, but has state information that is stored in memory (volatile and non-volatile, respectively) and that can be used to resume execution of the application.

As used herein, the term “closed application” refers to software applications without retained state information (e.g., state information for closed applications is not stored in a memory of the device). Accordingly, closing an application includes stopping and/or removing application processes for the application and removing state information for the application from the memory of the device. Generally, opening a second application while in a first application does not close the first application. When the second application is displayed and the first application ceases to be displayed, the first application becomes a background application.

It should be recognized that an input detected via one or more input devices can include one or more inputs, such as a selection input, a non-selection input, a movement input, a non-movement input, an air gesture input (sometimes referred to as an air gesture as described above), a non-air gesture input, a gaze input, a non-gaze input, a verbal input, and/or a non-verbal input. In some embodiments, a selection input is an input that chooses and/or selects a subject (e.g., an element, a user interface element, a user interface object, a user interface, a person, a user, an animal, an electronic device, a computer system, and/or an object) from multiple subjects or a state from multiple states. In some embodiments, a selection input specifies a subject in which to perform an operation. Examples of a selection input include a tap input, a verbal input, an audible command, a gaze input, an air gesture input, a mouse click, a squeeze input of a portion of an electronic stylus, a blink of one or more eyes of a subject, depression of rotatable input mechanism, and/or a submission of a physical hardware element. In some embodiments, a non-selection input is an input that does not correspond to a user interface element being displayed. In some embodiments, a non-selection input does not specify a subject for which to perform an operation. Examples of a non-selection input include a verbal input, an audible request, an audible command, an audible statement, a movement input, a hold-and-drag input, a gaze input, an air gesture input, and/or a mouse movement. In some embodiments, a movement input is an input that starts at a first position and moves to a second position different from the first position. In such embodiments, the movement input can end at the second position or move back to the first position. Examples of a movement input include a swipe gesture input, a flick gesture input, movement of a subject, movement of a mouse, movement of an input on a touch-sensitive surface, an air gesture moving from one location to another, rotation of a physical input mechanism, and/or rotation of an electronic stylus. In some embodiments, a non-movement input is an input that does not start at a first position and move to a second position different from the first position before ending at the second position or moving back to the first position. Examples of a non-movement input include a verbal input, an audible request, an audible command, an audible statement, a tap input, a hold-and-drag input, a gaze input, an air gesture input, mouse movement, and/or a mouse click. Examples of an air gesture input include a hand gesture to pick up, a hand gesture to press, an air-tap gesture, an air-swipe gesture, an air pinch gesture, air de-pinch gesture, a tap-and-hold air gesture, a hand rotation, and/or a clench-and-hold air gesture. In some embodiments, multiple inputs are combined to represent a single input, such as an air gesture input combined with a selection input where the air gesture input or the gaze input identifies a target and the selection input determines when the target should be identified.

Attention is now directed towards embodiments of user interfaces (“UI”) and associated processes that are implemented on an electronic device, such as portable multifunction device 100, device 300, or device 500.

FIGS. 6A-6U illustrate exemplary user interfaces for displaying information related to credentials in accordance with some embodiments. The user interfaces in these figures are used to illustrate the processes described below, including the processes in FIG. 7.

In FIGS. 6A-6U, computer system 600 is a laptop computer that includes display 602, keyboard input device 606, and touch-sensitive surface 608. Touch-sensitive surface 608 is used herein to illustrate inputs directed to (e.g., detected by) computer system 600, where such inputs control and/or affect the location and/or actions of selection tool 614 displayed by computer system 600 via display 602. FIG. 6A illustrates computer system 600 displaying home screen user interface 604 via display 602. In some embodiments, selection tool 614 indicates the position (e.g., a current position and/or a last position) of a user input detected via an input device (e.g., touch-sensitive surface 608 and/or a mouse) in communication with computer system 600. Keyboard input device 606 includes sensor 622. Sensor 622 is an input component with which a user can access restricted functionalities of computer system 600 using biometric data such as a fingerprint. As a visual aid, display 602 and keyboard input device 606 are illustrated each in a head-on view and not necessarily in a relative positioning as they would be positioned and/or attached to an enclosure of computer system 600.

As illustrated in FIG. 6A, home screen user interface 604 includes menu bar 610 across the top of display 602. Menu bar 610 includes time indicator 610a that indicates the current time (e.g., 10:12 AM in FIG. 6A). Home screen user interface 604 also includes application dock 612 that includes representations of various applications that are installed on computer system 600. Dock 612 includes credential manager icon 612a that corresponds to a credential management system installed on computer system 600. As illustrated in FIG. 6A, computer system 600 displays credential manager icon 612a within application dock 612 and computer system 600 displays selection tool 614 as overlaid over credential manager icon 612a. At FIG. 6A, computer system 600 detects, via touch-sensitive surface 608, tap input 605a while selection tool 614 is overlaid over credential manager icon 612a. In some embodiments, instead of tap input 605a, computer system 600 detects a tap input at a location of credential manager icon 612a, a voice command that includes an utterance that identifies credential manager icon 612a, an eye gaze directed at credential manager icon 612a, a depression of an input mechanism while credential manager icon 612a is visually emphasized, and/or an air gesture input directed at credential manager icon 612a.

As illustrated in FIG. 6B, in response to detecting tap input 605a while selection tool 614 is overlaid over credential manager icon 612a, computer system 600 displays credential manager login user interface 652 overlaid on home screen user interface 604. Credential manager login user interface 652 is a login user interface of the credential management system that is installed on computer system 600. That is, computer system 600 launches the credential management system in response to detecting selection of credential manager icon 612a. At FIG. 6B, computer system 600 must login into the credential management system using credentials of a user before computer system 600 is able to access restricted functionalities of the credential management system. In the discussion of FIGS. 6A-6U, credentials refer to information such as a username, password, passkey, verification code, and/or federated login used for accessing restricted functionality of an account, application, and/or service.

As illustrated in FIG. 6B, credential manager login user interface 652 includes indicators 618 and password field 620. Indicators 618 includes biometrics indicator 618a, locked indicator 618b, and user indicator 618c. Biometrics indicator 618a indicates that computer system 600 can login to the credential management system using biometric data of an authorized user. In some embodiments, the input to unlock the credential management system corresponds to computer system 600 detecting biometric data of an authorized user (e.g., a fingerprint, eye, iris, or facial data). Locked indicator 618b (e.g., “Password Manager is locked”) indicates that the credential management system is in a locked state. User indicator 618c indicates the user (e.g., Johnny Appleseed) whose credentials must be input in order for computer system 600 to unlock the credential management system.

At FIG. 6B, computer system 600 is configured to enter and/or display a password of the user within password field 620 in response to computer system 600 detecting on or more keystrokes via keyboard input device 606 and/or a software keyboard. At FIG. 6B, computer system 600 detects input 605b corresponding to biometric data (e.g., a fingerprint) of an authorized user via sensor 622 of computer system 600. In some embodiments, in lieu of detecting the biometric authentication data via sensor 622, computer system 600 detects a typed password via keyboard input device 606.

As illustrated in FIG. 6C, in response to detecting input 605b, computer system 600 unlocks the credential management system and displays credential manager login user interface 616. On the left side of credential manager user interface 616, computer system 600 displays tabs 624. Tabs 624 includes all tab 624a, passkeys tab 624b, codes tab 624c, WiFi tab 624d, alerts tab 624e, and deleted tab 624f. Tabs 624a-f are different groupings of various types of credentials, which will be discussed in detail in the discussion of FIGS. 6C-6U. As illustrated in FIG. 6C, computer system 600 displays a number in the bottom right corner of each of tabs 624a-f, which indicates the number of credentials that correspond to each respective tab. For example, there are two credentials within codes tab 624c and 11 credentials within WiFi tab 624d. Accordingly, computer system 600 displays a two within codes tab 624c and computer system 600 displays an 11 within WiFi tab 624d. The number displayed within all tab 624a, 33, is the total number of credentials that are managed by the credential management system. As illustrated in FIG. 6C, below tabs 624a-f, computer system 600 displays groups indicators 626, which indicate the names of shared credential groups as well as the number of credentials in each group.

As illustrated in FIG. 6C, near the middle of credential manager user interface 616, computer system 600 displays list 632 and tab indicator 628. List 632 includes credentials 632a1-f1 that are credentials which are saved and/or managed by the credential management system. Each of credentials 632a1-f1 includes an e-mail address associated with the credential as well as a logo corresponding to the service associated with the credential. For example, as illustrated in FIG. 6C, computer system 600 displays the e-mail address “jappleseed@invalid.com” and a triangular logo with credential 632a1 indicating that that the e-mail registered with credential 632a1 is “jappleseed@invalid.com” and credential 632a1 is associated with a service that has a logo in the shape of a triangle. As illustrated in FIG. 6C, computer system 600 displays a share icon overlaid over the triangular logo. The share icon indicates that credential 632a1 is shared to another user and/or from another user to the user of computer system 600 (e.g., via a group, as discussed above). Tab indicator 628, “All, 33 Credentials” indicates which of tabs 624 computer system 600 displays as selected (e.g., “All”) and the total number of credentials within the selected tab (e.g., “33”).

As illustrated in FIG. 6C, computer system 600 displays alerts 634a-c in the form of circled exclamation points to the right of credentials 632b1-d1. The display of alerts 634a-c indicates that credential 632b1-632d1 each have a pending security warning. Note that computer system 600 displays the same type (e.g., of a same color and/or style) of alert next to credentials 632b1 and 632d1 and a different type of alert (e.g., different color and/or different size) next to credential 632c1. The difference in the appearance between alerts 634a and 634b (e.g., and/or alerts 634b and 634c) is based on the severity of the alert. More specifically, the appearance of alerts 634a and 634c indicate a severe security alert while the appearance of alert 634b indicates a less severe security alert. For example, the appearance of alert 634a and/or alert 634c can indicate that the information associated of credential 632b1 and credential 632d1 has been hacked and/or is part of a data leak while the appearance of alert 634b can indicate that the password of credential 632c1 is easy to guess.

As illustrated in FIG. 6C, credential manager user interface 616 includes add control 636 and credential search control 638 in the top right corner. In some embodiments, in response to detecting input 605c2 directed to add control 636, computer system 600 initiates a process of adding a credential to the credential management system. In some embodiments, in response to detecting input 605c2 directed to add control 636, computer system 600 initiates a process of creating a credential that will be managed by the credential management system. In some embodiments, in response to detecting input 605c3 directed to credential search control 638, computer system 600 initiates a process to search and/or filter through existing credentials within the credential management system. At FIG. 6C, computer system 600 detects, via touch-sensitive surface 608, tap input 605c1 while selection tool 614 is overlaid over credential 632d1. In some embodiments, instead of tap input 605c1, computer systems 600 detects a tap input at a location of credential 632d1, a swipe input, a voice command that includes an utterance referencing credential 632d1, an eye gaze directed to credential 632d1, a depression of an input mechanism while credential 632d1 is visually emphasized, and/or an air gesture input directed to credential 632d1.

As illustrated in FIG. 6D, in response to detecting tap input 605c1, computer system 600 displays credential 632d1 as selected (e.g., computer system 600 visually emphasizes credential 632d1) and displays credential indicator 640 to the right of list 632. Credential indicator 640 is a detailed view of a selected credential (e.g., credential 632d1 at FIG. 6D). Accordingly, at FIG. 6D, because credential 632d1 is selected, credential indicator 640 includes information regarding credential 632d1.

As illustrated in FIG. 6D, credentials indicator 640 includes credential indicator 640a, username indicator 640b, password indicator 640c; service indicator 640d, group indicator 640e; note control 640f, edit control 640g, and share control 640h. Credential indicator 640a indicates an assigned name of the selected credential; username indicator 640b indicates the username associated with the selected credential (e.g., credential 632d1 at FIG. 6D); password indicator 640c indicates a length of a password associated with the selected credential; service indicator 640d indicates the service associated with the selected credential; group indicator 640e indicates the group (if any) that the selected credential is associated with; note control 640f is an area where computer system 600 displays credential specific notes; edit control 640g corresponds to a credential edit function of computer system 600 for the selected credential; and share control 640h corresponds to a credential sharing function of computer system 600 that allows computer system 600 to share the details of the selected credential with other computer systems.

As illustrated in FIG. 6D, below credentials indicator 640, computer system 600 displays security alert 642. Security alert 642 indicates any security alerts that are associated with the selected credential. At FIG. 6D, security alert 642 indicates that the password associated with credential 632d1 is compromised. In the discussion of FIGS. 6A-6U, a compromised password refers to a password that has been leaked, hacked, and/or stolen, which can lead to an unauthorized user gaining access to a system and/or service. It should be noted that security alert 642 is correlated to alert 634c as discussed above in relation to FIG. 6C. That is, both security alert 642 and alert 634c relate to the same security threat of credential 632d1.

As illustrated in FIG. 6D, security alert 642 includes change password control 642a. In some embodiments, upon detecting input 605d2 while selection tool 614 is overlaid over change password control 642a, computer system 600 displays a user interface for editing the password and/or username of credential 632d. At FIG. 6D, computer system 600 detects, via touch-sensitive surface 608, tap input 605d1 while selection tool 614 is overlaid over credential 632a1. In some embodiments, instead of tap input 605d1, computer system 600 detects a tap input at a location of credential 632a1, a voice command that includes an utterance specifying credential 632a1, an eye gaze directed at credential 632a1, a depression of an input mechanism while credential 632a1 is visually emphasized, and/or an air gesture input directed at credential 632a1.

As illustrated in FIG. 6E, in response to detecting tap input 605d1, computer system 600 displays credential 632a1 as selected (e.g., computer system 600 visually emphasizes credential 632a1) and displays a detailed view of credential 632a1 within credential indicator 640 to the right of the list 632. At FIG. 6E, a determination is made that the security of credential 632a1 can be increased. Because the determination is made that the security of credential 632a1 can be increased, computer system 600 displays passkey control 646a within security indicator 646. More specifically, at FIG. 6E, a service-specific password secures credential 632a1 and because a passkey would provide additional security to credential 632a1, computer system 600 displays passkey control 646a. Put a different way, computer system 600 displays an option to increase the security of a selected credential when it is determined that the security of the selected credential can be increased. In some embodiments, in response to detecting tap input 605e2 while selection tool 614 is overlaid over passkey control 646a, computer system 600 initiates a process for associating a passkey with credential 632a1. At FIG. 6E, computer system 600 detects, via touch-sensitive surface 608, tap input 605e1 while selection tool 614 is overlaid over edit control 640g. In some embodiments, instead of tap input 605e1, computer system 600 detects a tap input at a location of edit control 640g, a voice command that includes an utterance identifying edit control 640g, an eye gaze directed towards edit control 640g, a depression of an input mechanism while edit control 640g is visually emphasized, and/or an air gesture input directed at edit control 640g.

As illustrated in FIG. 6F, in response to detecting tap input 605e1, computer system 600 displays edit indicator 648 and change password control 642a within credential indicator 640. More specifically, as illustrated in FIG. 6F, computer system 600 displays edit indicator 648 surrounding credential indicator 640a. Computer system 600 is configured to modify the text of credential indicator 640a while computer system 600 displays edit indicator 648 around credential indicator 640a. Computer system 600 displays change password control 642a within credential indicator 640 as a selectable option to initiate a process for changing the password of credential 632a1. Computer system 600 displays password control 642a at the bottom of credential indicator 640 because credential 632a1 does not have a security alert. Computer system 600 displays password control 642a within security alert 642 when the selected credential has a pending security alert (e.g., as shown in FIG. 6D) and computer system 600 displays passkey control 646a in response to detecting an input corresponding to edit control 640g when the selected credential does not have a security alert. In some embodiments, in response to detecting input 605f2 while selection tool 614 is overlaid over change password control 642a, computer system 600 initiates a process for changing the password of credential 632a1. For example, in response to detecting input 605f2 while selection tool 614 is overlaid over change password control 642a, computer system 600 can display a user interface of the credential management system that allows a user to change the password of credential 632a1 without leaving the credential management system. For another example, in response to detecting input 605f2 while selection tool 614 is overlaid over change password control 642a, computer system 600 can display a user interface of a browser and/or an application that is outside of the credential management system. In such an example, the user interface can correspond to a service that credential 632a1 is used (e.g., changing the password requires using one or more user interfaces of the service rather than staying within the credential management system).

As illustrated in FIG. 6F, in response to detecting tap input 605e1, computer system 600 displays close control 650 where computer system 600 previously displayed edit control 640g. The display of close control 656 indicates that computer system 600 is in an edit mode and that computer system 600 exits the edit mode upon detecting an input directed to close control 650. At FIG. 6F, computer system 600 detects, via touch-sensitive surface 608, tap input 605f1 while selection tool 614 is overlaid over credential 632c1. In some embodiments, instead of tap input 605f1, computer system 600 detects a tap input at a location of credential 632c1, a voice command that includes an utterance identifying credential 632c1, an eye gaze directed towards credential 632c1, a depression of an input mechanism while credential 632c1 is visually emphasized, and/or an air gesture input directed at credential 632c1.

As illustrated in FIG. 6G, in response to detecting tap input 605f1, computer system 600 displays credential 632c1 as selected (e.g., computer system 600 visually emphasizes credential 632c1) and displays a detailed view of credential 632c1 within credentials indicator 640. Credential 632c1 is secured with a passkey. As illustrated in FIG. 6G, because credential 632c1 is secured with a passkey, computer system 600 displays passkey indicator 640j within credential indicator 640 instead of password indicator 640c. Passkey indicator 640j is a representation of a length of the passkey that secures credential 632c1.

As illustrated in FIG. 6G, in response to detecting tap input 605f1, computer system 600 displays security indicator 646, which at FIG. 6G, indicates that a passkey is being used to secure credential 632c1. At FIG. 6G, because a passkey is being used to secure credential 632c1, security indicator 646 includes previous password indicator 646b that includes a representation of a password (e.g., seven dots) previously used to secure credential 632c1. At FIG. 6G, computer system 600 detects, via touch-sensitive surface 608, tap input 605g while selection tool 614 is overlaid over credential 632b1. In some embodiments, instead of tap input 605g, computer system 600 detects a tap input at a location of credential 632b1, a voice command that includes an utterance identifying credential 632b1, an eye gaze directed to credential 632b1, a depression of an input mechanism while credential 632b1 is visually emphasized, and/or an air gesture input directed to credential 632b1.

As illustrated in FIG. 6H, in response to detecting tap input 605g, computer system 600 displays credential 632b1 as selected (e.g., computer system 600 visually emphasizes credential 632b1) and displays a detailed view of credential 632b1 within credential indicator 640 to the right of the list 632. Credential 632b1 is a federated credential that is managed by a company called “company A”. A federated credential is a credential that is authenticated by an authentication provider and optionally can be used to grant access to a number of unrelated services. That is, a federated credential allows a user to utilize a single credential (e.g., the same username and password) to access restricted functionalities of various unrelated services. The use of a federated credential helps the user avoid the process of different logins and/or multi-factor authentication for each system platform that they log into.

As illustrated in FIG. 6H, because credential 632b1 is a federated credential, computer system 600 displays federated credential indicator 658. Federated credential indicator 658 includes account indication 658a that includes an indication of the company that manages credential 632b1; sign in control 658b, which is an option for computer system 600 to display the various services, applications, and/or websites that are registered with credential 632b1; option 658c, which is an option for computer system 600 to display the various settings of credential 632b1; option 658d, which is an option for computer system 600 to display the various e-mail settings related to credential 632b1; stop control 658e, which is an option for computer system 600 to disassociate (e.g. unregister) credential 632b1 from various services, applications and/or websites that are currently associated with credential 632b1; and indicator 658f, which allows computer system 600 to log in to various services, applications, and/or websites using a different federated credential that is managed by company B (e.g., a company different from company A) instead of using credential 632b1 that is managed by company A.

At FIG. 6H, computer system 600 detects, via touch-sensitive surface 608, tap input 605h1 while selection tool 614 is overlaid over account indication 658a. In some embodiments, computer system 600 detects, via touch-sensitive surface 608, tap input 605h2 while selection tool 614 is overlaid over sign in control 658b instead of input 605h1. In some embodiments, instead of tap input 605h1 computer system 600 detects a tap input at a location of account indication 658a, a voice command that includes an utterance that identifies account indication 658a, an eye gaze directed to account indication 658a, a depression of an input mechanism while account indication 658a is visually emphasized, and/or an air gesture input directed to account indication 658a. In some embodiments, instead of tap input 605h2, computer system 600 detects a tap input at a location of account indication 658a, a voice command that includes an utterance that identifies sign in control 658b, an eye gaze directed to sign in control 658b, a depression of an input mechanism while sign in control 658b is visually emphasized, and/or an air gesture input directed to sign in control 658b. In some embodiments, computer system 600 disassociates credential 632b1 from the company A in response to detecting input 605h3 while selection tool 614 is overlaid over stop control 658e. In some embodiments, computer systems 600 displays indicator 658f based on a determination that the federated credential that is managed by company B is more secure than credential 632b1.

As illustrated in FIG. 6I, in response to detecting tap input 605h1 or tap input 605h2, computer system 600 displays list 660. List 660 is a list of services, websites, and/or applications that are registered with credential 632b1. For example, application 660d and website 660k (e.g., and all remaining services, websites, and/or applications of list 660) are registered with credential 632b1. That is, because credential 632b1 is a federated credential, credential 632b1 can be used to access restricted functionality of both application 660d and website 660k and the various other services included in list 660. At FIG. 6I, computer system 600 detects, via touch-sensitive surface 608, tap input 605i while selection tool 614 is overlaid over credential 632e1 that is a federated credential. In some embodiments, instead of tap input 605i, computer system 600 detects a tap input at a location of credential 632e1, a voice command that includes an utterance that identifies credential 632e1, an eye gaze directed towards credential 632e1, a depression of an input mechanism while credential 632e1 is visually emphasized, and/or an air gesture input directed at credential 632e1. In some embodiments, in response to detecting an input corresponding to selection of application 660d, computer system 600 initiates a process for logging into application 660d using credential 632b1.

As illustrated in FIG. 6J, in response to detecting tap input 605i, computer system 600 displays credential 632e1 as selected (e.g., computer system 600 visually emphasizes credential 632e1) and displays a detailed view of the credential 632e1 within credential indicator 640. Credential 632e1 is a federated credential. Because credential 632e1 is a federated credential, computer system 600 displays federated credential indicator 658 below credential indicator 640.

As illustrated in FIG. 6J, federated credential indicator 658 includes account indicator 658a that includes an indication of the company (“e.g., company D) that manages credential 632e1; sign in control 658b, which is an option to display a list of services, websites, and/or applications that are registered with credential 632e1; option 658g, which is an option to display various options (e.g., e-mail related options, password related options and/or account related options) related to the management of credential 632e1; option 658h which is an option to display details associated with credential 632e1; and stop control 658e which is an option for computer system 600 to disassociate (e.g. unregister) credential 632e1 from one or more services, websites, and/or applications that credential 632e1 is currently associated with.

Computer system 600 displays different information within federated credential indicator 658 based on which company manages the federated credential. For example, at FIG. 6H, computer system 600 displays option 658c, “account settings” and option 658d, “hide my e-mail settings” within federated credential indicator 658 in association with 632b1 that is managed by company A while, at FIG. 6J, computer system 600 does not display option 658c and option 658d within federated credential indicator because credential 632e1 is managed by company D. Further, as illustrated in FIG. 6J, computer system 600 displays option 658g, “options” and option 658h, “view account details” in association with credential 632e1 that is managed by company D while computer system 600 does not display option 658g and option 658h when federated credential indicator 658 corresponds to credential 632b1. At FIG. 6J, computer system 600 detects, via touch-sensitive surface 608, tap input 605j while selection tool 614 is overlaid over credential 632f1. In some embodiments, instead of tap input 605j, computer system 600 detects a tap input at a location of 632f1, a voice command that includes an utterance identifying credential 632f1, an eye gaze directed towards credential 632f1, a depression of an input mechanism while credential 632f1 is visually emphasized, and/or an air gesture input directed towards credential 632f1.

As illustrated in FIG. 6K, in response to detecting tap input 605j, computer system 600 displays credential 632f1 as selected (e.g., computer system 600 visually emphasizes credential 632f1) and displays a detailed view of credential 632f1 within credentials indicator 640 to the right of the list 632. As illustrated in FIG. 6K, computer system 600 displays security indicator 646 with an indication that the password for credential 632f1 is strong (e.g., “Your password is strong”) and with verification code control 646c below credentials indicator 640. Verification code control 646c can be used to replace and/or supplement the password that currently secures credential 632f1 with a verification code. A verification code provides additional security to credential 632f1 in comparison to a password. More specifically, a verification code is more secure than a password in that it is specific to one user and the verification code resets after a predetermined amount of time has elapsed. Computer system 600 displays verification code 646c within security indicator 646 instead of passkey control 646a because the service that corresponds with credential 632f1 does not allow for the use of passkeys in association with user accounts for the service. In some embodiments, in response to detecting input 605k2 while selection tool 614 is overlaid over verification code control 646c, computer system 600 displays a user interface that corresponds to a process of replacing the password of credential 632f1 with a verification code. At FIG. 6K, computer system 600 detects, via touch-sensitive surface 608, tap input 605k1 while selection tool 614 is overlaid over codes tab 624c. In some embodiments, instead of tap input 605k1, computer system 600 detects a tap input at a location of codes tab 624c, a voice command that includes an utterance identifying codes tab 624c, an eye gaze directed towards codes tab 624c, a depression of an input mechanism while codes tab 624c is visually emphasized, and/or an air gesture input directed towards codes tab 624c.

As illustrated in FIG. 6L, in response to detecting tap input 605k1, computer system 600 displays codes tab 624c as selected (e.g., computer system 600 visually emphasizes displays codes tab 624c) and displays all tab 624a as deselected (e.g., computer system 600 ceases visually emphasizing all tab 624a). Further, as illustrated in FIG. 6L, in response to detecting tap input 605k1, computer system 600 displays codes user interface 692. Codes user interface 692 includes credentials that are secured using verification codes. Codes user interface 692 includes tab indicator 670, “Codes, 2 Codes” that indicates that codes tab 624c is selected and that two credentials are grouped under the codes category.

As illustrated in FIG. 6L, codes user interface 692 includes credential 632g1 which is secured by code 632g3, “12345678” and credential 632h1 which is secured by code 632h3, “61724890.” Codes 632g3 and 632h3 are one-time codes that a user has to provide to a service and/or authenticates via a device separate from computer system 600. For example, when the user of computer system 600 is logging into a service using credential 632g1 on a device different from computer system 600, the other device may request a verification code to verify the identity of the user. When the user enters code 632g3, the other device allows the user to access the service. Verification codes provide additional security, as discussed above, in case a password is stolen and/or compromised.

As illustrated in FIG. 6L, codes user interface 692 includes timer 632g4 and timer 632h4. Timer 632g4 is associated with credential 632g1 and timer 632h4 associated with credential 632h1. Timer 632g4 indicates the amount of time until code 632g3 is reset and timer 632h4 represents the amount of time remaining until code 632h3 is reset. For example, at FIG. 6L, computer system 600 displays timer 632g4 as an almost a complete circle, which indicates that code 632g3 will soon reset to a different code (e.g., different numbers, letters, and/or symbols). In some embodiments, timers 632g4 and 632h4 indicate the amount of time until code 632g3 and code 632h3 expire. In some embodiments, timer 632g4 and/or timer 632h includes a textual representation of the amount of time until code 632g3 and/or 632h3 is reset. At FIG. 6L, computer system 600 detects, via touch-sensitive surface 608, tap input 605l while selection tool 614 is overlaid over credential 632g1. In some embodiments, instead of tap input 605l, computer system 600 detects a tap input at a location of credential 632g1, a voice command that includes an utterance that identifies credential 632g1, an eye gaze directed towards credential 632g1, a depression of an input mechanism while credential 632g1 is visually emphasized, and/or an air gesture input directed towards credential 632g1.

As illustrated in FIG. 6M, in response to detecting tap input 605l, computer system 600 displays credential 632g1 as selected (e.g., computer system 600 visually emphasizes credential 632g1) and displays a detailed view of credential 632g1 within credential indicator 640 to the right of credential 632g1 and credential 632h1. At FIG. 6M, because credential 632g1 is secured with a verification code, credentials indicator 640 includes verification code indicator 640i along with code 632g3 and timer 632g4 (e.g., as opposed to password indicator 640c when a respective credential is secured with a password). At FIG. 6M, computer system 600 detects, via touch-sensitive surface 608, tap input 605m while selection tool 614 is overlaid over WiFi tab 624d. In some embodiments, instead of tap input 605m, computer system 600 detects a tap input at a location of WiFi tab 624d, a voice command that includes an utterance that identifies WiFi tab 624d, an eye gaze directed at WiFi tab 624d, a depression of an input mechanism while WiFi tab 624d is visually emphasized, and/or an air gesture input directed at WiFi tab 624d.

As illustrated in FIG. 6N, in response to detecting tap input 605m, computer system 600 displays WiFi tab 624d as selected (e.g., computer system 600 visually emphasizes WiFi tab 624d and displays WiFi user interface 694. WiFi user interface 694 includes networks 678a-k that are wireless networks that devices (e.g., computer system 600, a smartphone of the user, a tablet of the user and/or a desktop computer of the user) of the user of computer system 600 has most recently connected to. For example, in some embodiments, a smartphone of the user recently connected to network 678c and network 678f and a tablet of the user recently connected to network 678g and network 678j while computer system 600 recently connected to the remaining networks. As illustrated in FIG. 6N, WiFi user interface 694 also includes tab indicator 676 “Networks, 11 networks” that indicates that 11 WiFi networks are listed below tab indicator 676 (e.g., and/or that indicates that 11 WiFi networks are managed by the credential management system).

As illustrated in FIG. 6N, computer system 600 displays network 678a at the top of list 678. Computer system 600 displays network 678a at the top of list 678 because network 678a is the most recently connected to (e.g., connected to by computer system 600 and/or connected to by a device of the user different from computer system 600) network. In some embodiments, computer system 600 displays the remaining networks in list 678 alphabetically. In such embodiments, computer system 600 displays list 678 alphabetically to avoid revealing sensitive information such as when computer system 600 last connected to a wireless network. At FIG. 6N, computer system 600 detects, via touch-sensitive surface 608, tap input 605n while selection tool 614 is overlaid over network 678a (e.g., “Home”). In some embodiments, instead of tap input 605n, computer system 600 detects a tap input at a location of network 678a, a voice command that includes an utterance that identifies network 678a, an eye gaze directed towards network 678a, a depression of an input mechanism while network 678a is visually emphasized, and/or an air gesture input directed at network 678a. In some embodiments, computer system 600 displays network 678a at the top of list 678 because computer system 600 is presently connected to network 678a. In some embodiments, computer system 600 visually emphasizes network 678a because network 678a is most recently connected to network. In some embodiments, computer system 600 displays network 678a as visually emphasized to indicate that computer system 600 is currently connected to network 678a.

As illustrated in FIG. 6O, in response to detecting tap input 605n, computer system 600 displays network indicator 680 to the right of list 678. At FIG. 6O, because network 678a was selected, network indicator 680 includes information pertaining to network 678a. Network indicator 680 includes title indicator 680a, “Home” that a representation of network 678a; network name indicator 680b, “Network Name, homewifi” which is an indication of the name of the wireless network of network 678a; password indicator 680c, “Password” along with 10 dots to represent the password that secures network 678a; edit control 680d for editing the information included in network indicator 680; and QR code control 680e. At FIG. 6O, computer system 600 detects, via touch-sensitive surface 608, tap input 6050 while selection tool 614 is overlaid over QR code control 680e. In some embodiments, instead of tap input 6050, computer system 600 detects a tap input at a location of QR code control 680e, a voice command that includes an utterance identifying QR code control 680e, an eye gaze directed at QR code 680e, a depression of an input mechanism while QR code control 680e is visually emphasized, and/or an air gesture input directed to QR code control 680e.

As illustrated in FIG. 6P, in response to detecting tap input 6050, computer system 600 displays QR code display 682 overlaid over list 678. QR code display 682 includes instructions 682a, “Scan QR code to join ‘Home’;” QR code 682b; and done control 682c. Computer system 600 displays QR code display 682 such that another computer system can scan QR code 682b. Upon scanning QR code 682b, the other computer system is able to gains access to network 678a, “Home.” This process is described in additional detail below. At FIG. 6P, computer system 600 detects, via touch-sensitive surface 608, tap input 605p while selection tool 614 is overlaid over done control 682c. In some embodiments, instead of tap input 605p, computer system 600 detects a tap input at a location of done control 682c, a voice command that includes an utterance identifying done control 682c, an eye gaze directed to done control 682, a depression of an input mechanism while done control 682c is visually emphasized, and/or an air gesture input directed to done control 682c.

As illustrated in FIG. 6Q, in response to detecting tap input 605p, computer system 600 ceases to display QR code display 682 (e.g., and continues to display WiFi user interface 694 as it was previously displayed at FIG. 6O). At FIG. 6O, computer system 600 detects, via touch-sensitive surface 608, tap input 605q while selection tool 614 is overlaid over network 678e, “Doug's House.” In some embodiments, instead of tap input 605q, computer system 600 detects a tap input at a location of network 678e, a voice command that includes an utterance identifying network 678e, an eye gaze directed to network 678e, a depression of an input mechanism while network 678e is visually emphasized, and/or an air gesture input directed at network 678e.

As illustrated in FIG. 6R, in response to detecting tap input 605q, computer system 600 displays network 678e as selected (e.g., computer system 600 visually emphasizes network 678a) and displays a detailed view of network 678e within network indicator 680. At FIG. 6R, computer system 600 detects, via touch-sensitive surface 608, tap input 605r while selection tool 614 is overlaid over QR code control 680e. In some embodiments, instead of detecting tap input 605r, computer system 600 detects a tap input at a location of QR code control 680e, a voice command that includes an utterance identifying QR code control 680e, an eye gaze directed at QR code control 680e, a depression of an input mechanism while code control 680e is visually emphasized, and/or an air gesture input directed at QR code control 680e.

As illustrated in FIG. 6S, in response to detecting tap input 605r, computer system 600 displays QR code display 682 overlaid over list 678. Because network 678e is selected, QR code display 682 includes: instructions 682a, “Scan QR code to join ‘Doug's House” for joining network 678e; QR code 682d that corresponds to network 678e; and done control 682c. Note that QR code 682d is a different QR code from QR code 682b as illustrated in FIG. 6P. The difference in QR code 682d and QR code 682b indicate a different in functionality of QR code 682d and QR code 682b. Specifically, QR code 682b facilitates connecting a computer system to network 678a and QR code 682d facilitates connecting a computer system to network 678e.

FIG. 6S also illustrates computer system 696 displaying camera application user interface 698. At FIG. 6S, QR code 682d is in the field of view of one or more cameras of computer system 696. As illustrated in FIG. 6S, because QR code 682d is in the field of view of the one or more cameras of computer system 696, computer system 696 displays QR code 682d within camera application user interface 698.

At FIG. 6S, computer system 696 detects QR code 682d. As illustrated in FIG. 6S, because computer system 696 detects QR code 682d, computer system 696 displays notification 644. Notification 644 is a selectable option for connecting computer system 696 to network 678e, “dougwifi.” That is, computer system 696 connects to network 678 in response to detecting in input directed to notification 644. In some embodiments, upon scanning QR code 682b, computer system 696 automatically connects to network 678e, “dougwifi.” At FIG. 6S, computer system 600 detects, via touch-sensitive surface 608, tap input 605s while selection tool 614 is overlaid over alerts tab 624e. In some embodiments, instead of tap input 605s, computer system 600 detects a tap input at a location of alerts tab 624e, a voice command that includes an utterance identifying alerts tab 624e, an eye gaze directed at alerts tab 624e, a depression of an input mechanism while alerts tab 624e is visually emphasized, and/or an air gesture input directed at alerts tab 624e.

As illustrated in FIG. 6T, in response to detecting tap input 605s, computer system 600 displays alerts tab 624e as selected (e.g., computer system 600 visually emphasizes alerts tab 624e) and displays alert user interface 684. Alert user interface 864 includes list 630 that includes a representation of various credentials that are managed by the credential management system that have security alerts. That is, alerts tab 624e serves as a filter for credentials that have security alerts. More specifically, selection of alerts tab 624e causes computer system 600 to filter through each of the credentials that are managed by the credential management system such that credentials that have security alerts are displayed in one place (e.g., in list 630).

As illustrated in FIG. 6T, alert user interface 684 includes tab indicator 654 “Security Alerts, 9 Alerts” list 630. Tab indicator 654 is an indication of the number of credentials that are managed by the credential management system that have security alerts above. At FIG. 6T, computer system 600 displays various credentials with various types of security alerts within list 630. As discussed above, the appearance of alert indicators indicate the severity of the security alert. For example, the appearance of alert indicator 630t2 indicates that the alert corresponding to credential 630t1 is of a high severity while the appearance of alert indicator 634b indicates that the severity of the alert corresponding to credential 632c1 is a lower severity. In some embodiments, list 630 includes credentials have security alerts of a high, medium, and/or low level of severity. In some embodiments, the various security alerts correspond to different issues (e.g., hacked password, easy to guess password, and/or reused password). At FIG. 6T, computer system 600 detects, via touch-sensitive surface 608, tap input 605t while selection tool 614 is overlaid over credential 632t1. In some embodiments, instead of tap input 605t, computer system 600 detects a tap input at a location of credential 632t1, a voice command that includes an utterance identifying credential 632t1, an eye gaze directed at a location of credential 632t1, a depression of an input mechanism while credential 632t1 is visually emphasized, and/or an air gesture input directed at credential 632t1.

At FIG. 6U, a determination is made that credentials 630t1 and 632b1 share a common password. As illustrated in FIG. 6U, in response to detecting tap input 605t and because the determination is made that credentials 630t1 and 632b1 share the common password, computer system 600 visually emphasizes credentials 630t1 and 632b1. The visual emphasis of credentials 630t1 and 632b1 indicates that both of credentials 630t1 and 632b1 share the common password. In some embodiments, computer system 600 visually emphasizes credentials 630t1 and 632b1 when computer system 600 detects selection tool 614 as hovering over the display of credential 630t1 and/or credential 632b1. In some embodiments, computer system 600 visually emphasizes credential 630t1 and credential 632b1 when a determination is made that credential 630t1 and credential 632b1 share a common password without detecting selection tool 614 as hovering over either credential 630t1 and credential 632b1.

As illustrated in FIG. 6U, computer system 600 displays alert 688 to the right of list 630. Alert 688 indicates that the password associated with credential 630t1 (e.g., credential T) matches the password for credential 632b1 (e.g., credential B) and should be changed. Within alert 688, computer system 600 displays hide alert control 688a and change password control 688b. In some embodiments, upon detecting an input directed to hide alert control 688a, computer system 600 ceases to display alert 688. In some embodiments, upon detecting an input directed to change password control 688b, computer system 600 initiates a process for changing the password associated with credential 630t1.

FIG. 7 is a flow diagram illustrating a method (e.g., method 700) for displaying information related to credentials in accordance with some embodiments. Some operations in method 700 are, optionally, combined, the orders of some operations are, optionally, changed, and some operations are, optionally, omitted.

As described below, method 700 provides an intuitive way for displaying information related to credentials. Method 700 reduces the cognitive burden on a user, thereby creating a more efficient human-machine interface. For battery-operated computing devices, enabling a user to interact with such devices faster and more efficiently conserves power and increases the time between battery charges.

In some embodiments, method 700 is performed at a computer system (e.g., 600) (e.g., a watch, a phone, a tablet, a fitness tracking device, a processor, a head-mounted display (HMD) device, a communal device, a media device, a speaker, a television, and/or a personal computing device) that is in communication with (e.g., wireless communication and/or wired communication) one or more display generation components (e.g., 602) (e.g., a display screen, a projector, a head mounted display and/or a touch-sensitive display) and one or more input devices (e.g., 608 and/or 606) (e.g., a physical input mechanism, a hardware input mechanism, a camera, a touch-sensitive surface, a microphone, a camera, a depth sensor, an accelerometer, a temperature sensor, and/or a heart monitor). In some embodiments, the computer system includes the one or more display generation components and/or the one or more input devices. In some embodiments, the physical input mechanism is a hardware input mechanism, a rotatable input mechanism, a crown, a knob, a dial, a physical slider, and/or a hardware button.

While displaying, via the one or more display generation components (e.g., 602), a credential manager user interface (e.g., 616, 692, and/or 694) (e.g., a user interface of an application configured to manage one or more credentials, a user interface that corresponds to a credential manager application that is installed on the computer system, a web based credential management application, a landing user interface of an application that is installed on the computer system, and/or a primary user interface of an application that is installed on the computer system), the computer system detects (702), via the one or more input devices (e.g., 608 and/or 606), an input (e.g., 605c1, 605d1, 605f1, 605g, and/or 605i) (e.g., a touch input, a mouse click input, a button press input, or an air gesture input) corresponding to a request to display a credential (e.g., a single credential, one or more credentials, or a plurality of credentials) for a respective service (e.g., a login for an application, a website, another device different from the computer system, a server, a service, and/or a remote system). In some embodiments, the credential manager user interface is displayed in response to the computer system detecting a portion of a credential has been inserted (e.g., by a user or by the computer system) in a credential entry user interface object (e.g., a text entry field and/or a user interface element configured to receive a credential). In some embodiments, the credential manager user interface corresponds to, included with, and/or is of an application that is installed on the computer system. In some embodiments, the computer system displays credential manager user interface in response to detecting one or more biometrics of a user. In some embodiments, an input includes a tap input, a verbal input, an audible command, a gaze input, an air gesture, a mouse click, and/or a submission of a user-interface element, a non-selection input and/or a physical hardware element. In some embodiments, a non-selection input includes a verbal input, an audible request, an audible command, an audible statement, a swipe input, a hold-and-drag input, a gaze input, an air gesture, and/or a mouse movement. In some embodiments, a credential includes a user name, a password, a token, a passkey, a single-sign-on credential, a user biometric, a digital certificate, a service-specific credential, and/or a federated credential. In some embodiments, the input corresponding to the request to display the credential is a tap input at a location of a representation of a credential management application, a tap input at a location of a representation of a credential, a trackpad and/or mouse press input while a cursor or other focus selector is at a location of a filter for credentials, a pinch gesture while a gaze of the user is directed at a representation of a credential, and/or a voice command that includes an utterance that identifies the respective credential.

In response to (704) detecting the input corresponding to the request to display the credential for the respective service and in accordance with a determination that the respective service uses (e.g., corresponds to, directed to, at a location of, related to, and/or associated with) a service-specific credential (e.g., 632d1, 632a1, and/or 632c1) (e.g., a credential that is registered directly with a single service, a credential that is created via a login procedure that is unique to the respective service, a credential that is created specifically for the respective service, and/or a unique credential for the respective service), the computer system displays (706), via the one or more display generation components (e.g., 602), a first user interface (e.g., 640 and/or 642) that corresponds to (e.g., directed to, at a location of, related to and/or associated with, and/or includes information regarding) the service-specific credential.

In response to (704) detecting the input corresponding to the request to display the credential for the respective service and in accordance with a determination that the respective service uses a federated credential (e.g., 632b1 and/or 632e1) (e.g., a credential that is authenticated by a separate authentication provider and optionally can be used to grant access to a number of unrelated services), the computer system displays (708), via the one or more display generation components (e.g., 602), a second user interface (e.g., 658) (e.g., different from the first user interface) that corresponds to (e.g., directed to, at a location of, related to, and/or associated with) the federated credential, wherein the second user interface includes a link (e.g., 658c, 658d, and/or 658d) (e.g., a hyperlink, textual link, and/or graphical link) to a federated credential user interface (e.g., a user interface that is a part of an application that is installed on the computer system and/or a user interface that is a webpage) that includes a set of one or more options for managing the federated credential (e.g., editing, deleting, displaying, removing, and/or suspending use of the federated credential by the respective service and/or by one or more services). In some embodiments, the first user interface does not correspond to the federated credential. In some embodiments, the second user interface does not correspond to the service-specific credential. In some embodiments, the service-specific credential is user generated or computer generated. In some embodiments, the federated credential is user generated or computer generated. In some embodiments, one or more options included in the set of one or more options for managing the federated credential is selectable. In some embodiments, the first user interface includes a set of one or more options for managing the service-specific credential. In some embodiments, the first user interface includes a link to a service-specific credential user interface. In some embodiments, the service-specific credential user interface includes a set of one or more options for managing the service-specific credential. In some embodiments, the first user interface, the second user interface, the federated credential user interface, and/or the service-specific credential user interface corresponds to the same application. In some embodiments, the first user interface, the second user interface, the federated credential user interface, and/or the service-specific credential user interface corresponds to different applications. In some embodiments, the first user interface and the second user interface corresponds to a first application, the federated credential user interface corresponds to a second application different from the first application, and the service-specific credential user interface corresponds to a third application (and/or a service) different from the first application and the second application. Displaying different user interfaces for different types of credentials allows the computer system to provide information that is specific to a type of credential being displayed, thereby providing improved visual feedback and/or performing an operation when a set of conditions has been met without requiring further user input. Displaying a user interface for a federated credential that includes a link to a federated credential user interface for managing the federated credential allows the computer system to provide ways to manage different types of credentials using a single credential manager, thereby providing improved visual feedback and/or performing an operation when a set of conditions has been met without requiring further user input.

In some embodiments, the second user interface (e.g., 658) includes an indication (e.g., a textual indication and/or a graphical indication) of an authentication source (e.g., 658a) (e.g., a company, a service, and/or an application that manages the federated credential, a company, a service, and/or an application that the federated credential is registered with, and/or a company, a service, and/or an application that the federated credential is linked to). In some embodiments, the authentication source is different from the respective service. In some embodiments, the authentication source is the respective service. In some embodiments, the indication of the authentication source of the federated credential is selectable. In some embodiments, the authentication source is for and/or of the federated credential. Displaying an indication of an authentication source when a set of prescribed conditions is met (e.g., when a service uses a federated credential) allows the computer system to provide an indication with respect to the type of credential that is associated with a respective service, thereby performing an operation when a set of conditions has been met without requiring further user input.

In some embodiments, in accordance with a determination that the authentication source is a first authentication source, the second user interface (e.g., 658) (and/or the indication of the authentication source) includes a first set of information (e.g., 658a-658d at FIG. 6H) (e.g., information corresponding to the authentication source, a set of one or more options, a set of one or more controls, a set of one or more instructions for using the federated credential, and/or a set of one or more instructions to stop using the federated credential). In some embodiments, the first set of information is separate from the indication of the authentication source. In some embodiments, the first set of information includes a link to a website and/or an application of the first authentication source. In some embodiments, in accordance with a determination that the authentication source is a second authentication source different from the first authentication source, the second user interface (and/or the indication of the authentication source) includes a second set of information (e.g., 658a-658f at FIG. 6J) (e.g., information corresponding to the authentication source, a set of one or more options, a set of one or more controls, a set of one or more instructions for using the federated credential, and/or a set of one or more instructions to stop using the federated credential) different from the first set of information. In some embodiments, the second set of information is separate from the indication of the authentication source. In some embodiments, the second set of information includes a link to a website and/or an application of the second authentication source. In some embodiments, the first set of information is a subset of information of the set second set of information or vice versa. In some embodiments, the first set of information is a superset of information of the second set of information or vice versa. Displaying different sets of information when different authentication sources are used allows the computer system to provide an indication with respect to which authentication source (e.g., company, application and/or website) manages a credential, thereby performing an operation when a set of conditions has been met without requiring further user input.

In some embodiments, the federated credential user interface (e.g., 660) includes an indication of a first service (e.g., 660d-660p) that is managed by the federated credential (e.g., 632b1 and/or 632e1). In some embodiments, the indication of the first service includes an indication of a login (e.g., of the first service) that is managed by the federated credential. In some embodiments, the federated credential user interface includes an indication of a second service (e.g., 660d-660p), different from the first service, that is managed by the federated credential. In some embodiments, the federated credential user interface includes three or more (e.g., a plurality of) services and/or logins that are managed by the federated credential. In some embodiments, the indication of the first service is different from the indication of the second service. In some embodiments, the first service and/or the second service is different from the respective service. In some embodiments, the first service or the second service is the respective service. In some embodiments, the indication of the second service includes an indication of a login (e.g., of the second service) that is managed by the federated credential. In some embodiments, while displaying the second user interface, the computer system detects, via the one or more input devices, an input that corresponds to selection of a link. In some embodiments, the input that corresponds to selection of the link is a tap input at a location of the link, a tap input at a confirmation button, a trackpad and/or mouse press input while a cursor or other focus selector is at a location of the link, a pinch gesture while a gaze of the user is directed at the link, and/or a voice command that includes an utterance that identifies the link and/or a request to manage the federated credential. In some embodiments, in response to detecting the input that corresponds to selection of the link, the computer system displays, via the one or more display generation components, one or more (e.g., a plurality of) services and/or logins that are managed by, registered with, and/or linked to the federated credential (e.g., without displaying one or more services and/or logins that are not registered with the federated credential). In some embodiments, the second user interface includes the indication of the first service and/or the indication of the second service. In some embodiments, the federated credential user interface is overlaid on top of the second user interface. In some embodiments, in response to detecting the input that corresponds to selection of the link, the computer system ceases display of, via the one or more display generation components, the second user interface as a part of displaying the federated user interface.

In some embodiments, the second user interface (e.g., 658) includes a selectable option (e.g., 658) (e.g., a control, a user interface object, a user interface element, and/or a virtual button) to stop using the federated credential (e.g., 632b1 and/or 632e1) for the respective service (e.g., disassociating the federated credential with the respective service). In some embodiments, while displaying the second user interface including the selectable option to stop using the federated credential, the computer system detects, via the one or more input devices (e.g., 608 and/or 606), an input (e.g., 605h3) corresponding to the selectable option to stop using the federated credential. In some embodiments, the input corresponding to the selectable option to stop using the federated credential is a tap input at a location of the selectable option, a trackpad and/or mouse and/or mouse press input while a cursor or other focus selector is at a location of the selectable option, a pinch gesture while a gaze of the user is directed at the selectable option, a pinch gesture while the selectable option is visually emphasized, and/or a voice command that includes an utterance that identifies the selectable option. In some embodiments, in response to detecting the input corresponding to the selectable option to stop using the federated credential, the computer system initiates a process to stop using the federated credential for the respective service (e.g., as described above at FIG. 6H) (and/or causes the federated credential to be disassociated, unregistered, and/or unlinked from the respective service). In some embodiments, in response to detecting the input corresponding to the selectable option to stop using the federated credential, the computer system ceases display of, via the one or more display generation components, the second user interface. In some embodiments, after completing the process to stop using the federated credential for the respective service and/or causing the federated credential to be disassociated, unregistered, and/or unlinked from the respective service, the federated credential remains attached to, used for, linked to, associated with, and/or registered with another service different from the respective service. In some embodiments, a respective computer system external to the computer system performs at least a portion of the process to stop using the federated credential for the respective service and/or disassociates, unregisters, and/or unlinks the federated credential from the respective service. Initiating a process to stop using a federated credential in response to detecting an input corresponding to a selectable option allows the computer system to manage use of the federated credential for specific services, thereby providing improved feedback and/or performing an operation when a set of conditions has been met without requiring further user input.

In some embodiments, the first user interface (e.g., 640 and/or 642) includes an indication (and/or identification) of a user name (e.g., 640b) for use with the respective service (e.g., a unique user identifier for the respective service). In some embodiments, the service-specific credential includes the user name. In some embodiments, the first user interface includes a selectable option (e.g., a control, a user interface object, a user interface element, and/or a virtual button) to modify the user name. In some embodiments, while displaying the first user interface including the selectable option to modify the user name, the computer system detects, via the one or more input devices, an input corresponding to the selectable option to modify the user name. In some embodiments, the input corresponding to the selectable option to modify the user name is a tap input at a location of the selectable option, a trackpad and/or mouse and/or mouse press input while a cursor or other focus selector is at a location of the selectable option, a pinch gesture while a gaze of the user is directed at the selectable option, a pinch gesture while the selectable option is visually emphasized, and/or a voice command that includes an utterance that identifies the selectable option. In some embodiments, in response to detecting the input corresponding to the selectable option to modify the user name, the computer system initiates a process to modify the user name. In some embodiments, the user name is created by a user. In some embodiments, the user name is assigned to a user. In some embodiments, the user name is automatically generated. Displaying an indication of a user name when a set of prescribed conditions is met (e.g., when the respective service uses a service-specific credential) allows the computer system to provide an indication with respect to a type of credential that is associated with a respective service (e.g., the respective service has a service-specific credential), thereby performing an operation when a set of conditions has been met without requiring further user input.

In some embodiments, the first user interface (e.g., 640 and/or 642) includes an indication (and/or identification) of a password (e.g., 640c) for use with the respective service (e.g., a set of one or more characters and/or symbols that verifies the identity of a user). In some embodiments, the indication of the password includes and/or is a set of one or more common symbols (e.g., a set of one or more asterisks, circles, and/or squares). In some embodiments, the password is automatically generated. In some embodiments, the first user interface includes a selectable option (e.g., a control, a user interface object, a user interface element, and/or a virtual button) to modify the password. In some embodiments, while displaying the first user interface including the selectable option to modify the password, the computer system detects, via the one or more input devices, an input corresponding to selection of the selectable option to modify the password. In some embodiments, the input corresponding to the selectable option to modify the password is a tap input at a location of the selectable option, a trackpad and/or mouse and/or mouse press input while a cursor or other focus selector is at a location of the selectable option, a pinch gesture while a gaze of the user is directed at the selectable option, a pinch gesture while the selectable option is visually emphasized, and/or a voice command that includes an utterance that identifies the selectable option. In some embodiments, in response to detecting the input corresponding to selection of the selectable option to modify the password, the computer system initiates a process to modify the password. In some embodiments, the indication of the password partially or fully obfuscates the password. Displaying an indication of a password when a set of prescribed conditions is met (e.g., when the respective service uses a service-specific credential) allows the computer system to provide an indication with respect to the type of credential that is associated with the respective service (e.g., the respective service has a service-specific credential), thereby performing an operation when a set of conditions has been met without requiring further user input.

In some embodiments, the first user interface (e.g., 640 and/or 642) includes an indication of a passkey (e.g., 640j and/or 646 at FIG. 6G) for use with the respective service (e.g., a secure token that is stored locally on the computer system and used to securely provide authentication). In some embodiments, the passkey is and/or includes a private key. In some embodiments, the passkey is used to encrypt and/or generate a signature for a message. In some embodiments, an application (e.g., a user application that corresponds to a service associated with the passkey) of the computer system and/or a device (e.g., a server, a web server, and/or a computer system corresponding to a service associated with the passkey) has access to a public key that corresponds to the passkey. In some embodiments, the passkey is verified by the application or the device generating a signature using the public key and matching the signature using the public key with the signature generated using the passkey. In some embodiments, the passkey is generated by the computer system. In some embodiments, the passkey is generated by a respective computer system external to the computer system. In some embodiments, the passkey is generated by an application that is installed on the computer system. In some embodiments, the passkey corresponds to one or more biometrics of a user. In some embodiments, the service-specific credential does not include a user name and/or password when the service-specific credential includes the passkey. In some embodiments, the passkey of the service specific credential replaces a user name and/or password of the service specific credential. Displaying an indication of a passkey when a set of prescribed conditions is met (e.g., when the respective service uses a service-specific credential) allows the computer system to provide an indication with respect to a type of credential that is associated with the respective service, thereby performing an operation when a set of conditions has been met without requiring further user input.

In some embodiments, the indication of the passkey (e.g., 640j and/or 646 at FIG. 6G) is displayed concurrently with information corresponding to (e.g., directed to, related to, and/or associated with) a password (e.g., 646b) (e.g., set of one or more characters and/or symbols that verifies the identity of a user) of the service-specific credential (e.g., 632d1, 632a1, and/or 632c1). In some embodiments, the first user interface includes a representation of the password for the service-specific credential. In some embodiments, the password is registered and/or active with respect to the respective service. In some embodiments, the password is not registered and/or active with respect to the respective service. In some embodiments, the password is a current password that is registered with the service-specific credential. In some embodiments, the password is a most recent password used to access restricted functionality of the respective service. In some embodiments, the password is a recently used password, a most-recently used password, a previous password, a password that was replaced by the passkey, a password previously associated with the service-specific credential, a password that is currently associated with the service-specific credential, and/or a password that was mostly recently used and/or or last used to access restricted functionality of respective service. Displaying information corresponding to a password of a service-specific credential concurrently with an indication of a passkey allows the computer system to provide a user with an alternative way to authenticate themselves when the passkey is not available for use, thereby providing improved feedback and/or performing an operation when a set of conditions has been met without requiring further user input.

In some embodiments, in response to detecting the input corresponding to the request to display the credential (e.g., 605c1, 605d1, 605f1, 605g, and/or 605i) for the respective service and in accordance with a determination that the service-specific credential (e.g., 632d1, 632a1, and/or 632c1) has a security alert (e.g., 634a, 634b, and/or 634c) (e.g., the service-specific credential has been compromised, the service-specific credential is part of a data leak, the service-specific credential is a duplicate, the service-specific credential does not meet a set of one or more security requirements, and/or the service-specific credential is determined to be easy to guess), the first user interface (e.g., 640 and/or 642) includes a selectable option (e.g., 642a) (e.g., a control, a user interface object, a user interface element, and/or a virtual button) to change (e.g., edit and/or modify) the service-specific credential (e.g., to change information, such as a user name and/or a password, of the service-specific credential). In some embodiments, in response to detecting the input corresponding to the request to display the credential (e.g., 605c1, 605d1, 605f1, 605g, and/or 605i) for the respective service and in accordance with a determination that the service-specific credential does not have a security alert, the first user interface does not include the selectable object to change the service-specific credential. In some embodiments, the security alert is disassociated with the service-specific credential when the information, the user name, the password, and/or the service-specific credential is changed. Selectively including a selectable option within the first user interface when a set of prescribed conditions is met allows the computer system to automatically indicate whether a security alert is associated with the service-specific credential, thereby performing an operation when a set of conditions has been met without requiring further user input.

In some embodiments, while displaying the first user interface (e.g., 640 and/or 642) without the selectable option to change the service-specific credential (e.g., 632d1, 632a1, and/or 632c1) (e.g., in accordance with the determination that the service-specific credential does not have a security alert), the computer system detects, via the one or more input devices (e.g., 608 and/or 606), an input corresponding to a request to edit the service-specific credential. In some embodiments, the input corresponding to the request to edit the service-specific credential includes a tap input that corresponds to selection of a selectable option to edit the service-specific credential, a gaze directed at the selectable option to edit the service-specific credential, a voice command that includes an utterance that identifies the service-specific credential, and/or a depression of a rotatable input mechanism while the service-specific credential and/or the selectable option to edit the service-specific credential is visually emphasized. In some embodiments, in response to detecting the input corresponding to the request to edit the service-specific credential, the computer system displays, via the one or more display generation components (e.g., 602), the selectable option (e.g., within the first user interface) to change (e.g., edit and/or modify) the service-specific credential (e.g., to change information, such as a user name and/or a password, of the service-specific credential). In some embodiments, in response to detecting the input corresponding to the request to edit the service-specific credential, the computer system ceases display of, via the one or more display generation components, the first user interface and displays, via the one or more display generation components, a user interface that corresponds to the respective service. In some embodiments, in response to detecting the input corresponding to the request to edit the service-specific credential, the computer system continues display of, via the one or more display generation components, the first user interface. In some embodiments, the computer system initiates a process for changing the service-specific credential in response to detecting an input that corresponds to selection of the selectable option to change the service-specific credential. In some embodiments, the input that corresponds to selection of the selectable option to change the service-specific credential is a tap input at a location of the selectable option, a trackpad and/or mouse and/or mouse press input while a cursor or other focus selector is at a location of the selectable option, a pinch gesture while a gaze of the user is directed at the selectable option, a pinch gesture while the selectable option is visually emphasized, and/or a voice command that includes an utterance that identifies the selectable option. In some embodiments, the computer system displays a text entry user interface object (e.g., user name entry user interface object and/or password entry user interface object, a website that corresponds to the service, and/or an application that corresponds to the service), a website that corresponds to the service, and/or an application that corresponds to the service as a part of initiating the process for changing the service-specific credential. Displaying a selectable option to change a credential in response to detecting an input to change the service-specific credential allows the computer system to provide an option to edit and/or initiate editing of a credential without requiring the user to navigate away from a credential management system, thereby reducing the number of inputs needed to perform an operation (e.g., modify the credential).

In some embodiments, the credential manager user interface (e.g., 616, 692, and/or 694) includes a first representation (e.g., an indication and/or an identification) of a first wireless network (e.g., a WiFi and/or a short-range communication network) credential (e.g., 678a-678k) (e.g., a name and/or a representation of a password). In some embodiments, the first representation is of one or more wireless network credentials. In some embodiments, the first representation of the first wireless network credential includes an indication of a number of wireless network credentials managed by a credential management system. In some embodiments, the first representation of the first wireless network includes a representation of a protocol for a network corresponding to the first wireless network credential. In some embodiments, the credential manager user interface includes a representation of a protocol for a network corresponding to the first wireless network credential. In some embodiments, the credential manager user interface includes a list of wireless network credentials and/or a list of wireless networks that the computer system and/or one or more computer systems, different from the computer system, associated with a common account as the computer system has previously connected to and/or attempted to connect to. In some embodiments, the credential manager user interface includes a list of wireless networks that the computer system is in range of. In some embodiments, the credential manager user interface includes a list of wireless networks that the computer system is authorized to connect to. In some embodiments, the list of wireless network credentials and/or the list of wireless networks is in chronological order or reverse chronological order. In some embodiments, the list of wireless network credentials and/or the list of wireless networks is in alphabetical order or reverse alphabetical order. In some embodiments, the list of wireless network credentials and/or the list of wireless networks is ordered based on signal strength (e.g., stronger signal strength are higher in the list than lower signal strength). In some embodiments, the credential manager user interface includes a second representation of a second wireless network credential. In some embodiments, the credential manager user interface includes a second representation of a second wireless network different from the first wireless network. Including a representation of a wireless network credential within the credential manager user interface allows the computer system to provide an indication of the various types of credentials that are associated with a credential management system that corresponds to the credential manger user interface, thereby providing improved feedback and/or performing an operation when a set of conditions has been met without requiring further user input.

In some embodiments, the credential manager user interface (e.g., 616, 692, and/or 694) includes a second representation (e.g., an indication and/or an identification) of a second wireless network (e.g., a WiFi and/or a short-range communication network) credential (e.g., 678a-678k) (e.g., a name and/or a representation of a password). In some embodiments, the second representation is different from the first representation (e.g., 678a-678k). In some embodiments, the second wireless network credential is different from the first wireless network credential. In some embodiments, the first wireless network credential corresponds to a first wireless network. In some embodiments, the second wireless network credential corresponds to the first wireless network. In some embodiments, the second wireless network credential corresponds to a second wireless network different from the first wireless network. In some embodiments, in accordance with a determination that the first wireless network credential was more recently used (e.g., the by computer system and/or by an external computer system that is commonly owned and/or registered with a common account as the compute system) than the second wireless network credential, the first representation of the first wireless network credential is displayed more prominently (e.g., visually emphasized and/or closer to a top of a list of wireless network credentials) than the second representation of the second wireless network credential (e.g., the first representation and the second representation are ordered based on which was more recently used) (e.g., as described above in reference to FIG. 6N). In some embodiments, a representation of a wireless network credential is displayed at a position relative (e.g., above, below, and/or to the side) to the first representation of the first wireless network credential and the second representation of the second representation of the second wireless network credential, in accordance with a determination that the computer system is presently connected to a wireless network using the wireless network credential. In some embodiments, in accordance with a determination that the second wireless network credential was more recently used (e.g., the by computer system and/or by an external computer system that is commonly owned and/or registered with a common account as the compute system) than the first wireless network credential, the second representation of the second wireless network credential is displayed more prominently (e.g., visually emphasized and/or closer to a top of a list of wireless network credentials) than the first representation of the first wireless network credential (e.g., as described above in reference to FIG. 6N) (e.g., and the first representation is not displayed more prominently than the second representation). More prominently displaying a particular representation of a wireless network credential when a set of prescribed conditions is met allows the computer system to indicate a recency in which wireless networks were last connected to, thereby performing an operation when a set of conditions has been met without requiring further user input.

In some embodiments, in response to detecting the input corresponding to the request display the credential for the respective service (e.g., 605c1, 605d1, 605f1, 605g, and/or 605i) and in accordance with a determination that the respective service uses a first wireless network credential (e.g., 678a-678k), the computer system displays, via the one or more display generation components (e.g., 602), a third user interface (e.g., 680) that corresponds to (e.g., directed to, at a location of, related to and/or associated with, and/or includes information regarding) the first wireless network credential, wherein the third user interface includes a selectable option (e.g., 680c) to display a machine readable visual code (e.g., 682b) (e.g., an app clip code or quick response (QR) code) to connect to the first wireless network. In some embodiments, while displaying the credential manager user interface, the computer system detects an input that corresponds to selection of a filter for wireless network credentials. In some embodiments, in response to detecting the input that corresponds to the selection of the filter for wireless network credentials, the computer system displays a representation of a set of one or more wireless network credentials (e.g., the first representation of the first wireless network credential and/or a second representation of the second wireless network credential). In some embodiments, in response to detecting a selection of a representation of the set of one or more wireless network credentials (e.g., the first representation of the first wireless network credential or another representation of the first wireless network credential), the computer system displays the selectable option to display the machine readable code to connect to the first wireless network. In some embodiments, the machine readable visual code includes credential data (e.g., network name and/or password) corresponding to the first wireless network. In some embodiments, the machine readable visual code is used to quickly share the credential data (e.g., by a respective device scanning and/or otherwise reading the machine readable visual code) so that the respective device is able to join the first wireless network. In some embodiments, in response to scanning and/or otherwise reading the machine readable visual code and/or in response to detecting an input directed to the machine readable visual code or a user interface element (e.g., a button) associated with the machine readable visual code, the respective device automatically joins the first wireless network using the credential data. Displaying a user interface to provide a machine readable visual code allows the computer system to quickly share passwords with others devices, thereby performing an operation when a set of conditions has been met without requiring further user input.

In some embodiments, the credential manager user interface (e.g., 616, 692, and/or 694) includes a first authentication code (e.g., 632g3 and/or 632h3) (e.g., for a service, such as the respective service or another service different from the respective service). In some embodiments, the first authentication code is automatically generated. In some embodiments, the first authentication code is a numeric code and/or an alphanumeric code. In some embodiments, the first authentication code is part of a two-factor authentication for a service. In some embodiments, the first authentication code includes an indication of a number of authentication codes managed by the credential manager user system. In some embodiments, the credential manager user interface includes a second authentication code different from the first authentication code. In some embodiments, the credential manager user interface includes a list of authentication codes that are currently active and/or inactive and managed by a credential management system of the computer system. In some embodiments, the authentication codes included in the list of authentication codes are ordered based on a recency of when the authentication codes were created. In some embodiments, the authentication codes included in the list of authentication codes are ordered based on a recency of when the authentication codes were last used. In some embodiments, the computer system displays multiple authentication codes for a common service together. In some embodiments, the computer system displays multiple authentication codes for a common service separate from each other. Including an authentication code within a user interface allows the computer system to indicate the various types of credentials that are managed by a credential management system that corresponds to the credential manger user interface, thereby providing improved feedback and/or performing an operation when a set of conditions has been met without requiring further user input.

In some embodiments, the credential manager user interface (e.g., 616, 692, and/or 694) includes a second authentication code (e.g., 632g3 and/or 632h3), different from the first authentication code (e.g., 632g3 and/or 632h3), that is concurrently displayed with the first authentication code. In some embodiments, the credential manager user interface includes an authentication code filter. In some embodiments, the computer system displays the first authentication code and/or the second authentication code in response to detecting an input that corresponds to selection of the authentication code filter. In some embodiments, the computer system displays the first authentication code and the second authentication code in a temporal order based on when the codes will expire. In some embodiments, computer system displays the first authentication code and the second authentication code in an alphabetical order based on the name of the respective services that correspond to the first authentication code and the second authentication code. In some embodiments, the computer system updates display of the first authentication code and the second authentication code in real time. (e.g., the computer system ceases to display the first authentication code and/or the second authentication code when the first authentication code or the second authentication code is no longer valid). In some embodiments, first authentication code is for a first service and the second authentication code is for a second service different from the first service. In some embodiments, the first authentication code and the second authentication code are for the same service. Including multiple authentication codes within a user interface allows the computer system to concurrently provide authentication code information for at least two discrete purposes to a user, thereby providing improved feedback and/or performing an operation when a set of conditions has been met without requiring further user input.

In some embodiments, the credential manager user interface (e.g., 616, 692, and/or 694) includes a first indication (e.g., a textual indication, a graphical indication, and/or a digital timer) of an amount of time (e.g., 632g4 and/or 632h4) until the first authentication code (e.g., 632g3 and/or 632h3) resets (e.g., and/or expires) and a second indication (e.g., a textual indication, a graphical indication, and/or a digital timer) of an amount of time (e.g., 632g4 and/or 632h4) until the second authentication code (e.g., 632g3 and/or 632h3) resets (e.g., and/or expires). In some embodiments, the first indication of the amount of time until the first authentication code resets and the second indication of the amount of time until the second authentication code resets are displayed with the first authentication code and the second authentication code. In some embodiments, the computer system displays the first indication of the amount of time until the first authentication code resets and/or the second indication of the amount of time until the second authentication code for the second service resets in response to detecting an input that corresponds to selection of the authentication code filter. In some embodiments, the first indication of the amount of time until the first authentication code resets and the second indication of the amount of time until the second authentication code resets are the same types of indications. In some embodiments, the first indication of the amount of time until the first authentication code resets and the second indication of the amount of time until the second authentication code for the second service resets are the different types of indications. In some embodiments, the first indication of the amount of time until the first authentication code resets is displayed in-line with the first authentication code and the second indication of the amount of time until the second authentication code for the second service resets is displayed concurrently with and/or inline with the second authentication code for the second service. Including multiple indications of an amount of time until various authentication codes reset within the credential manager user interface allows the computer system to concurrently provide information regarding the status of different authentication codes of various services, thereby providing improved feedback and/or performing an operation when a set of conditions has been met without requiring further user input.

In some embodiments, the credential manager user interface (e.g., 616, 692, and/or 694) includes a first list of representations (e.g., 632a1-632f1) (e.g., textual representations and/or graphical representations) of credentials. In some embodiments, the credential manager user interface includes a filter for credentials that have a security alert (e.g., 624e) (e.g., credentials that have been compromised, credentials that are part of a data leak, credentials that are duplicates, credentials that do not meet a set of one or more security requirements, and/or credentials that are determined to be easy to guess). In some embodiments, the first list of representations of credentials includes at least one representation of a credential that does not have a security alert and at least one representation of a credential that has a security alert. In some embodiments, while displaying the credential manager user interface with the first list of representations of credentials and the filter for credentials that have a security alert, the computer system detects, via the one or more input devices (e.g., 608 and/or 606), an input (e.g., 605s) corresponding to the filter for credentials that have a security alert. In some embodiments, the input corresponding to the filter for credentials that have a security alert is a tap input at a location of the filter for credentials that have a security alert, a trackpad and/or mouse press input while a cursor or other focus selector is at a location of the filter for credentials that have a security alert, a pinch gesture while a gaze of the user is directed at the filter for credentials that have a security alert, a pinch gesture while the filter for credentials that have a security alert is visually emphasized, and/or a voice command that includes an utterance that identifies the filter for credentials that have a security alert. In some embodiments, in response to detecting the input corresponding to the filter for credentials that have a security alert, the computer system displays, via the one or more display generation components (e.g., 602), a second list of representations of credentials (e.g., 630) different from the first list of representations of credentials (e.g., without displaying the first list of representations of credentials), wherein the second list of representations of credentials includes a representation of a credential (e.g., 630b1, 630c1, 630i1, 630k1, 630m1, and/or 630j1) that has (e.g., currently has) a security alert (e.g., the credential is weak, the credential is part of a data leak, the credential has a password that is easy to guess, and/or the credential shares a common password with another credential of the user) without including a representation of a credential that does not have (e.g., does not currently have) a security alert. In some embodiments, the computer system ceases display of the first list of representations of credentials as a part of displaying the second list of representations of credentials. In some embodiments, the computer system displays the second list of representations of credentials as overlaid on top of the credential manager user interface and/or the first list of representations of credentials. In some embodiments, the order of the second list of representations of credentials is based on a severity of a security alert (e.g., a credential with the most serious security alert is displayed at the top). In some embodiments, the second list of representations of credentials is displayed based on a severity of a security alert (e.g., a representation of a credential with the most serious security alert is displayed in red). Displaying a list of representations of credentials that have security alerts in response to detecting an input corresponding to a filter for credentials allows the computer system to perform a filtering operation such that the computer system only displays a certain type of credential, thereby providing improved feedback and/or performing an operation when a set of conditions has been met without requiring further user input.

In some embodiments, the credential for the respective service is a first credential. In some embodiments, the second list (e.g., 630) of representations of credentials includes a representation of the first credential (e.g., 630b1, 630c1, 630i1, 630k1, 630m1, and/or 630j1) (e.g., an indication of the first credential, a name of the first credential, a graphical representation of the first credential and/or a textual representation of the first credential), a representation of a second credential (e.g., 630b1, 630c1, 630i1, 630k1, 630m1, and/or 630j1) (e.g., an indication of the second credential, a name of the second credential, a graphical representation of the second credential and/or a textual representation of the second credential) different from the first credential, and a representation of a third credential (e.g., 630b1, 630c1, 630i1, 630k1, 630m1, and/or 630j1) (e.g., an indication of the third credential, a name of the third credential, a graphical representation of the third credential and/or a textual representation of the third credential) different from the first credential and the second credential. In some embodiments, while displaying the second list of representations of credentials, the computer system detects an input (e.g., 605t) corresponding to (e.g., directed to, at a location of, related to, and/or associated with) selection of the representation of the first credential included in the second list of representations of credentials. In some embodiments, the input corresponding to selection of the representation of the first credential included in the second list of representations of credentials is a placement of a cursor or other focus selector over the first credential, a tap input at a location of the first credential, a trackpad and/or mouse press input while a cursor or other focus selector is at a location of the first credential, a pinch gesture while a gaze of the user is directed at the first credential, a pinch gesture while the representation of the first credential is visually emphasized, and/or a voice command that includes an utterance that identifies the information corresponding to the first credential. In some embodiments, in response to detecting the input corresponding to selection of the representation of the first credential and in accordance with a determination that the second credential and the third credential have a common password with the first credential, the computer system visually emphasizes (e.g., concurrently visually emphasizing, such as highlighting, tinting, shading, increasing in size, and/or maintaining the size while reducing the size of other representations of credentials) the representation of the first credential, the representation of the second credential, and the representation of the third credential (e.g., as described above in reference to FIG. 6U). In some embodiments, the computer system does not visually emphasize any representation of the second list of representations of credentials in accordance with a determination that no credential included in the second list of representations of credentials has the common password with the first credential. In some embodiments, the first credential, the second credential, and the third credential correspond to different services, websites, and/or applications. In some embodiments, the first credential, the second credential, and the third credential are the same type of credential or a different type of credential. In some embodiments, the input includes hovering a cursor over the display of the representation of the first credential. Visually emphasizing a representation of a credential when a set of prescribed conditions is met (e.g., the credential has a common password with another different credential) allows the computer system to automatically perform a display operation that provides an indication with respect to the frequency in which a particular password is used among various credentials, thereby performing an operation when a set of conditions has been met without requiring further user input.

In some embodiments, the credential (e.g., 632a1, 632b1, 632d1, 632e1, and/or 632f1) for the respective service is a first credential. In some embodiments, in response to detecting the input corresponding to the request to display the credential for the respective service and in accordance with a determination that the respective service uses the service-specific credential (e.g., 632d1, 632a1, and/or 632c1) and that a second credential (e.g., 632c1, 632g1, and/or 632h1) (e.g., a user selected password/user name, a passkey, or an authentication code), different from the first credential (e.g., the first credential is a first type of credential and the second credential is a second type of credential different from the first type of credential), provides additional security (e.g., the second of credential is more secure than the first credential, the second credential is more complex than the first credential, the second credential is harder to guess than the first credential, and/or the second credential is harder to gain access to than the first credential), the first user interface (e.g., 640 and/or 642) includes information (e.g., 642a, 646c, and/or 646a) corresponding to (e.g., directed to, related to, and/or associated with) the second credential (e.g., information regarding the security features of the second credential, a link to switch from the first credential to the second credential, a link to supplement the first credential with the second credential, information to strengthen the first credential, and/or a link to user a different federated credential). In some embodiments, in response to detecting the input corresponding to the request to display the credential for the respective service and in accordance with a determination that the respective service uses the service-specific credential and that the second credential (and/or any credential) would not provide additional security (e.g., the second credential is not more secure than the first credential, the second credential is not more complex than the first credential, the second credential is easier guess than the first credential, and/or the second credential is easier to gain access to than the first credential), the first user interface does not include information corresponding to the second credential. In some embodiments, in response to detecting the input corresponding to the request to display the credential for the respective service and in accordance with a determination that the respective service uses the federated credential (e.g., 632b1 and/or 632e1) and that a third credential (e.g., 632c1, 632g1, and/or 632h1) would provide additional security (e.g., the third credential is more secure than the first credential, the third credential is more complex than the first credential, the third credential is harder to guess than the first credential, and/or the third credential is harder to gain access to than the first credential), the second user interface (e.g., 658) includes information (e.g., 642a, 646c, and/or 646a) corresponding to (e.g., directed to, related to, and/or associated with) the third credential (e.g., information regarding the security features of the third credential, a link to switch from the first credential to the third credential, a link to supplement the first credential with the third credential, information to strengthen the first credential, and/or a link to use a different federated credential). In some embodiments, in response to detecting the input corresponding to the request to display the credential for the respective service and in accordance with a determination that the respective service uses the federated credential and that the third credential (and/or any credential) would not provide additional security, the second user interface does not include information corresponding to the third credential. In some embodiments, while displaying the link to switch from the first credential to the second or third credential, the computer system detects an input corresponding to selection of the link. In some embodiments, in response to detecting the input corresponding to selection of the link, the computer system initiates a process for switching the first credential to the second credential or third credential. Selectively providing information corresponding to a respective credential when a set of prescribed conditions is met allows the computer system to automatically perform a display operation that indicates that the security of a credential could be increased by securing the credential with a different credential, thereby performing an operation when a set of conditions has been met without requiring further user input.

In some embodiments, the federated credential (e.g., 632b1 and/or 632e1) is a first federated credential. In some embodiments, the information corresponding to the third credential includes information (e.g., 658f) (e.g., instructions and/or a link) corresponding to (e.g., directed to, related to, and/or associated with) switching from the first federated credential to a second federated credential (e.g., a credential that is authenticated by a separate authentication provider that is different from the authentication provider of the first federated credential and optionally can be used to grant access to a number of unrelated services) different from the first federated credential. In some embodiments, the information corresponding to the third credential includes a link to switch from the first federated credential to the second federated credential.

In some embodiments, the information (e.g., 646a) corresponding to the second credential includes information corresponding to (e.g., directed to, related to, and/or associated with) switching from the service-specific credential (e.g., 632d1, 632a1, and/or 632c1) to a passkey credential (e.g., 632c1) (e.g., a secure token that is stored locally on the computer system and used to securely provide authentication). In some embodiments, the passkey is and/or includes a private key. In some embodiments, the passkey is used to encrypt and/or generate a signature for a message. In some embodiments, an application (e.g., a user application that corresponds to a service associated with the passkey) of the computer system and/or a device (e.g., a server, a web server, and/or a computer system corresponding to a service associated with the passkey) has access to a public key that corresponds to the passkey. In some embodiments, the passkey is verified by the application or the device generating a signature using the public key and matching the signature using the public key with the signature generated using the passkey. In some embodiments, the information corresponding to the second credential includes a link to switch from the service-specific credential to the passkey credential.

In some embodiments, the computer system (e.g., before and/or after detecting the input corresponding to the request to display the credential for the respective service) detects, via the one or more input devices (e.g., 608 and/or 606), an input (e.g., 805c) corresponding to a request to use the credential (e.g., 632a1, 632b1, 632c1, 632d1, 632e1, and/or 632f1) to access restricted functionality of the respective service. In some embodiments, the input corresponding to the request to use the credential to access restricted functionality of the respective service is a selection of a login button of the respective service, a voice command to login to the respective service, a tap input at a location of a login user interface object, a trackpad and/or mouse press input while a cursor or other focus selector is at a location of a login user interface object, a pinch gesture while a gaze of the user is directed at a login user interface object, a selection of an enter button on a hardware keyboard or software keyboard, and/or selection of a submit button. In some embodiments, in response to detecting the input corresponding to the request to use the credential to access restricted functionality of the respective service and in accordance with a determination that the request to use the credential to access restricted functionality of the respective service is accepted (e.g., accepted by a respective computer system external to the computer system and/or the respective service and/or accepted by the computer system), the computer system displays, via the one or more display generation components (e.g., 602), information (e.g., 814a and/or 808a) related to (and/or corresponding to, associated with, and/or from) an application (e.g., 612a) (e.g., an application installed on the computer system and/or an application installed on a respective computer system external to the computer system) corresponding to (e.g., directed to, related to, and/or associated with) the credential manager user interface (e.g., 616, 692, and/or 694). In some embodiments, the computer system displays content related to the restricted functionality of the respective service in response to detecting the input corresponding to the request to use the credential to access restricted functionality of the respective service and in accordance with a determination that the request to use the credential to access restricted functionality of the respective service is accepted. In some embodiments, the computer system concurrently displays the information relating to the application corresponding to the credential manager user interface and the content related to the restricted functionality of the respective service. In some embodiments, the computer system forgoes displaying the information relating to the application that corresponds to the credential manager user interface in response to detecting the input corresponding to the request to use the credential to access restricted functionality of the respective service and in accordance with a determination that the request to use the credential to access restricted functionality of the respective service is denied. In some embodiments, the information relating to the application corresponding to the credential manager user interface is displayed within a notification. In some embodiments, the computer system ceases to display the information relating to the application corresponding to the credential manager user interface after a predetermined period of time has elapsed. Displaying information related to an application corresponding to a credential manager user interface of a credential management application when a set of prescribed conditions is met allows the computer system to provide information regarding the credential management application to a user at a point in time when the interest of the user in the credential management application is heightened, thereby performing an operation when a set of conditions has been met without requiring further user input.

In some embodiments, the information includes an option (e.g., 814a and/or 808a) to view the credential manager user interface (e.g., 616, 692, and/or 694). In some embodiments, while displaying the option to view the credential manager user interface (e.g., and while not displaying the credential user interface), the computer system detects, via the one or more input devices (e.g., 608 and/or 606), an input (e.g., 805d) corresponding to selection of the option to view the credential manager user interface. In some embodiments, the input corresponding to selection of the option to view credential manager user interface is a tap input at a location of a link to the credential manager user interface, a trackpad and/or mouse press input while a cursor or other focus selector is at a location of a link to the credential manger user interface, a pinch gesture while a gaze of the user is directed at a link to the credential manager user interface and/or a voice command that includes an utterance that identifies the credential manager user interface. In some embodiments, in response to detecting the input that corresponds to selection of the option to view the credential manager user interface, the computer system displays, via the one or more display generation components (e.g., 602), the credential manager user interface. In some embodiments, the computer system ceases to display the information as a part of displaying the credential manager user interface. In some embodiments, the computer system continues to display the information as a part of displaying the credential manager user interface. In some embodiments, the input corresponding to selection of the option to view the credential manager user interface is a selection of a link, graphical representation of the credential manager user interface, and/or graphical representation of a credential manager application installed on the computer system. Displaying information related to an application corresponding to the credential manager user interface when a set of prescribed conditions is met allows the computer system to provide access to the application to a user at a point in time when the interest of the user in the application is heightened, thereby performing an operation when a set of conditions has been met without requiring further user input.

Note that details of the processes described above with respect to method 700 (e.g., FIG. 7) are also applicable in an analogous manner to other methods described herein. For example, method 900 optionally includes one or more of the characteristics of the various methods described above with reference to method 700. For example, the computer system can use one or more techniques of method 900 to display an option to view the first user interface or the second user interface of method 700. For brevity, these details are not repeated herein.

FIGS. 8A-8Z illustrate exemplary user interfaces for displaying notifications regarding the saving of credentials in accordance with some embodiments. The user interfaces in these figures are used to illustrate the processes described below, including the processes in FIG. 9.

FIGS. 8A-8Z illustrate a process of saving credentials to the credential management system. As discussed above with respect to FIGS. 6A-6U, the credential management system is an application that is installed on computer system 600 that manages credentials for various services, applications, and/or websites. At FIGS. 8A-8Z, the credentials (e.g., e-mails, usernames, passkeys, verification codes, and/or passwords) that are saved to the credential management system are used to log into or create an account associated with various websites. In the example of FIGS. 8A-8Z, computer system 600 is a laptop computer in communication with keyboard input device 606 and touch-sensitive surface 608 as illustrated and described above with respect to FIGS. 6A-6U. The features of computer system 600, keyboard input device 606, and touch-sensitive surface 608 discussed above in reference to FIGS. 6A-6U are hereby incorporated into the discussion of FIGS. 8A-8Z.

FIGS. 8A-8E illustrate a process in which computer system 600 generates credentials for a user account of a website (e.g., example.com) and stores the credentials within the credential management system. As illustrated in FIG. 8A, computer system 600 displays, via display 602, time indicator 610a (e.g., 1:27 PM in FIG. 8A), credential management control 610b, and company C website user interface 812 as overlaid over home screen user interface 604. company C website user interface 812 is a webpage of a website entitled “example.com” (hereinafter referred to as “the company C website”). company C website user interface 812 includes URL control 830 which indicates the domain of the website “example.com”.

At FIG. 8A, computer system 600 is in the process of creating a user account for the company C website. As illustrated in FIG. 8A, company C website user interface 812 includes create account user interface 804 for creating a user account with the company C website. Create account user interface 804 is a user interface in which computer system 600 displays and/or enters information as a part of creating the user account for the company C website. Create account user interface 804 includes name field 804a, “John Appleseed;” e-mail field 804b, “johnap@invalid.com;” password field 804c; confirm password field 804d; password guidelines 804e; create account control 804f; and existing account control 804g.

Name field 804a is a field in which computer system 600 enters and displays a representation of a name of a user to be associated with the user account being created; e-mail field 804b is a field in which computer system 600 enters and displays an e-mail address to be associated with the user account being created; password field 804c is a field in which computer system 600 enters and displays a password and/or a representation of the password that will secure the user account; confirm password field 804d is a field in which computer system 600 displays and/or enters a duplicate of the password used to secure the user account; password guidelines 804e are rules that the created password must adhere to (e.g., the password must have at least 8 characters and must include at least one number). Computer system 600 displays existing account control 804g as a selectable option for users who already have a user account with the company C website. At FIG. 8A, computer system 600 detects, via touch-sensitive surface 608, tap input 805a while selection tool 614 is overlaid over password field 804c. In some embodiments, instead of tap input 805a, computer system 600 detects a tap input at a location of password field 804c, a voice command including an utterance identifying password field 804c, an eye gaze directed at password field 804c, a depression of an input mechanism while password field 804c is visually emphasized, and/or an air gesture input directed at password field 804c. In some embodiments, in response to detecting an input directed to create account control 804f, a user account is created for the company C website using the credentials entered into fields 804a-d. In some embodiments, in response to detecting selection of existing account control 804g, computer system 600 displays a login page of the company C website.

As illustrated in FIG. 8B, in response to detecting tap input 805a, computer system 600 displays notification 806 below confirm password field 804d. As illustrated in FIG. 8B, notification 806 includes yes control 806a and no control 806b. Computer system 600 generates a password for the user account being created for the company C website upon detecting selection of yes control 806a and computer system 600 does not generate a password for the user account being created for the company C website upon detecting selection of no control 806b. Also illustrated in FIG. 8B, in response to detecting tap input 805a, computer system 600 displays a cursor in password field 804c, which indicates that computer system 600 is configured to enter text (e.g., manually typed by the user or generated by computer system 600) into password field 804c. At FIG. 8B, computer system 600 detects, via touch-sensitive surface 608, tap input 805b while selection tool 614 is overlaid over yes control 806a. In some embodiments, instead of tap input 805b, computer system 600 detects a tap input at a location of yes control 806a, a voice command including an utterance identifying yes control 806a, an eye gaze directed at yes control 806a, a depression of am input mechanism while yes control 806a is visually emphasized, and/or an air gesture input directed to yes control 806a.

As illustrated in FIG. 8C, in response to detecting tap input 805b, computer system 600 displays a representation of a computer-generated password in password field 804c and confirm password field 804d. That is, in response to detecting an input corresponding to selection of yes control 806a, computer system 600 generates a password, using the credential management system, for the user account being created for the company C website. As illustrated in FIG. 8C, computer system 600 displays the generated password as a series of 10 dots such that the confidential nature of the computer-generated password is maintained. In some embodiments, computer system 600 does not censor the display of the generated password (e.g., computer system 600 displays the characters (e.g., letters, numbers, and/or symbols) of the password). In some embodiments, computer system 600 does not generate a password in response to detecting an input corresponding to selection of no control 806b at FIG. 8B. In some embodiments, computer system 600 displays a representation of a password within password field 804c and/or confirm password field 804d in response to computer system 600 detecting a user input that corresponds to the selection of one or more alphanumeric characters. For example, computer system 600 displays a representation of a password within password field 804c and/or confirm password field 804d in response to detecting the selection of various alphanumeric characters via a hardware keyboard (e.g., keyboard input device 606) or a software keyboard by a user.

As illustrated in FIG. 8C, as a part of computer system 600 creating the password for the user account of the company C website, computer system 600 displays notification 808. Notification 808 indicates that the credentials associated with the user account being created for the company C website (e.g., the password and/or username) are saved within the credential management system. That is, at FIG. 8C, computer system 600 and/or a computer system external to computer system 600 saves the credentials associated with the user account being created for the company C website to the credential management system as a part of creating the password.

Computer system 600 displays notification 808 in-line with the field(s) in which computer system 600 displays the representation of the password (e.g., password field 804c and confirm password field 804d). In-line refers to computer system 600 displaying notification 808 symmetrically aligned below, above, or to either side of password field 804c or confirm password field 804d. In some embodiments, computer system 600 displays notification 808 in-line with password field 804c and confirm password field 804d because the password for the company C website is the first password that is created by computer system 600 using the credential management system. As discussed in greater detail below, computer system 600 displays notifications similar to notification 808 in a different location upon generating and/or saving credentials for subsequently created user account to the credential management system. In some embodiments, computer system 600 displays notification 808 above and/or to the side of confirm password field 804d. In some embodiments, computer system 600 displays notification 808 inline with password field 804c. In some embodiments, computer system 600 displays notification 808 because the password for the user account for the company C website is the first password that was automatically generated (e.g., by computer system 600 and/or by another computer system external to computer system 600). In some embodiments, computer system 600 displays notification 808 in-line with password field 804c and confirm password field 804d because the credential for the company C website is the first credential that is saved to and/or managed by the credential management system.

As illustrated in FIG. 8C, notification 808 includes open control 808a. In some embodiments, computer system 600 opens the credential management system that the credentials for the company C website are saved to in response to detecting an input that corresponds to selection of open control 808a. As illustrated in FIG. 8C, computer system 600 detects, via touch-sensitive surface 608, tap input 805c while selection tool 614 is overlaid over create account control 804f. In some embodiments, instead of tap input 805c, computer system 600 detects a tap input at a location of create account control 804f, a voice command including an utterance identifying create account control 804f, an eye gaze directed at create account control 804f, a depression of an input mechanism while create account control 804f is visually emphasized, and/or an air gesture input directed at create account control 804F.

As illustrated in FIG. 8D, in response to detecting tap input 805c, computer system 600 displays company C homepage user interface 810. Put a different way, in response to detecting tap input 805c, computer system 600 logs into the company C website using the credentials shown at FIG. 8C. In some embodiments, computer system 600 saves the credentials for the company C website to the credential management system upon using the credentials to login to the company C website. Company C homepage user interface 810 is the homepage of the company C website and includes various controls with which computer system 600 can navigate within the website. As illustrated in FIG. 8D, company C homepage user interface 810 includes “Hi, John!” which indicates that an account registered to John (e.g., the user) is logged into the company C website.

As illustrated in FIG. 8D, as a part of logging into the company C website, computer system 600 displays notification 814 that includes link 814a. Computer system 600 displays notification 814 at FIG. 8D because, at FIG. 8D, computer system 600 logins into a service for the first time using a password that was automatically generated (e.g., by computer system 600 generated or by a computer system different from computer system 600). As will be discussed later, computer system 600 does not display notification 814 when computer system 600 subsequently logs into services using passwords that are automatically generated. At FIG. 8D, computer system 600 detects, via touch-sensitive surface 608, tap input 805d while selection tool 614 is overlaid over link 814a within notification 814. In some embodiments, instead of tap input 805d, computer system 600 detects a tap input at a location of link 814a, a voice command including an utterance identifying link 814a, an eye gaze directed at link 814a, a depression of an input mechanism while link 814a is visually emphasized, and/or an air gesture input directed at link 814a. In some embodiments, computer system 600 displays notification 814 because it is the first time computer system 600 logins to a service using a credential that is managed by the credential managed system.

As illustrated in FIG. 8E, in response to detecting tap input 805d, computer system 600 displays credential manager user interface 616. Credential manager user interface 616 is a user interface of the credential management system. That is, in response to detecting tap input 805d, computer system 600 opens the credential management system. At FIG. 8E, computer system 600 displays credential manager user interface 616 as overlaid over company C homepage user interface 810.

At FIG. 8E, as a part of displaying credential manager user interface 616, computer system 600 displays credential 632d1 (e.g., credential D) as selected. Credential 632d1 is the credential that corresponds to the user account for the company C website. Computer system 600 displays credential 632d1 as selected because credential 632d1 was used to login to the company C website. In some embodiments, computer system 600 displays credential 632d1 as selected because credential 632d1 was the most recently created credential. In some embodiments, computer system 600 displays credential 632d1 as selected because credential 632d1 was the most recently used credential that is managed by the credential management system. In some embodiments, computer system 600 displays credential 632d1 as selected link 814a corresponds to the company C website (e.g., link 814a is displayed as a part of logging into the company C website).

As a part of displaying credential 632d1 as selected, computer system 600 displays credential 632d1 as visually emphasized (e.g., tinted and/or highlighted) to indicate that credential 632d1 is the selected and/or focused credential and computer system 600 displays information relating to credential 632d1 within credentials indicator 640. For example, as illustrated in FIG. 8E, computer system 600 displays the censored form of the password of credential 632d1 (e.g., the password that computer system 600 generated using the credential management system) within credentials indicator 640. Computer system 600 displays credential manager user interface 616 at FIG. 8E to indicate the information that corresponds to the credentials saved for the company C website.

An amount of time elapses between FIGS. 8E and 8F and computer system 600 ceases to display credential manager user interface 616 and computer system 600 displays company D website user interface 816. FIGS. 8F-8M illustrate a process of computer system 600 generating a password that does not adhere to a list of password guidelines of a service and modifying the password such that the password adheres to the guidelines of the service.

As illustrated in FIG. 8F, computer system 600 displays company D website user interface 816 overlaid over home screen user interface 604. Company D website user interface 816 is a webpage of website entitled “test.com” (hereinafter referred to as “the company D website”). company D website user interface 816 includes URL control 830 which indicates the domain “test.com” and create account user interface 818. Create account user interface 818 is a user interface used for the creation of a user account associated with the company D website.

As illustrated in FIG. 8F, create account user interface 818 includes first name field 818a; last name field 818b; e-mail field 818c; password field 818d; confirm password field 818e; password guidelines 818f; create account control 818g; and existing account control 818h. Password guidelines 818f includes requirements that a created password for a user account associated with the company D website must adhere to. Note that password guidelines 818f includes a requirement that passwords for user accounts associated with the company D website cannot include special characters. At FIG. 8F, computer system 600 detects, via touch-sensitive surface 608, tap input 805f while selection tool 614 is overlaid over password field 818d. In some embodiments, instead of tap input 805f, computer system 600 detects a tap input at the location of password field 818d, a voice command including an utterance identifying password field 818d, an eye gaze directed at password field 818d, a depression of an e input mechanism while password field 818d is visually emphasized, and/or an air gesture input directed at password field 818d.

As illustrated in FIG. 8G, in response to detecting tap input 805f, computer system 600 displays notification 820 that includes yes control 820a and no control 820b. Of note, notification 820 is different than notification 806 at FIG. 8B. More specifically, notification 806 includes an indication of the credential management system while notification 820 does not. Computer system 600 displays notification 820 at FIG. 8G and not notification 808 because computer system 600 previously generated a password using the credential management system.

As illustrated in FIG. 8G, in response to detecting tap input 805f, computer system 600 displays a cursor in password field 818d. The cursor indicates that computer system 600 is configured to display and/or enter text within password field 818d that corresponds to a password (e.g., manually typed by the user or generated by computer system 600) for the user account of the company D website. At FIG. 8G, computer system 600 detects, via touch-sensitive surface 608, tap input 805g while selection tool 614 is overlaid over yes control 820a. In some embodiments, instead of tap input 805g, computer system 600 detects a tap input at a location of yes control 820a, a voice command including an utterance that identifies yes control 820a, an eye gaze directed at yes control 820a, a depression of an input mechanism while yes control 820a is visually emphasized, and/or an air gesture input directed at yes control 820a.

At FIG. 8H, in response to detecting tap input 805g, computer system 600 generates a password using the credential management system for the user account being created for the company D website. As illustrated in FIG. 8H, as part of computer system 600 generating the password, computer system 600 displays a representation of the password in password field 818d and confirm password field 818e. At FIG. 8H, computer system 600 (e.g., or another computer system external to computer system 600) saves the credentials for the user account being created for the company D website to the credential management system as a part of computer system 600 creating the password. In some embodiments, another computer system external to computer system 600 generates the password for the user account being created for the company D website.

As illustrated in FIG. 8H, as a part of saving the password to the credential management system, computer system 600 displays notification 822 in the top right corner of display 602. At FIG. 8H, computer system 600 displays notification 822 at a default location for notifications. That is, by default, computer system 600 displays system notifications at the location of notification 822 in FIG. 8H. Computer system 600 does not display notification 822 in-line with password field 818d and confirm password field 818e (e.g., as computer system displayed notification 808 at FIG. 8C) because the password that is generated for the company D website is not the first password that was generated by computer system 600 using the credential management system. In some embodiments, computer system 600 displays notification 822 at a different location of display 602, such as in a corner or on the edge of display 602. As illustrated in FIG. 8H, notification 822 indicates that the generated password is saved (e.g., by computer system 600 and/or by another computer system different from computer system 600) to the credential management system. As illustrated in FIG. 8H, notification 822 includes link 822a to open the credential management system and view the generated password. In some embodiments, computer system 600 displays notification 822 in line with password 818d. In some embodiments, computer system 600 displays notification 808 as a part of saving the credential for the company D website to the credential management system.

At FIG. 8H, a determination is made that the password generated for the user account being created for the company D website does not meet the password requirements of the company D website. Because the determination is made that the password generated for the user account being created for the company D website does not meet the password requirements of the company D website, computer system 600 displays warning 818i, “password doesn't meet requirements” and warning 818j, “no special characters allowed” within create account user interface 818.

Warning 818i and warning 818j indicate that the password that computer system 600 generated does not meet the requirements of password guidelines 818f. Specifically, the password that computer system 600 generated includes special characters in contradiction of password guidelines 818f that state that no special characters are allowed in a password of a user account for the company D website. At FIG. 8H, computer system 600 detects, via touch-sensitive surface 608, tap input 805h while selection tool 614 is overlaid over link 822a within notification 822. In some embodiments, instead of tap input 805h, computer system 600 detects a tap input at a location of link 822a, a voice command that includes at utterance identifying link 822a, an eye gaze directed at link 822a, a depression of an input mechanism while link 822a is visually emphasized, and/or an air gesture input directed at link 822a.

As illustrated in FIG. 8I, in response to detecting tap input 805h, computer system 600 displays credential manager user interface 616 as overlaid on company D website user interface 816. At FIG. 8I, as a part of displaying credential manager user interface 616, computer system 600 ceases to display notification 822 and displays credential 642e1 as selected. Credential 632e1 is the credential that corresponds to the user account for the company D website. Computer system 600 displays credential 632e1 as selected because computer system 600 detected selection of link 822a while the company D website was active. In some embodiments, computer system 600 ceases to display notification 822 after a predetermined amount of time has elapsed since computer system 600 began to display notification 822.

As a part of displaying credential 632e1 as selected, computer system 600 displays credential 632e1 as visually emphasized (e.g., highlighted and/or tinted) to indicate that credential 632e1 is the selected and/or focused credential and computer system 600 displays information relating to credential 632e1 within credentials indicator 640. For example, as illustrated in FIG. 8I, computer system 600 displays the censored form of the password of credential 632e1 (e.g., the password that computer system 600 generated using the credential management system) within credentials indicator 640. At FIG. 8I, computer system 600 detects, via touch-sensitive surface 608, tap input 805i that corresponds to a request to cease the display of credential manager user interface 616. In some embodiments, instead of tap input 805i, computer system 600 detects a tap input at a location outside of the display of manager user interface 616, a voice command including a verbal request to cease the display of credential manager user interface 616, an eye gaze outside of the display of manager user interface 616, and/or an air gesture input directed outside of the display of manager user interface 616.

At FIG. 8J, in response to detecting tap input 805i, computer system 600 ceases to display credential manager user interface 616 as overlaid over company D website user interface 816. At FIG. 8J, computer system 600 detects, via touch-sensitive surface 608, tap input 805j while selection tool 614 is overlaid over password field 818d. In some embodiments, instead of tap input 805j, computer system 600 detects a tap input at a location of password field 818d, a voice command including an utterance that identifying password field 818a, an eye gaze directed at password field 818d, a depression of an input mechanism while password field 818a is visually emphasized, and/or an air gesture input directed at password field 818a.

As illustrated in FIG. 8K, in response to detecting tap input 805j and based on a determination that the password generated for the user account of the company D website is rejected, computer system 600 displays the characters of the generated password for the user account being created for the company D website in password field 818d and confirm password field 818e. More specifically, as illustrated in FIG. 8K, in response to detecting tap input 805j, computer system 600 displays the content of the password that is generated for the user account being created for the company D website instead of a representation of the password that is generated for the user account being created for the company D website. In some embodiments, computer system 600 displays password field 818d and confirm password field 818e with an uncensored representation of the generated password in response to detecting tap input 805j without there being a determination that the password generated for the user account of the company D website is rejected. In some embodiments, computer system 600 displays password field 818d and confirm password field 818e with an uncensored representation of the generated password in response to detecting tap input 805j and based on a determination that computer system 600 censors the display of the generated password at the time computer system 600 detects input 805j.

As illustrated in FIG. 8K, in response to detecting tap input 805j, computer system 600 displays a cursor within password field 818d and notification 824. The display of the cursor within password field 818d indicates that computer system 600 is configured to edit the generated password in response to detecting one or more inputs from the user. Notification 824 indicates that any modifications made to the generated password will be saved to the credential management system and includes control 824a. At FIG. 8K, computer system 600 detects, via touch-sensitive surface 608, tap input 805k while selection tool 614 is overlaid over control 824a. In some embodiments, instead of tap input 805k, computer system 600 detects a tap input at a location of control 824a, a voice command including an utterance identifying control 824a, an eye gaze directed at control 824a, a depression of an input mechanism while control 824a is visually emphasized, and/or an air gesture input directed at control 824a.

As illustrated in FIG. 8L, in response to detecting tap input 805k, computer system 600 displays options list 826 as overlaid on top of create account user interface 818. Options list 826 includes a number of selectable options for modifying the generated password of the user account being created for the company D website. For example, options list 826 includes option 826a, “password easy to type,” option 826b, “password no special characters,” and option 862c, “open password manager app.” In some embodiments, in response to detecting input 805l1 directed to option 826a, computer system 600 modifies the generated password such that the generated password is easier to type. For example, the modified password includes characters on the same side of keyboard input device 606 and/or a password that is shorter in length. In some embodiments, in response to detecting input 80513 directed to option 826c, computer system 600 opens the credential management system and displays the credentials for the company D website. At FIG. 8L, computer system 600 detects, via touch-sensitive surface 608, tap input 805l2 while selection tool 614 is overlaid over option 826b. In some embodiments, instead of tap input 805l2, computer system 600 detects a tap input at a location of option 826b, a voice command including an utterance identifying option 826b, an eye gaze directed at option 826b, a depression of an input mechanism while option 826b is visually emphasized, and/or an air gesture input directed at option 826b.

At FIG. 8M, in response to detecting tap input 805l2, computer system 600 modifies the password for the user account being created for the company D website such that the password does not include special characters and displays the modified password within password field 818d and confirm password field 818e as censored. Specifically, at FIG. 8M, computer system 600 removes the asterisk character (“*”) from the password so that the password adheres to password guidelines 818f. The removal of the special character is indicated in FIG. 8M by computer system 600 displaying the password as eight dots (e.g., indicative of eight numbers/letters of the password) within password field 818d and confirm password field 818e as opposed to computer system 600 displaying the password as nine dots at FIGS. 8H and 8J.

At FIG. 8M, computer system 600 saves the modified password in association with the domain “test.com” to the credential management system. As illustrated in FIG. 8M, as a part of saving the modified password, computer system 600 displays notification 822. Notification 822 indicates that computer system 600 saved the modified password to the credential management system.

An amount of time elapses between FIGS. 8M and 8N and computer system 600 ceases to display company D website user interface 816 and computer system 600 begins to display company E website user interface 834, company C homepage user interface 810, and company D login user interface 864. FIGS. 8N-8R illustrate a process of computer system 600 logging into a website (e.g., using an autofill feature) using credentials that are not associated with the domain of the website. More specifically, at FIGS. 8N-8R, computer system 600 uses the credentials registered to the test.com domain to login to a services.test.com domain.

FIG. 8N illustrates computer system 600 displaying three open windows via display 602. The window that computer system 600 displays as furthest back (e.g., least recently opened) is company E website user interface 834. Company E website user interface 834 is the homepage of localhost.com (e.g., hereinafter referred to as “the company E website”). The second window that computer system 600 displays is company C homepage user interface 810, which is the homepage of the company C website. Computer system 600 displays company D login user interface 864 overlaid over company E website user interface 834 and company C homepage user interface 810, which indicates that company D login user interface 864 is the window that computer system 600 most recently opened. Company D login user interface 864 is a user interface that is displayed immediately prior to computer system 600 gaining access to restricted functionality of the company D website.

Company D login user interface 864 includes login user interface 832 and URL control 830. Note that the URL that computer system 600 displays in URL control 830 is a different domain than the domain computer system 600 displays in association with company D website user interface 816 at FIGS. 8F-8M. More specifically, in FIGS. 8F-8M, computer system 600 displays the domain as “test.com” and at FIG. 8N, computer system 600 displays the domain as “services.test.com.” At FIG. 8N, while company D login user interface 864 is a part of the company D website, “services.test.com” is a different section of the company D website than previously displayed. Specifically, the URL as displayed in FIG. 8N corresponds to a section of the company D website that corresponds to a services directory of the company D website, which will be discussed further below.

Company D login user interface 864 includes login user interface 832, which is a user interface in which computer system 600 displays and/or enters credential information for company D website. Login user interface 832 is the user interface used for logging into the company D website. As illustrated in FIG. 8N, login user interface 832 includes e-mail field 832a, password field 832b, control 824a and sign in control 832c. At FIG. 8N, computer system 600 detects, via touch-sensitive surface 608, tap input 805n while selection tool 614 is overlaid over control 824a. In some embodiments, instead of tap input 805n, computer system 600 detects a tap input at a location of control 824a, a voice command including an utterance identifying control 824a, an eye gaze directed at control 824a, an of an e input mechanism while control 824a is visually emphasized, and/or an air gesture input directed at control 824a.

As illustrated in FIG. 8O, in response to detecting tap input 805n, computer system 600 displays credentials 832d-g in a list below password field 832b. Each of credentials 832d-g is a respective credential that is saved to and/or managed by the credential management system. For each of credentials 832d-g, computer system 600 displays an email and a representation of the website that corresponds to the respective credential. For example, with respect to credential 832d, computer system 600 displays “johnnya@invalid.com” from test.com. That is, credential 832d corresponds to the credential that was created at FIG. 8M that corresponds to the “test.com” domain.

Computer system 600 displays a list of credentials below password field 832b to encourage efficiency of logging into a service and as part of an autofill functionality of computer system 600. For example, in response to detecting an input of one of credentials 832d-g, computer system 600 automatically fills e-mail field 832a and password field 832b with the credentials (e.g., e-mail and password) of the selected credential. At FIG. 8O, computer system 600 detects, via touch-sensitive surface 608, tap input 8050 while selection tool 614 is overlaid over credential 832d. In some embodiments, instead of tap input 8050, computer system 600 detects a tap input at a location of credential 832d, a voice command including an utterance identifying credential 832d, an eye gaze directed at credential 832d, a depression of an input mechanism while credential 832d is visually emphasized, and/or an air gesture input directed at credential 832d.

At FIG. 8P, a determination is made that credential 832d does not correspond to the domain that is associated with company D login user interface 864. More specifically, as explained above, credential 832a is associated with the test.com domain while company D login user interface 864 corresponds to the domain of “services.test.com.” As illustrated in FIG. 8P, in response to detecting tap input 8050 and because the determination is made that credential 832d does not correspond to the domain that is associated company D login user interface 864, computer system 600 displays notification 836. Computer system 600 displays notification 836 because the selected credential (e.g., credential 832d) is registered with a different domain than the domain of company D login user interface 864. The display of notification 836 is a way of alerting the user that the selected credentials may be incorrect in an attempt to prevent the user from phishing themselves.

As illustrated in FIG. 8P, notification 836 includes option 836a, option 836b, option 836c, and option 836d. Each of option 836a, option 836b, option 836c, and option 836d are various options for how to use credential 832d with respect to the services.test.com domain. In some embodiments, in response to detecting input 805p1 while selection tool 614 is overlaid over option 836a, “use password once” computer system 600 fills e-mail field 832a and password field 832b with the credentials associated with credential 832d and does not register and/or save credential 832d in association with the services.test.com domain. In some embodiments, in response to detecting input 805p3 while selection tool 614 is overlaid over option 836c, “stop using password,” computer system 600 does not use credential 832d to access the restricted functionalities of the services.test.com domain. In some embodiments, in response to detecting input 805p4 while selection tool 614 is overlaid over option 836d, “close,” computer system 600 ceases to display notification 836. At FIG. 8P, computer system 600 detects, via touch-sensitive surface 608, tap input 805p2 while selection tool 614 is overlaid over option 836b, “use and update website.” In some embodiments, instead of tap input 805p1, computer system 600 detects a tap input at a location of option 836b, a voice command including an utterance identifying option 836b, an eye gaze directed at option 836b, a depression of an input mechanism while option 836b is visually emphasized, and/or an air gesture input directed at option 836b.

As illustrated in FIG. 8Q, in response to detecting tap input 805p2, computer system 600 displays the e-mail associated with credential 832d within e-mail field 832a and computer system 600 displays a representation of the password associated with credential 832d within password field 832b. Because option 836b “use and update website” is selected, computer system 600 registers and/or associates credential 832d with the services.test.com domain in the credential management system. At FIG. 8Q, computer system 600 detects, via touch-sensitive surface 608, tap input 805q while selection tool 614 is overlaid over sign in control 832c. In some embodiments, instead of tap input 805q, computer system 600 detects a tap input at a location of sign in control 832c, a voice command including an utterance identifying sign in control 832c, an eye gaze directed at sign in control 832c, a depression of an input mechanism while sign in control 832c is visually emphasized, and/or an air gesture input directed at sign in control 832c.

As illustrated in FIG. 8R, in response to detecting tap input 805q, computer system 600 displays company D homepage user interface 838, with which the user can search the services directory for test.com. That is, at FIG. 8R, in response to detecting tap input 805q, computer system 600 logins to the services.test.com domain using credential 832d. At FIG. 8R, computer system 600 detects, via touch-sensitive surface 608, tap input 805r while selection tool 614 is overlaid over credential management control 610b within menu 610 in the top right corner of display 602. In some embodiments, instead of tap input 805r, computer system 600 detects a tap input at a location of credential management control 610b, a voice command including an utterance identifying credential management control 610b, an eye gaze directed at credential management control 610b, a depression of an input mechanism while credential management control 610b is visually emphasized, and/or an air gesture input directed at management control 610b.

FIGS. 8S-8U illustrate a process of computer system 600 displaying a menu of credentials based on a context of computer system 600. Upon selection of a credential in the menu, computer system 600 displays the details of the selected credential.

As illustrated in FIG. 8S, in response to detecting tap input 805r, computer system 600 displays menu 840 below the right side of menu 610. Menu 840 includes indicator 840a, which indicates the title of menu 840; add control 840b, for adding a credential to the credential management system; window control 840c, for causing computer system 600 to launch the credential management system; search control 840d, for searching among various credentials that are managed by the credential management system; and credentials 840e-i. Credentials 840e-i are representative of various credentials (e.g., username, e-mail, password) for different companies, websites, and/or applications. At FIG. 8S, computer system 600 displays credentials 840e-g in menu 840 based on a recency of a previous interaction with a website, a recency of an initial display of websites, and/or which websites are active and/or were active on computer system 600. In some embodiments, in response to detecting input 805s2 directed to add control 840b, computer system 600 initiates a process of adding and/or creating a new credential to the credential management system. In some embodiments, in response to detecting input 805s3 directed to window control 840c, computer system 600 launches the credential management system.

At FIG. 8S, computer system 600 displays company C homepage user interface 810 overlaid over company E website user interface 834 but behind company D homepage user interface 838, which indicates that computer system 600 activated/opened company C homepage user interface 810 after company E website user interface 834 but before company D homepage user interface 838. This order of recency of a previous interaction with a website, a recency of any initial display of a website, and/or which websites are active is reflected within menu 840. More specifically, as illustrated in FIG. 8S, computer system 600 displays credential 840e (e.g., credential E), that corresponds to company D homepage user interface 838 as the first credential in the list because computer system 600 most recently opened company D homepage user interface 838. Computer system 600 displays credential 840f (e.g., credential D), that corresponds to company C homepage user interface 810, as the second credential in the list because computer system 600 opened company C homepage user interface 810 before company E website user interface 834 but after company D homepage user interface 838. Computer system 600 displays credential 840g (e.g., credential A), that corresponds to company E website user interface 834, as the third credential in the list because computer system 600 opened company E website user interface 834 before company C homepage user interface 810. The order of credentials 840e-g indicates the recency in which computer system 600 launched, previously interacted with, and/or displayed the websites for each respective credential. In some embodiments, the order of credentials 840e-i indicates the recency in which applications are opened (e.g., launched and/or activated) by computer system 600. In some embodiments, the order of credentials 840e-i indicates a recency in which credentials 840e-g were created. In some embodiments, the order of credentials 840e-i indicates a recency in which credential 840e-g were last used.

At FIG. 8S, a determination is made that selection tool 614 is positioned over credential 840e. As illustrated in FIG. 8S, because the determination is made that selection tool 614 is positioned over credential 840e, computer system 600 visually emphasizes credential 840e and displays a selection indicator to the right of credential 840e. At FIG. 8S, computer system 600 detects, via touch-sensitive surface 608, tap input 805s1 while selection tool 614 is overlaid over credential 840e. In some embodiments, instead of tap input 805s1, computer system 600 detects a tap input at a location of credential 840e, a voice command including an utterance identifying credential 840e, an eye gaze directed at credential 840e, a depression of an input mechanism while credential 840e is visually emphasized, and/or an air gesture input directed at credential 840e. In some embodiments, input 805s is directed to the representation of the e-mail address (e.g., Johnap@invalid.com) included in credential 840e.

As illustrated in FIG. 8T, in response to detecting tap input 805s1, computer system 600 displays detailed view 842 in place of menu 840. Detailed view 842 includes credential indicator 842a, which indicates the name of the selected credential; username 842b which indicates the username associated with credential 840e; password 842c which includes a representation of the password for credential 840e; website 842d which includes a representation of the website that corresponds to credential 840e; group 842e which indicates a group (e.g., if any) that credential 840e belongs to; and security indicator 842f which indicates a status of the security of credential 840e. At FIG. 8T, computer system 600 detects, via touch-sensitive surface 608, tap input 805t2 while selection tool 614 is overlaid over password 842c. In some embodiments, instead of tap input 805t2, computer system 600 detects a tap input at a location of password 842c, a voice command including an utterance identifying 842c, an eye gaze directed at password 842c, a depression of an input mechanism while password 842 is visually emphasized, and/or an air gesture input directed at password 842c. In some embodiments, credential 840e includes a representation of a password of credential 840e. In some embodiments, computer system 600 displays detailed view 642 in response to detecting an input corresponding to the representation of the password of credential 840e.

As illustrated in FIG. 8U, in response to detecting tap input 805t2, computer system 600 displays notification 844, which indicates that computer system 600 has copied the password associated with credential 840e. In some embodiments, in response to detecting input 805t1 (e.g., as shown at FIG. 8T) while selection tool 614 is overlaid over username 842b, computer system 600 copies the username of credential 840e. In some embodiments, in response to detecting tap input 805t2 (e.g., as shown in FIG. 8T) directed to password 842c, computer system 600 displays an option to copy the password of credential 840e. In some embodiments, in response to detecting input 805t1 (e.g., as shown in FIG. 8T) while selection tool 614 is overlaid over username 842b, computer system 600 displays an option to copy the username of credential 840e.

An amount of time elapses between FIGS. 8U and 8V and computer system 600 ceases to display company C homepage user interface 810 company E website user interface 834, and company D homepage user interface 838 and displays company F create account user interface 846. FIGS. 8V-8Z illustrate a process of computer system 600 saving a credential in a deleted section of the credential management system when a password is generated but not registered with a website.

As illustrated in FIG. 8V, computer system 600 displays company F create account user interface 846. Company F create account user interface 846 is a webpage that corresponds to a apple.com domain (e.g., hereinafter referred to as “the company F website”). Computer system 600 displays company F create account user interface 846 as a part of creating a user account for the company F website.

As illustrated in FIG. 8V, company F create account user interface 846 includes name field 846a; e-mail field 846b; phone number field 846c; username field 846d; password field 846e; confirm password field 846f; and create account control 846g. At FIG. 8V, computer system 600 displays name field 846a, e-mail field 846b, phone number field 846c, and username field 846d with text corresponding to each respective field. At FIG. 8V, computer system 600 detects, via touch-sensitive surface 608, tap input 805v while selection tool 614 is overlaid over password field 846e. In some embodiments, instead of tap input 805v, computer system 600 detects a tap input at a location of password field 846e, a voice command including an utterance identifying password field 846e, an eye gaze directed at password field 846e, a depression of an input mechanism while password field 846e is visually emphasized, and/or an air gesture input directed at password field 846e.

As illustrated in FIG. 8W, in response to detecting tap input 805v, computer system 600 displays a cursor in password field 846e and displays notification 820 that includes yes control 820a and no control 820b. At FIG. 8W, computer system 600 detects, via touch-sensitive surface 608, tap input 805w while selection tool 614 is overlaid over yes control 848a. In some embodiments, instead of tap input 805w, computer system 600 detects a tap input at a location of yes control 848a, a voice command including an utterance identifying yes control 848a, an eye gaze directed at yes control 848a, a rotation of an input mechanism while yes control 848a is visually emphasized, and/or an air gesture input directed at yes control 848a.

At FIG. 8X, in response to detecting tap input 805w, computer system 600 generates a password for the user account being created for the company F website and computer system 600 displays a representation of the generated password within password field 846e and confirm password field 846f. As a part of generating the password, computer system 600 displays notification 850 in the top right corner of display 602, which indicates that computer system 600 saved the credentials (e.g., the generated password and user name) for the user account being created to the company F website to the credential management system. At FIG. 8X, computer system 600 detects, via touch-sensitive surface 608, tap input 805x while selection tool 614 is overlaid over a control to cease the display of company F create account user interface 846. In some embodiments, instead of tap input 805x, computer system 600 detects a tap input at a location of the control, a voice command including an utterance identifying the control, an eye gaze directed at the control, a depression of an input mechanism while the control is visually emphasized, and/or an air gesture input directed at the control.

At FIG. 8Y, in response to detecting tap input 805x, computer system 600 ceases to display company F create account user interface 846. That is, computer system 600 ceases to display company F create account user interface 846 before the user account setup process for the company F website is complete. Accordingly, even though the credentials for the company F website were saved to the credential management system, said credentials were not registered and/or associated with the company F website.

At a time between FIG. 8X and FIG. 8Y, computer system 600 detects a series of one or more inputs that corresponds to the opening of the credential management system. As illustrated in FIG. 8Y, in response to detecting the series of one or more inputs that corresponds to the opening of the credential management system, computer system 600 displays credential manager user interface 616. At FIG. 8Y, computer system 600 detects, via touch-sensitive surface 608, tap input 805y while selection tool 614 is overlaid over deleted tab 624f. In some embodiments, instead of tap input 805y, computer system 600 detects a tap input at a location of deleted tab 624f, a voice command including an utterance identifying deleted tab 624f, an eye gaze directed at a location of deleted tab 624f, a depression of an input mechanism while deleted tab 624 is visually emphasized, and/or an air gesture input directed at deleted tab 624.

As illustrated in FIG. 8Z, in response to detecting tap input 805y, computer system 600 displays deleted tab 624f as selected (e.g., computer system 600 visually emphasizes deleted tab 624f) and displays deleted credentials user interface 868. Deleted credentials user interface 868 includes tab indicator 852 and list 854. Tab indicator 852 indicates a number of credentials that have been deleted and/or credentials that are not associated with a service (e.g., website, application, and/or user account) that are managed by the credential managed system. List 854 includes a representation of various credentials that have been deleted and/or were not saved in association with a service. In FIG. 8Z, computer system 600 displays the credentials of list 854 as grouped under the title “my passwords.” That is, the representation of the various credentials included in list 854 are grouped based on which group they were shared from, if any.

Note that in FIG. 8Z, computer system 600 displays credential 854a (e.g., the credential associated with the company F website) within list 854. Credential 854a corresponds to the credential of the user account that was being created for the company F website created at FIG. 8X. Credential 854a is displayed within list 854 because, though the password of credential 854a was created and saved to the credential management system, credential 854a was never associated and/or registered with a service because computer system 600 did not complete the process of creating the user account for the company F website at FIG. 8X. As illustrated in FIG. 8Z, computer system 600 displays credential 854a at the top of list 854. Computer system 600 displays credential 854a at the top of list 854 because credential 854a is the most recently added credential to list 854. That is, computer system 600 orders list 854 in a temporal order where the most recently added credential is displayed at the top of list 854. In some embodiments, credentials that are generated (e.g., manually generated and/or generated by a computer system) but not selected to be managed by the credential management system are included within list 854. In some embodiments, credentials that are generated (e.g., manually generated and/or generated by a computer system) and registered with a domain but the domain is unable to be identified by the computer system 600 are included in list 854. In some embodiments, portions of credentials (e.g., a password and/or a username) whose domain computer system 600 is unable to identify are included in list 854.

At FIG. 8Z, computer system 600 displays indicator 856 with details regarding credential 854a. Indicator 856 includes credential indicator 856a, delete control 856b, and recover control 856c. Credential indicator 856a which indicates the name of the service that corresponds to credential indicator 856a and indicator 856d which indicates the last time credential 854a was modified at modified (e.g., at 1:46 PM today). Below indicator 856, computer system 600 displays indicator 858, which indicates that credential 856a will be deleted (e.g., permanently deleted) from the credential management system in seven days if no action is taken with respect to credential 856a. Delete control 856b is an option to permanently delete data associated with credential 854a from the credential management system. Recover control 856c is selectable option to recover data that corresponds to credential 854a. In some embodiments, in response to detecting an input directed to delete control 856b, computer system 600 deletes the record of the unsaved credential. In some embodiments, in response to detecting an input directed to recover control 856c, computer system 600 recovers the details of the unsaved credential in order to complete the process of saving a credential in association with a service.

FIG. 9 is a flow diagram illustrating a method (e.g., method 900) for displaying notifications regarding the saving of credentials in accordance with some embodiments. Some operations in method 900 are, optionally, combined, the orders of some operations are, optionally, changed, and some operations are, optionally, omitted.

As described below, method 900 provides an intuitive way for displaying notifications regarding the saving of credentials. Method 900 reduces the cognitive burden on a user, thereby creating a more efficient human-machine interface. For battery-operated computing devices, enabling a user to interact with such devices faster and more efficiently conserves power and increases the time between battery charges.

In some embodiments, method 900 is performed at a computer system (e.g., 600) (e.g., a watch, a phone, a tablet, a fitness tracking device, a processor, a head-mounted display (HMD) device, a communal device, a media device, a speaker, a television, and/or a personal computing device) that is in communication with (e.g., wireless communication and/or wired communication) one or more display generation components (e.g., 602) (e.g., a display screen, a projector, a head mounted display, and/or a touch-sensitive display) and one or more input devices (e.g., 608 and/or 606) (e.g., a physical input mechanism, a hardware input mechanism, a camera, a touch-sensitive surface, a microphone, a camera, a depth sensor, an accelerometer, a temperature sensor, and/or a heart monitor). In some embodiments, the computer system includes the one or more display generation components and/or the one or more input devices. In some embodiments, the physical input mechanism is a hardware input mechanism, a rotatable input mechanism, a crown, a knob, a dial, a physical slider, and/or a hardware button.

While displaying a credential user interface (e.g., 804, 812, 816, 818, 832 and/or 864) for a service (e.g., a registration user interface, a login user interface, a one-time password user interface, a password user interface, and/or a user interface configured to receive a credential), the computer system detects (902), via the one or more input devices (e.g., 608 and/or 606), an input (e.g., 805b, 805c, 805f, 805g, 805j, 805q, 805l1, and/or 805l2) corresponding to a request to perform a respective operation (e.g., store for future use, create, manage, use, and/or upload) associated with a credential (e.g., 632e1, 832d, 840e, 840f, 840g, 840h, and/or 840i) for the service (e.g., for a login, account setup, and/or that is being used to access the credential user interface for the service). In some embodiments, the credential is displayed as a set of one or more symbols while the credential is displayed within the credential user interface for the service. In some embodiments, the credential includes a user name, a password, a token, a passkey, a single-sign-on credential, a user biometric, a digital certificate, a login-specific credential, and/or a federated credential. In some embodiments, the input corresponding to the request to perform the respective operation corresponds to a request to save a new credential (e.g., for a login and/or that is being used for the credential entry user for the service). In some embodiments, the input corresponding to the request to perform the respective operation is a tap input at a location of a user interface object for logging into a service, a website, and/or an application, a gaze input at a user interface object for generating a user name and/or password for a user account, a pinch gesture while a user interface object for generating a user name and/or a password for a user account is visually emphasized, a tap input at a location of a user interface object for generating a user name and/or password for a user account, and/or selection of an enter button on a hardware keyboard and/or a virtual keyboard.

In response to detecting the input (e.g., 805b, 805c, 805f, 805g, 805j, 805l1, and/or 805l2) corresponding to the request to perform the respective operation associated with the credential (e.g., 632e1, 632d1, 832d, 840e, 840f, 840g, 840h, and/or 840i) for the service, the computer system displays (904), via the one or more display generation components (e.g., 602), a notification (e.g., 828, 822, and/or 808) (e.g., a banner, a platter, and/or a notification that is in line with the credential user interface object or is displayed separately from the credential user interface) that indicates that the credential (e.g., 632e1, 632d1, 832d, 840e, 840f, 840g, 840h, and/or 840i) has been saved in a credential management system (e.g., 612a) that is separate from the service for which the credential was created, wherein the notification (e.g., 828, 822, and/or 808) includes an option (e.g., 822a) (e.g., a user interface element, a user interface object, a control, a link, a textual user interface object, and/or graphical user interface object that corresponds to a credential management application that is installed on the computer system) to view the credential within a credential management user interface (e.g., 816) for the credential management system that is separate from the service for which the credential was created (e.g., as described above with respect to method 700). In some embodiments, the request to perform the respective operation associated with the credential for the service is a request to access restricted content (e.g., log into a service). In some embodiments, the computer system displays a new user interface in response to detecting the input corresponding to the request to perform the respective operation associated with the credential for the service. In some embodiments, in response to detecting selection of the option, the computer system displays the credential management user interface as overlaid on top of the credential user interface for the service. In some embodiments, the input corresponding to the request to perform the respective operation associated with the credential for the service corresponds to a selection of a user interface object. In some embodiments, the notification is displayed while the credential user interface for the service is displayed. In some embodiments, the computer system ceases to display the credential user interface for the service in response to detecting an input that corresponds to selection of the option. In some embodiments, the computer system ceases to display the notification in response to detecting an input that corresponds to selection of the notification. In some embodiments, the option is to view the credential within credential management software. In some embodiments, the credential is saved prior to the credential being provided to the service (e.g., the credential is saved prior to the credential being used to login to the service or an account is created with the service), after the credential is provided to the service (e.g., when the credential is saved after the credential is used to login to the service) and/or the credential is saved in conjunction with providing the credential to the service (e.g., the credential is saved when the credential is used to login to the service). Displaying a notification that indicates that a credential has been saved in a credential management system and that includes an option to view the credential within the credential management system in response to detecting an input that corresponds to a request to perform a respective operations allows the computer system to alert a user that the credential is registered with a respective service for future use and is managed by the credential management system, thereby providing improved visual feedback and/or reducing the number of inputs needed to perform an operation (e.g., access the credential management system).

In some embodiments, before (e.g., or in conjunction with detecting) detecting, via the one or more input devices (e.g., 608 and/or 606), the input (e.g., 805b, 805c, 805f, 805g, 805j, 805l1, and/or 805l2) corresponding to the request to perform the respective operation associated with the credential (e.g., 632e1, 632d1, 832d, 840e, 840f, 840g, 840h, and/or 840i) for the service, the computer system detects, via the one or more input devices, one or more inputs corresponding to (e.g., directed to, at a location of, related to, and/or associated with) a selection of one or more alphanumeric characters (e.g., digital representations of alphanumeric characters and/or keys on a keyboard) by a user, wherein the credential includes the one or more alphanumeric characters (e.g. as described above in relation to FIG. 8C) (e.g., the computer system and/or a respective computer system external to the computer system generates the credential based on the selection of the one or more alphanumeric characters). In some embodiments, the credential consistent of the one or more alphanumeric characters. In some embodiments, the one or more inputs corresponding to the selection of the one or more alphanumeric characters also includes a selection of one or more symbols. In some embodiments, the one or more inputs corresponding to the selection of the one or more alphanumeric characters by the user is one or more keyboard inputs that are detected via a hardware keyboard and/or software keyboard, a voice command that includes utterances that identifies the one or more alphanumeric characters, and/or one or more trackpad and/or mouse press inputs while a cursor or other focus selector is a various locations of various alphanumeric characters.

In some embodiments, the input (e.g., 805b, 805g, 805l1, and/or 805l2) corresponding to the request to perform the respective operation associated with the credential (e.g., 632e1, 632d1, 832d, 840e, 840f, 840g, 840h, and/or 840i) for the service is a request for the credential to be generated (e.g., selected, formed and/or created). In some embodiments, the credential is automatically (e.g., without detecting intervening user input) generated in response to detecting the input corresponding to the request to perform the respective operation associated with the credential for the service. In some embodiments, the credential is generated by the computer system or a respective computer system external to the computer system. In some embodiments, in response to detecting the input corresponding to the request to perform the respective operation associated with the credential for the service (e.g., and without detecting any intervening user inputs), the computer system displays, via the one or more display generation components (e.g., 602), a representation of the credential (e.g., 804c, 818d, 818e, and/or 832b). In some embodiments, in response to detecting the input corresponding to the request to perform the respective operation associated with the credential for the service the credential is generated (e.g., saved and/or formed) by the computer system or by a respective computer system external to the computer system. In some embodiments, generating the credential includes generating a user name and/or password of the credential. In some embodiments, the computer system generates the credential based on one or more requirements (e.g., length, complexity, and/or type) of the service. Displaying a representation of a credential in response to detecting an input allows the computer system to create a credential that is difficult to guess and/or recreate without requiring input with respect to the creation of the credential from the user, thereby reducing the number of inputs needed to perform an operation (e.g., create a credential).

In some embodiments, in response to (and/or after) detecting the input (e.g., 805b, 805c, 805f, 805g, 805j, 805l1, and/or 805l2) corresponding to the request to perform the respective operation associated with the credential (e.g., 632e1, 632d1, 832d, 840e, 840f, 840g, 840h, and/or 840i) for the service, the computer system forgoes display of, via the one or more display generation components (e.g., 602), the credential within the credential user interface (e.g., 804, 812, 816, 818, 832 and/or 864) (e.g., as discussed above at FIG. 8C). In some embodiments, the computer system displays, via the one or more display generation components, a representation of the credential in response to detecting the input corresponding to the request to perform the respective operation associated with the credential for the service. In some embodiments, the representation of the credential is a series of common shapes (e.g., circles, triangles, or squares). In some embodiments, in response to detecting the input corresponding to the request to perform the respective operation associated with the credential for the service, the computer system displays the credential outside of the credential user interface. Forgoing display of a credential within a user interface in response to detecting an input corresponding to a request to perform an operation associated with the credential allows the computer system to avoid revealing confidential and/or sensitive information, thereby providing improved feedback and/or performing an operation when a set of conditions has been met without requiring further user input.

In some embodiments, the representation of the credential is a first representation of the credential (e.g., 804c, 818d, 818e, and/or 832b). In some embodiments, after displaying the first representation of the credential, the computer system detects, via the one or more input devices (e.g., 608 and/or 606), a set of one or more inputs (e.g., 605a, 605b, and/or 805y). In some embodiments, the set of one or more inputs includes a tap input at a location of an icon of a credential management application, a trackpad and/or mouse press input while a cursor or other focus selector is at a location of the icon of the credential management icon, a pinch gesture while a gaze of the user is directed at a credential, a pinch gesture while the a credential is visually emphasized, a pinch gesture while the icon for the credential management application is visually emphasized, and/or a voice command that includes an utterance that identifies the credential management application and/or a credential. In some embodiments, in response to detecting the set of one or more inputs, the computer system displays, via the one or more display generation components (e.g., 602), a user interface (e.g., 868) for a section (e.g., 624f) (e.g., a recently deleted section, a recently accessed section, and/or a temporary section) of the credential management system (e.g., 612a), wherein in accordance with a determination that the credential (e.g., 632e1, 632d1, 832d, 840e, 840f, 840g, 840h, and/or 840i) is not saved in association with a domain (e.g., any domain, the credential is not linked to a domain and/or the credential does not correspond to a domain), the user interface for the section of the credential management system includes a second representation of the credential (e.g., 854a) and in accordance with a determination that the credential is saved in association with a domain (e.g., the credential is linked to the domain and/or the credential corresponds to the domain), the user interface for the section of the credential management system does not include the second representation (e.g., or any representation of the credential). In some embodiments, the computer system does not save the credential in association with the domain (e.g., or any domain) when the computer system does not complete a signup process of the service after the first representation of the credential is displayed and/or has been created. In some embodiments, the computer system moves the credential from the section to a respective section different from the section after the credential is saved in association to a domain. In some embodiments, the computer system moves the credential from the respective section different from the section to the section in accordance with a determination that the credential is disassociated from the domain. Including a representation of a credential within a section of a credential management system when a set of prescribed conditions is met allows the computer system to indicate whether the credential is linked and/or registered with any domain and reduce the chances that passwords are lost, thereby performing an operation when a set of conditions has been met without requiring further user input.

In some embodiments, the request to perform the respective operation associated with the credential for the service (e.g., 632e1, 632d1, 832d, 840e, 840f, 840g, 840h, and/or 840i) is a request to create (e.g., generate, forming, and/or selecting) the credential (e.g., 805b and/or 805g). In some embodiments, in response to detecting the input corresponding to the request to perform the respective operation associated with the credential for the service and while displaying the notification (e.g., 828, 822, and/or 808) that indicates that the credential has been saved in a credential management system, the computer system displays, via the one or more display generation components (e.g., 602), a representation of the credential (e.g., 804c, 818d, 818e, and/or 832b) (e.g., the computer system creates and/or stores the credential). In some embodiments, saving the credential includes associating the credential with the service. In some embodiments, creating the credential and saving the credential happen concurrently. In some embodiments, creating the credential and saving the credential happen serially. In some embodiments, the computer system creates and/or stores the credential in response to detecting the request to perform the respective operation associated with the credential for the service. Displaying a representation of a credential while displaying a notification that includes an indication that the credential is saved in response to detecting the request to perform the respective operation associated with the credential for the service allows the computer system to confirm to the user that the request was detected and fulfilled, thereby providing improved visual feedback and/or performing an operation when a set of conditions has been met without requiring further user input.

In some embodiments, the request to perform the respective operation associated with the credential for the service is a request to access restricted functionality (e.g., 805c) (e.g., login into the service, website and/or application) of the service. In some embodiments, in response to detecting the input corresponding to the request to perform the respective operation associated with the credential for the service (e.g., and in accordance with a determination that the request is accepted) and while displaying the notification (e.g., 828, 822, and/or 808) that indicates that the credential has been saved in a credential management system, the computer system displays, via the one or more display generation components (e.g., 602), content (e.g. 810) (e.g., text and/or images) corresponding to (e.g., directed to, at a location of, related to, and/or associated with) the restricted functionality of the service (e.g., as discussed above at FIG. 8D) (e.g., accessing the restricted functionality and/or logging into an application, website, and/or the service). In some embodiments, saving the credential includes associating the credential with the service. In some embodiments, displaying the content related to the restricted functionality and saving the credential happen concurrently. In some embodiments, displaying the content related to the restricted functionality and saving the credential happen serially. Displaying content corresponding to restricted functionality of a service and displaying a notification that includes an indication that a credential is saved in response to detecting a request to perform a respective operation associated with the credential for the service allows the computer system to confirm to the user that the request was detected and fulfilled, thereby providing improved visual feedback and/or performing an operation when a set of conditions has been met without requiring further user input.

In some embodiments, the credential user interface (e.g., 804, 812, 816, 818, 832 and/or 864) includes a text entry field (e.g., 804c, 804d, and/or 818d) (e.g., a password field, authentication code field, a passkey field, and/or a user name field). In some embodiments, in response to detecting the input (e.g., 805b, 805c, 805f, 805g, 805j, 805l1, and/or 805l2) corresponding to the request to perform the respective operation associated with the credential for the service (e.g., 632e1, 632d1, 832d, 840e, 840f, 840g, 840h, and/or 840i), the computer system displays, via the one or more display generation components (e.g., 602), a representation (e.g., a textual representation and/or a graphical representation) of the credential for the service within the text entry field (e.g., 818d, 818e, and/or 804c) (e.g., a password field, authentication code field, a passkey field, and/or a user name field) of the credential user interface (e.g., the text entry field is a part of and/or included within the credential user interface), wherein the notification (e.g., 828, 822, and/or 808) that indicates that the credential has been saved in the credential management system (e.g., 612a) is displayed concurrently with the text entry field. In some embodiments, the notification is displayed above, below or to the side of the text entry field. In some embodiments, the computer system displays the credential for the service within the text entry field in response to detecting the input corresponding to the request to perform the respective operation associated with the credential for the service. In some embodiments, the representation of the credential for the service includes one or more symbols (e.g., the same type of symbol or a different types of symbols). In some embodiments, the notification is not displayed concurrently with \and/or inline with the text entry field. In some embodiments, the computer system ceases to display the representation of the credential for the service within the text entry in response to detecting a set of one or more inputs. In some embodiments, the computer system ceases to display the notification concurrently with and/or inline with the text entry field after a predetermined period of time has elapsed. Displaying a notification that indicates that a credential has been saved in a credential management system in line with a text entry field that contains a representation of the credentials allows the computer system to display the notification at a location such that the probability that a user views the notification is increased, thereby providing improved visual feedback and/or performing an operation when a set of conditions has been met without requiring further user input.

In some embodiments, the notification (e.g., 828, 822, and/or 808) is displayed at a default location (e.g., a default location of the credential user interface and/or a default location of a desktop user interface of the computer system) for computer system notifications (e.g., as discussed above at FIG. 8H) (e.g., of the computer system). In some embodiments, the default location is chosen by a user. In some embodiments, the computer system moves a different notification from the default location as a part of displaying the notification that indicates that the credential has been saved in the credential management system at the default location. In some embodiments, the computer system ceases to display a different notification as part of displaying the notification that indicates that the credential has been saved in the credential management system at the default location. In some embodiments, the computer system ceases to display the notification at the default location after a predetermined period of time has elapsed. In some embodiments, the computer system displays the notification that the credential has been saved in the credential management system in the default location in accordance with a determination that the computer system has previously displayed a notification that a particular credential has been saved with the credential management system. Displaying a notification that indicates that a credential has been saved in a credential management system at a default location for computer system notifications allows the computer system to display the notification at a location where the user is accustomed to viewing notifications, thus increasing the probability that the user views the notification, thereby providing improved visual feedback and/or performing an operation when a set of conditions has been met without requiring further user input.

In some embodiments, in response to detecting the input (e.g., 805b, 805c, 805f, 805g, 805j, 805l1, and/or 805l2) corresponding to the request to perform the respective operation associated with the credential for the service (e.g., 632e1, 632d1, 832d, 840e, 840f, 840g, 840h, and/or 840i), the computer system displays, via the one or more display generation components (e.g., 602), a representation of the credential in a text entry field (e.g., 804c, 804d, 818d, and/or 818e) (e.g., a password entry field and/or user name entry field). In some embodiments, the representation of the credential is a series of common shapes and/or symbols. In some embodiments, after displaying the representation of the credential in the text entry field (e.g., or while displaying the representation of the credential in the text entry field or in conjunction with displaying the representation of the credential in the text entry field user interface object) and in accordance with a determination that the credential is rejected (e.g., by the computer system, by the user, by the service, and/or by the credential management system) and (e.g., or) that the credential is edited (e.g., by the computer system and/or by the user), the computer system changes the appearance of the representation of the credential in the text entry field (e.g., changing the appearance of the representation of the credential based on how the credential is edited and/or changing the appearance of the representation of the credential such that the credential is obfuscated). In some embodiments, after displaying the representation of the credential in the text entry field and in accordance with the determination that the credential is rejected and that the credential is edited, the computer system displays, via the one or more display generation components (e.g., 602), an indication (e.g., 828) that the edited credential is saved in the credential management system (e.g., 612a). In some embodiments, after displaying the representation of the credential in the text entry field and in accordance with a determination that the credential is rejected and that the credential is edited, the computer system (e.g., or a respective computer system external to the computer system) saves the edited credential within credential management system. In some embodiments, the computer system concurrently displays representation of the credential in the text entry field and the notification that indicates that the credential has been saved in the credential management system. Displaying an indication that an edited credential has been saved when a set of prescribed conditions is met allows the computer system to perform a display operation that reassures the user that the computer system has updated the credential based on edits made by the user, thereby performing an operation when a set of conditions has been met without requiring further user input and/or providing improved visual feedback.

In some embodiments, the credential is a first credential. In some embodiments, in response to detecting the input (e.g., 805b, 805c, 805f, 805g, 805j, 805l1, and/or 805l2) corresponding to the request to perform the respective operation associated with the credential for the service (e.g., 632e1, 632d1, 832d, 840e, 840f, 840g, 840h, and/or 840i) and in accordance with a determination that the first credential is rejected (e.g., by the service, by the computer system, and/or by a respective computer system external to the computer system), the computer system displays, via the one or more display generation components (e.g., 602), a set of one or more selectable options (e.g., 826a, 826b, and/or 826c) (e.g., a set of one or more selectable options) to create a second credential (e.g., 632e1, 632d1, 832d, 840e, 840f, 840g, 840h, and/or 840i) (e.g., a password, a user name, authentication code, and/or passkey) with one or more different properties (e.g., different length, different characters, different number of symbols, and/or different complexity) from the first credential. In some embodiments, the computer system does not display the set of one or more options in accordance with a determination that the first credential is not rejected (e.g., is accepted). In some embodiments, the set of one or more options is displayed concurrently with and/or inline (e.g., above, below, and/or to the side) with a representation of the first credential. In some embodiments, the computer system ceases to display the set of one or more options in response to detecting an input that corresponds to selection of an option of the set of one or more options. In some embodiments, the computer system initiates a process for creating a different credential in response to detecting an input that corresponds to selection of the set of one or more options. In some embodiments, the input that corresponds to selection of the set of one or more options is a tap input at a location of the set of one or more options, a trackpad and/or mouse press input while a cursor or other focus selector is at a location of the set of one or more options, a pinch gesture while a gaze of the user is directed at the set of one or more options, a pinch gesture while the set of one or more options is visually emphasized, and/or a voice command that includes an utterance that identifies the set of one or more options. Displaying a set of one or more selectable options to create a credential when a set of prescribed conditions is met (e.g., the submission of a credential is rejected) allows the computer system to perform a display operation that alerts the user that the credential that was submitted was rejected, thereby performing an operation when a set of conditions has been met without requiring further user input, reducing the number of inputs needed to perform an operation, and/or providing improved visual feedback.

In some embodiments, the set of one or more selectable options (e.g., 826a, 826b, and/or 826c) includes a first selectable option (e.g., 826b) to generate (e.g., create and/or form) a third credential (e.g., 632e1, 632d1, 832d, 840e, 840f, 840g, 840h, and/or 840i) (e.g., a password, user name, and/or authentication code) that does not include special characters (e.g., an exclamation point, ampersand symbol, percentage symbol, dollar symbol, and/or asterisk). In some embodiments, a credential that does not include special characters is generated automatically (e.g., without further user input) in response to the computer system detecting an input corresponding to selection of the first selectable option. In some embodiments, the third credential is different from the first credential and/or the second credential. Displaying a selectable option to generate a credential when a set of prescribed conditions is met (e.g., a submitted credential is rejected) allows the computer system to provide the user with an option that streamlines the creation of a credential, thereby performing an operation when a set of conditions has been met without requiring further user input and/or reducing the number of inputs needed to perform an operation (e.g., generate a credential).

In some embodiments, the set of one or more selectable options (e.g., 826a, 826b, and/or 826c) includes a second selectable option (e.g., 826a) to generate (e.g., create and/or form) a fourth credential (e.g., 632e1, 632d1, 832d, 840e, 840f, 840g, 840h, and/or 840i) (e.g., a combination of a user name and password, authentication code, and/or passkey) that is easier to type than the first credential (e.g., 632e1, 632d1, 832d, 840e, 840f, 840g, 840h, and/or 840i) (e.g., the fourth credential includes no special characters, the fourth credential includes letters and/or numbers that are in close proximity to each other on a keyboard, and/or the fourth credential is not as complex as the first credential). In some embodiments, a respective credential that is easier to type than the first credential is generated automatically (e.g., without further user input) in response to detecting an input corresponding to selection of the second selectable option. In some embodiments, the respective credential is different from the first credential, second credential, and/or third credential. Displaying a selectable option to generate a credential when a set of prescribed conditions is met (e.g., a submitted credential is rejected) allows the computer system to provide the user with an option to streamline the creation of a credential, thereby performing an operation when a set of conditions has been met without requiring further user input and/or reducing the number of inputs needed to perform an operation (e.g., generate a credential).

In some embodiments, the set of one or more selectable options (e.g., 826a, 826b, and/or 826c) includes a third selectable option (e.g., 826c) to display, via the one or more display generation components (e.g., 602), (e.g., launch, display, activate, and/or execute) a user interface (e.g., 616) of the credential management system. In some embodiments, the third selectable option is an option to open the credential management system. In some embodiments, in response to detecting an input corresponding to selection of the third option, the computer system displays the user interface of the credential management system based on the context of the computer system. In some embodiments, the computer system ceases to display the set of one or more options as part of displaying the user interface of credential management system. In some embodiments, the computer system maintains the display of the set of one or more options as part of displaying the user interface of the credential management system. Displaying a selectable option to display a user interface of the credential management system when a set of prescribed conditions is met (e.g., a submitted credential is rejected) allows the computer system to provide the user with an option that streamlines access to the credential management system, thereby performing an operation when a set of conditions has been met without requiring further user input and/or reducing the number of inputs needed to perform an operation (e.g., access the credential management system).

In some embodiments, the computer system detects (e.g., before, while, and/or after detecting the input corresponding to the request to perform the respective operation associated with the credential for the service), via the one or more input devices (e.g., 608 and/or 606), an input (e.g., 805r) corresponding to a selection of a menu user interface object (e.g., 610b). In some embodiments, the computer system displays the menu user interface object in a menu bar of a desktop user interface of the computer system. In some embodiments, the computer system persistently displays the menu user interface object. In some embodiments, the computer system displays the menu user interface object based on the context of the computer system. In some embodiments, the menu user interface object is a graphical representation (e.g., logo and/or avatar) of the credential management system. In some embodiments, the input corresponding to selection of the menu user interface object is a tap input at a location of the menu user interface object, a trackpad and/or mouse press and/or mouse input while a cursor or other focus selector is at a location of the menu user interface object, a pinch gesture while a gaze of the user is directed at the menu user interface object, a pinch gesture while the menu user interface object is visually emphasized, and/or a voice command that includes an utterance that identifies the menu user interface object. In some embodiments, in response to detecting the input (e.g., in conjunction with detecting the input and/or while detecting the input) corresponding to selection of the menu user interface object, the computer system displays, via the one or more display generation components (e.g., 602), one or more credentials (e.g., 840e-840i) (e.g., a list of credentials and/or a menu of credentials), wherein at least one credential (e.g., 840e-840i) of the one or more credentials is automatically (e.g., without detecting intervening user input and/or without a user selecting the credential) included (e.g., by the computer system, by the credential management system, and/or by a respective computer system external to the computer system) in the one or more credentials based on a current context of the computer system (e.g., 600) (e.g., applications that are open on the computer system, which websites are open on the computer system, which credentials were recently used, which credentials were recently created, and/or which user is engaged with the computer system). In some embodiments, at least one credential of the one or more credentials is automatically included in the one or more credentials based on a previous context of the computer system. In some embodiments, the computer system updates the one or more credentials in real time based on the context of the computer system changing. In some embodiments, the computer system persistently displays the menu user interface object. In some embodiments, the one or more credentials includes a first credential and a second credential when the computer system has a first context and the one or more credentials includes a third credential and fourth credential, different from the first credential and the second credential (e.g., and does not include the first credential and/or the second credential), when the computer system has a second context different from the first context. Displaying at least one credential based on a current context of the computer system in response to detecting a selection of a user interface object allows the computer system to perform a display operation that indicates a context of the computer system, thereby providing improved feedback and/or performing an operation when a set of conditions has been met without requiring further user input.

In some embodiments, in accordance with a determination that a first application (e.g., a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application) is currently active (e.g., displayed, open, and/or executing) on the computer system (e.g., 600) and a second application (e.g., a note-taking application, a word-processing application, a document-processing application, a presentation application, an email application, a form processing application such as for PDF viewer and/or editor, a game, a messaging application, a maps application, a fitness application, a health application, a digital payments application, a media application, and/or a social network application), different from the first application, is not currently active (e.g., is not displayed, is not open, and/or is not executing) on the computer system, the one or more credentials (e.g., 840e-840i) include a credential (e.g., 840e-840i) corresponding to (e.g., directed to, related to, and/or associated with) the first application and the one or more credentials do not include a credential corresponding to (e.g., directed to, related to, and/or associated with) the second application. In some embodiments, in accordance with a determination that the second application is currently active on the computer system and the first application is not currently active on the computer system, the one or more credentials include the credential corresponding to the second application and the one or more credentials do not include the credential corresponding to the first application (e.g., as discussed above at FIG. 8S). In some embodiments, the one or more credentials includes a credential that corresponds to the first application and a credential that corresponds to the second application when both the first application and the second application are currently active. In some embodiments, the one or more credentials do not include a credential that corresponds to the first application nor a credential that corresponds to the second application when neither the first application or the second application are currently active on the computer system. Selectively including a credential in a list of credentials based on which applications are currently active on a computer system allows the computer system to perform a display operation that indicates which applications are currently running on the computer system, thereby performing an operation when a set of conditions has been met without requiring further user input.

In some embodiments, in accordance with a determination that a first website (e.g., 834, 810, and/or 838) (e.g., webpages and/or web-based applications) is currently active (e.g., the first website is displayed, open, and/or executing) on the computer system (e.g., 600) and a second website (e.g., 834, 810, and/or 838) (e.g., webpages and/or web-based applications) different from the first website is not currently active (e.g., the second website is not displayed, is not open, and/or is not executing) on the computer system, the one or more credentials (e.g., 840e-840i) includes a credential (e.g., 840e-840i) corresponding to (e.g., directed to, related to, and/or associated with) the first website and the one or more credentials do not include a credential corresponding to (e.g., directed to, related to, and/or associated with) the second website. In some embodiments, in accordance with a determination that the second website is currently active on the computer system and the first website is not currently active on the computer system, the one or more credentials include the credential corresponding to the second website and the one or more credentials do not include the credential corresponding to the first website (e.g., as discussed above at FIG. 8S). In some embodiments, the one or more credentials includes the credential that corresponds to the first website and the credential that corresponds to the second website when both the first website and the second website are currently active on the computer system. In some embodiments, the one or more credentials do not include the credential that corresponds to the first website nor the credential that corresponds to the second website when neither the first website or the second website are currently active on the computer system. Selectively including a credential in a list of credentials based on which websites are currently active on a computer system allows the computer system to indicate which applications are currently running on the computer system, thereby performing an operation when a set of conditions has been met without requiring further user input.

In some embodiments, in accordance with a determination that a first credential (e.g., 840e-840i) (e.g., a service specific credential, a passkey, and/or a verification code) meets recency criteria (e.g., was created within a threshold period of time (e.g., previous 1 minute-30 minutes, previous 1 day-5 days, previous 1 week-4 weeks, and/or previous 1 month-3 months) of the computer system detecting the input corresponding to (e.g., directed to, related to, and/or associated with) the selection of the menu user interface object and/or is a most recently created credential) and a second credential (e.g., 840e-840i) (e.g., a service specific credential, a passkey, and/or a verification code) different from the first credential (e.g., the first credential corresponds to a first service and the second credential corresponds to a second service different from the first service and/or the first credential is a different type of credential than the second credential) does not meet the recency criteria, the one or more credentials (e.g., 840e-840i) include the first credential and the one or more credentials do not include the second credential. In some embodiments, in accordance with a determination that the second credential meets the recency criteria and the first credential does not meet the recency criteria, the one or more credentials include the second credential and the one or more credentials do not include the first credential (e.g., as discussed above at FIG. 8S). In some embodiments, the one or more credentials include both the first credential and the second credential in accordance with a determination that both the first credential and the second credential meet the recency criteria. In some embodiments, the one or more credentials include neither the first credential and the second credential in accordance with a determination that nether the first credential nor the second credential meet the recency criteria. Selectively including credentials in a list of credentials based on which credentials satisfies a recency criteria allows the computer system to indicate a recency in with respect to the creation of various credentials, thereby performing an operation when a set of conditions has been met without requiring further user input.

In some embodiments, in response to detecting the input (e.g., 805r) corresponding to selection of the menu user interface object (e.g., 610b), the computer system displays, via the one or more display generation components (e.g., 602), a search field (e.g., 840d) (e.g., a user interface object configured to receive search queries and/or a user interface object that corresponds to a search functionality of the computer system) to search saved credentials (e.g., 632e1, 632d1, 832d, 840e, 840f, 840g, 840h, and/or 840i) (e.g., credentials saved on the computer system and/or credentials saved by the credential management system). In some embodiments, the computer system concurrently displays the search field and the one or more credentials. In some embodiments, the computer system performs a search operation in response to detecting an input while text is entered into the search field. In some embodiments, the search field is displayed concurrently with and/or inline with the one or more credentials. In some embodiments, the search field is displayed while the credential management system is inactive. Displaying a search field in response to detecting an input allows the computer system to make accessible a search feature of the computer system to a user without requiring that the user perform a series of inputs to access the search feature of the computer system, thereby reducing the number of inputs needed to perform an operation and/or providing improved visual feedback.

In some embodiments, in response to detecting the input (e.g., 805r) corresponding to selection of the menu user interface object (e.g., 610b), the computer system displays, via the one or more display generation components (e.g., 602), a selectable option (e.g., 840b) to create a new credential (e.g., a service specific credential, a passkey, and/or authentication code). In some embodiments, the computer system concurrently displays the search field user interface object, the new credential user interface object, and the one or more credentials. In some embodiments, the computer system ceases to display the search field user interface object and/or the one or more credentials in response to detecting an input that corresponds to selection of the new credential user interface object. In some embodiments, the computer system displays the new credential user interface object concurrently with and/or inline with the search field user interface object and/or the one or more credentials. In some embodiments, the input corresponding to selection of the menu user interface object is detected while the credential management system is inactive. Displaying a selectable option to create a new credential in response to detecting an input corresponding to selection of a user interface object allows the computer system to make accessible a create a credential feature of the computer system without requiring that the user perform a series of inputs to access the feature of the computer system, thereby reducing the number of inputs needed to perform an operation and/or providing improved visual feedback.

In some embodiments, while displaying the one or more credentials (e.g., 840e-840i), the computer system detects, via the one or more input devices (e.g., 608 and/or 606), an input (e.g., 805s) corresponding to (e.g., directed to, at a location of, related to, and/or associated with) a selection of a user name (e.g., a unique user identifier for the respective service) of a first credential (e.g., 840e) of the one or more credentials. In some embodiments, in response to detecting the input that corresponds to selection of the user name of the first credential of the one or more credentials, the computer system displays, via the one or more display generation components (e.g., 602), a selectable option (e.g., 842b) to copy (e.g., a computer system operation of storing data related to the user name to be transferred from one digital location to another digital location) the user name of the first credential of the one or more credentials. In some embodiments, the computer system copies the user name in response to detecting an input that corresponds to selection of the user name of the first credential of the one or more credentials. In some embodiments, the input corresponding to selection of the user name of the first credential of the one or more credentials is detected while the credential management system is inactive. In some embodiments, the computer system copies the user name of the first credential of the plurality of credentials in response to detecting an input corresponding to selection of the selectable option to copy the user name of the first credential of the plurality of credentials. In some embodiments, after the computer system copies the user name of the first credential, the computer system displays the user name (e.g., the computer system paste the user name) in response to detecting an input corresponding to a request to paste the user name. Displaying a selectable option to copy a user name of a credential in response to detecting an input corresponding to selection of a user name allows the computer system to perform an operation that streamlines the use of the user name to access restricted functionality of a service, thereby providing improved feedback, performing an operation (e.g. displaying selectable option for a user name) when a set of conditions has been met (e.g., the user name has been selected) without requiring further user input, and/or reducing the numbers of inputs needed to perform an operation (e.g., a copy operation).

In some embodiments, while displaying the one or more of credentials (e.g., 840e-840i), the computer system detects, via the one or more input devices (e.g., 608 and/or 606), an input corresponding to (e.g., directed to, at a location of, related to, and/or associated with) selection of a password (e.g., 842c) (e.g., set of one or more characters that verifies the identity of a user) of a second (e.g., 840e) credential of the one or more credentials (e.g., as discussed above at FIG. 8T). In some embodiments, in response to detecting the input that corresponds to selection of the password of the second credential of the one or more credentials, the computer system displays, via the one or more display generation components (e.g., 602), a selectable option (e.g., 842c) to copy the password of the second credential of the one or more credentials to be copied (e.g., a computer operation of storing data related to password to be transferred from one digital location to another digital location). In some embodiments, the computer system copies the password in response to detecting an input that corresponds to selection of the password of the second credential of the set of one or more credentials. In some embodiments, the input corresponding to selection of the password of the second credential of the one or more credentials is detected while the credential management system is inactive. In some embodiments, the computer system copies the password of the second credential of the one or more of credentials in response to detecting an input corresponding to selection of the selectable option to copy the password of the second credential of the plurality of credentials. Displaying a selectable option to copy a password of a credential in response to detecting an input corresponding to selection of a password allows the computer system to perform an operation that streamlines the use of the password to access restricted functionality of a service, thereby providing improved feedback, performing an operation (e.g. displaying selectable option for a password) when a set of conditions has been met (e.g., the password has been selected) without requiring further user input, and/or reducing the numbers of inputs needed to perform an operation (e.g., a copy operation).

In some embodiments, while displaying the one or more credentials (e.g., 840e-840i), the computer system detects, via the one or more input devices (e.g., 608 and/or 606), an input (e.g., 805s) corresponding to (e.g., directed to, at a location of, related to, and/or associated with) selection of a third credential (e.g., 840e-840i) (e.g., a combination of a user name and password, authentication code, and/or passkey) of the one or more credentials. In some embodiments, the input corresponding to selection of the third credential is a tap input at a location of the third credential, a trackpad and/or mouse press input while a cursor or other focus selector is at a location of the third credential, a pinch gesture while a gaze of the user is directed of the third credential, a depression of a rotatable input mechanism while the third credential is visually emphasized, and/or a voice command that includes an utterance identifying the third credential. In some embodiments, in response to detecting that input that corresponds to selection of the third credential of the plurality of credentials, the computer system displays, via the one or more display generation components (e.g., 602), security information (e.g., 842) related to the third credential (e.g., the credential is compromised, the credential is easy to guess, the credential is part of a data leak, and/or the credential is strong). In some embodiments, the input corresponding to the selection of the third credential of the one or more credentials is detected while the credential management system is inactive. In some embodiments, the computer system concurrently displays the option to first copy user interface object, the second copy user interface object, the one or more credentials, new credential user interface object, and/or the search field user interface object. In some embodiments, the security information related to the third credential includes a link to modify the third credential. In some embodiments, the security information related to the third credential includes a link to the credential management system. Displaying security information related to a credential in response to detecting an input corresponding to selection of the credential allows the computer system to indicate to a user whether the credential is secure and/or at risk without requiring that the use perform a series of inputs, thereby providing improved visual feedback and/or reducing the number of inputs needed to perform an operation (e.g., display security information of the credential).

In some embodiments, while displaying the credential user interface (e.g., 804, 812, 816, 818, 832 and/or 864) for the service, the computer system detects, via the one or more input devices (e.g., 608 and/or 606), an input (e.g., 805p1, 805p2, 805p3, 8050, 805l1, 805l2, 805g, and/or 805b) corresponding to (e.g., directed to, at a location of, related to, and/or associated with) a request to display the credential (e.g., 632e1, 632d1, 832d, 840e, 840f, 840g, 840h, and/or 840i) within a credential entry user interface object (e.g., 804c, 818d, and/or 818e) for a domain (e.g., use the credential to login to the service, and/or enter the credential into text entry fields of the credential user interface). In some embodiments, the input corresponding to the request to display the credential is a tap input at a location of a user interface object that is displayed in response to detecting an input corresponding to a text entry field (e.g., and/or displayed as part of displaying a cursor within the text entry field), a trackpad and/or mouse press input while a cursor or other focus selector is at a location of the user interface object that is displayed in response to detecting an input corresponding to the text entry field (e.g., and/or displayed as part of displaying a cursor within the text entry field), a pinch gesture while a gaze of the user is directed at the user interface object that is displayed in response to detecting an input corresponding to a text entry field (e.g., and/or displayed as part of displaying a cursor within the text entry field) and/or a voice command that includes an utterance for the computer system to login to a service, application and/or website. In some embodiments, in response to detecting the input corresponding to the request to display the credential within the credential user interface object for the domain and in accordance with a determination that the credential does not correspond to the domain (e.g., the credential is not registered with the domain, the credential is not associated with the domain, and/or a different credential is associated with the domain), the computer system displays, via the one or more display generation components (e.g., 602), a warning user interface (e.g., 836). In some embodiments, the computer system displays the credential within the credential entry user interface object for the domain in response to detecting the input corresponding to the request to display the credential within the credential user interface object for the domain and in accordance with a determination that the credential does not correspond to the domain. In some embodiments, the computer system does not display the credential within the credential entry user interface object for the domain in response to detecting the input corresponding to the request to display the credential within the credential user interface object for the domain and in accordance with a determination that the credential does not correspond to the domain. Displaying a warning user interface when a set of prescribed conditions is satisfied (e.g., the credential does not correspond to a domain of a credential entry user interface that the credential was entered into) allows the computer system to perform a display operation that indicates that the user may be misusing the credential, thereby performing an operation a set of conditions has been met without requiring further user input.

In some embodiments, the warning user interface (e.g., 836) includes a first selectable option (e.g., 836a) (e.g., a selectable option) to use the credential (e.g., 632e1, 632d1, 832d, 840e, 840f, 840g, 840h, and/or 840i) once to access restricted functionality of the domain. In some embodiments, the computer system accesses the restricted functionality of the domain in response to detecting an input that corresponds to selection of the first selectable option. Displaying a selectable option to use the credential once to access restricted functionality of the domain when a set of prescribed conditions is satisfied (e.g., the credential does not correspond to a domain of a credential entry user interface that the credential was entered into) allows the computer system to allow the user to confirm that the user would like to use the credential to access the restricted functionalities of the domain, thereby performing an operation a set of conditions has been met without requiring further user input.

In some embodiments, the warning user interface (e.g., 836) includes a second selectable option (e.g., 836b) to associate (e.g., register and/or link the credential to the domain in addition to or instead of other services the credential is already associated with) the credential (e.g., 632e1, 632d1, 832d, 840e, 840f, 840g, 840h, and/or 840i) with the domain. In some embodiments, the computer system accesses restricted functionality of the domain in response to detecting a selection of the option to associate the credential with the domain. In some embodiments, the computer system does not access the restricted functionality of the domain in response to detecting a selection of the option to associate the credential with the domain. In some embodiments, the computer system associates the credential with the domain in response to detecting an input that corresponds to selection of the second selectable option. Displaying a selectable option to associate a credential with a domain when a set of prescribed conditions is satisfied (e.g., the credential does not correspond to a domain of a credential entry user interface that the credential was entered into) allows the computer system to provide the user the ability to register the credential with the domain such that subsequent attempt to access restricted functionalities of the domain are not interrupted, thereby performing an operation a set of conditions has been met without requiring further user input and/or reducing the number of inputs needed to perform an operation (e.g., register the credential with the domain).

In some embodiments, the warning user interface (e.g., 836) includes a third selectable option (e.g., 836c) to stop using the credential (e.g., 632e1, 632d1, 832d, 840e, 840f, 840g, 840h, and/or 840i) (e.g., disassociate, unregister and/or unlink the credential with the credential management system, the service, and/or the domain and/or delete the credential) for the domain. In some embodiments, the computer system does not access the restricted functionality of the domain in response to detecting a selection of the option to stop using the credential. In some embodiments, the computer system disassociates the credential from the domain in response to detecting an input that corresponds to selection of the third selectable option. Displaying a selectable option to stop using a credential for a domain when a set of prescribed conditions is satisfied (e.g., the credential does not correspond to a domain of a credential entry user interface that the credential was entered into) allows the computer system to provide the user with the option to avoid misusing the credential with an incorrect domain, thereby performing an operation a set of conditions has been met without requiring further user input.

Note that details of the processes described above with respect to method 900 (e.g., FIG. 9A) are also applicable in an analogous manner to the methods described herein. For example, method 700 optionally includes one or more of the characteristics of the various methods described herein with reference to method 900. For example, the computer system can use one or more techniques of method 900 to display an option to view the first user interface or the second user interface of method 700. For brevity, these details are not repeated herein.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve managing credentials. The present disclosure contemplates that in some instances, this gathered data may include personal information data that uniquely identifies or can be used to contact or locate a specific person. Such personal information data can include demographic data, location-based data, telephone numbers, email addresses, social media identifiers, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used for managing credentials. Accordingly, use of such personal information data enables users to have a computer system perform operations for managing credentials. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of some services, the present technology can be configured to allow users to select to “opt in” or “opt out” of participation in the collection of personal information data during registration for services or anytime thereafter. In another example, users can select not to provide certain data for some services. In yet another example, users can select to limit the length of time data is maintained or entirely prohibit the development of user profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other processes.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the some services, or publicly available information.

What is claimed is:

1. A method, comprising:
at a computer system that is in communication with one or more display generation components and one or more input devices:
while displaying a credential user interface for a service, detecting, via the one or more input devices, an input corresponding to a request to perform a respective operation associated with a credential for the service; and
in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

2. The method of claim 1, further comprising:
before detecting, via the one or more input devices, the input corresponding to the request to perform the respective operation associated with the credential for the service, detecting, via the one or more input devices, one or more inputs corresponding to a selection of one or more alphanumeric characters by a user, wherein the credential includes the one or more alphanumeric characters.

3. The method of claim 1, wherein the input corresponding to the request to perform the respective operation associated with the credential for the service is a request for the credential to be generated, the method further comprising:
in response to detecting the input corresponding to the request to perform the respective operation associated with the credential for the service, displaying, via the one or more display generation components, a representation of the credential.

4. The method of claim 3, further comprising:
in response to detecting the input corresponding to the request to perform the respective operation associated with the credential for the service, forgoing display of, via the one or more display generation components, the credential within the credential user interface.

5. The method of claim 3, wherein the representation of the credential is a first representation of the credential, the method further comprising:
after displaying the first representation of the credential, detecting, via the one or more input devices, a set of one or more inputs; and
in response to detecting the set of one or more inputs, displaying, via the one or more display generation components, a user interface for a section of the credential management system, wherein:
in accordance with a determination that the credential is not saved in association with a domain, the user interface for the section of the credential management system includes a second representation of the credential; and
in accordance with a determination that the credential is saved in association with a domain, the user interface for the section of the credential management system does not include the second representation.

6. The method of claim 1, wherein the request to perform the respective operation associated with the credential for the service is a request to create the credential, the method further comprising:
in response to detecting the input corresponding to the request to perform the respective operation associated with the credential for the service and while displaying the notification that indicates that the credential has been saved in a credential management system, displaying, via the one or more display generation components, a representation of the credential.

7. The method of claim 1, wherein the request to perform the respective operation associated with the credential for the service is a request to access restricted functionality of the service, the method further comprising:
in response to detecting the input corresponding to the request to perform the respective operation associated with the credential for the service and while displaying the notification that indicates that the credential has been saved in a credential management system, displaying, via the one or more display generation components, content corresponding to the restricted functionality of the service.

8. The method of claim 1, wherein the credential user interface includes a text entry field, the method further comprising:
in response to detecting the input corresponding to the request to perform the respective operation associated with the credential for the service, displaying, via the one or more display generation components, a representation of the credential for the service within the text entry field of the credential user interface, wherein the notification that indicates that the credential has been saved in the credential management system is displayed concurrently with the text entry field.

9. The method of claim 1, wherein the notification is displayed at a default location for computer system notifications.

10. The method of claim 1, further comprising:
in response to detecting the input corresponding to the request to perform the respective operation associated with the credential for the service, displaying, via the one or more display generation components, a representation of the credential in a text entry field; and
after displaying the representation of the credential in the text entry field and in accordance with a determination that the credential is rejected and that the credential is edited:
changing the appearance of the representation of the credential in the text entry field; and
displaying, via the one or more display generation components, an indication that the edited credential is saved in the credential management system.

11. The method of claim 1, wherein the credential is a first credential, the method further comprising:
in response to detecting the input corresponding to the request to perform the respective operation associated with the credential for the service and in accordance with a determination that the first credential is rejected, displaying, via the one or more display generation components, a set of one or more selectable options to create a second credential with one or more different properties from the first credential.

12. The method of claim 11, wherein the set of one or more selectable options includes a first selectable option to generate a third credential that does not include special characters.

13. The method of claim 11, wherein the set of one or more selectable options includes a second selectable option to generate a fourth credential that is easier to type than the first credential.

14. The method of claim 11, wherein the set of one or more selectable options includes a third selectable option to display, via the one or more display generation components, a user interface of the credential management system.

15. The method of claim 1, further comprising:
detecting, via the one or more input devices, an input corresponding to a selection of a menu user interface object; and
in response to detecting the input corresponding to selection of the menu user interface object, displaying, via the one or more display generation components, one or more credentials, wherein at least one credential of the one or more credentials is automatically included in the one or more credentials based on a current context of the computer system.

16. The method of claim 15, wherein:
in accordance with a determination that a first application is currently active on the computer system and a second application, different from the first application, is not currently active on the computer system, the one or more credentials include a credential corresponding to the first application and the one or more credentials do not include a credential corresponding to the second application; and
in accordance with a determination that the second application is currently active on the computer system and the first application is not currently active on the computer system, the one or more credentials include the credential corresponding to the second application and the one or more credentials do not include the credential corresponding to the first application.

17. The method of claim 15, wherein:
in accordance with a determination that a first website is currently active on the computer system and a second website different from the first website is not currently active on the computer system, the one or more credentials includes a credential corresponding to the first website and the one or more credentials do not include a credential corresponding to the second website; and
in accordance with a determination that the second website is currently active on the computer system and the first website is not currently active on the computer system, the one or more credentials include the credential corresponding to the second website and the one or more credentials do not include the credential corresponding to the first website.

18. The method of claim 15, wherein:
in accordance with a determination that a first credential meets recency criteria and a second credential different from the first credential does not meet the recency criteria, the one or more credentials include the first credential and the one or more credentials do not include the second credential; and
in accordance with a determination that the second credential meets the recency criteria and the first credential does not meet the recency criteria, the one or more credentials include the second credential and the one or more credentials do not include the first credential.

19. The method of claim 15, further comprising:
in response to detecting the input corresponding to selection of the menu user interface object, displaying, via the one or more display generation components, a search field to search saved credentials.

20. The method of claim 15, further comprising:
in response to detecting the input corresponding to selection of the menu user interface object, displaying, via the one or more display generation components, a selectable option to create a new credential.

21. The method of claim 15, further comprising:
while displaying the one or more credentials, detecting, via the one or more input devices, an input corresponding to a selection of a user name of a first credential of the one or more credentials; and
in response to detecting the input that corresponds to selection of the user name of the first credential of the one or more credentials, displaying, via the one or more display generation components, a selectable option to copy the user name of the first credential of the one or more credentials.

22. The method of claim 15, further comprising:
while displaying the one or more of credentials, detecting, via the one or more input devices, an input corresponding to selection of a password of a second credential of the one or more credentials; and
in response to detecting the input that corresponds to selection of the password of the second credential of the one or more credentials, displaying, via the one or more display generation components, a selectable option to copy the password of the second credential of the one or more credentials to be copied.

23. The method of claim 15, further comprising:
while displaying the one or more credentials, detecting, via the one or more input devices, an input corresponding to selection of a third credential of the one or more credentials; and
in response to detecting that input that corresponds to selection of the third credential of the one or more credentials, displaying, via the one or more display generation components, security information related to the third credential.

24. The method of claim 1, further comprising:
while displaying the credential user interface for the service, detecting, via the one or more input devices, an input corresponding to a request to display the credential within a credential entry user interface object for a domain; and
in response to detecting the input corresponding to the request to display the credential within the credential user interface for the domain and in accordance with a determination that the credential does not correspond to the domain, displaying, via the one or more display generation components, a warning user interface.

25. The method of claim 24, wherein the warning user interface includes a first selectable option to use the credential once to access restricted functionality of the domain.

26. The method of claim 24, wherein the warning user interface includes a second selectable option to associate the credential with the domain.

27. The method of claim 24, wherein the warning user interface includes a third selectable option to stop using the credential for the domain.

28. A non-transitory computer-readable storage medium storing one or more programs configured to be executed by one or more processors of a computer system that is in communication with one or more display generation components and one or more input devices, the one or more programs including instructions for:
while displaying a credential user interface for a service, detecting, via the one or more input devices, an input corresponding to a request to perform a respective operation associated with a credential for the service; and
in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.

29. A computer system configured to communicate with one or more display generation components and one or more input devices, comprising:
one or more processors; and
memory storing one or more programs configured to be executed by the one or more processors, the one or more programs including instructions for:
while displaying a credential user interface for a service, detecting, via the one or more input devices, an input corresponding to a request to perform a respective operation associated with a credential for the service; and
in response to detecting the input corresponding to the request to perform the respective operation associated with the credential for the service, displaying, via the one or more display generation components, a notification that indicates that the credential has been saved in a credential management system that is separate from the service for which the credential was created, wherein the notification includes an option to view the credential within a credential management user interface for the credential management system that is separate from the service for which the credential was created.
